(19) United States
(12) Patent Application Publication
(10) Pub. No.: US 2013/0109789 A1
(43) Pub. Date: May 2, 2013

(54) OLEFIN POLYMERIZATION CATALYST, PROCESS FOR PRODUCING OLEFIN POLYMER, POLYPROPYLENE RESIN COMPOSITION AND ARTICLE COMPRISING THE SAME

(71) Applicant: SUMITOMO CHEMICAL COMPANY, LIMITED, Tokyo (JP)

(72) Inventors: Hirofumi HAMAKI, Osaka (JP); Wataru HIRAHATA, Ichihara-shi (JP); Yasuki FUJIWARA, Kawasaki-shi (JP); Shuichi KIMATA, Ichihara-shi (JP); Hisakatsu HAMA, Ichihara-shi (JP); Kenji IKEDA, Ichihara-shi (JP)

(73) Assignee: SUMITOMO CHEMICAL COMPANY, LIMITED, Tokyo (JP)

(21) Appl. No.: 13/658,880

(22) Filed: Oct. 24, 2012

(30) Foreign Application Priority Data
Oct. 28, 2011 (JP) 2011-236834
Jan. 23, 2012 (JP) 2012-010748
Jan. 23, 2012 (JP) 2012-010749

(51) Int. Cl. C08F 4/649; C08L 23/12; C08F 10/06; C08L 5/00; C08K 5/101; C08K 5/527; C08F 4/76; C08L 23/08

(52) U.S. Cl. 524/56; 526/126; 525/240; 502/126

(57) ABSTRACT

An olefin polymerization catalyst is obtained by bringing the following components (A), (B) and (C) into contact with one another:
(A) a solid catalyst component for olefin polymerization containing a titanium atom, a magnesium atom and a halogen atom;
(B) an organoaluminum compound; and
(C) a triether represented by formula (I).

An olefin polymerization solid catalyst can be provided having a sufficiently high polymerization activity and an ability to produce an olefin polymer with a low content of low-molecular weight components and amorphous components.

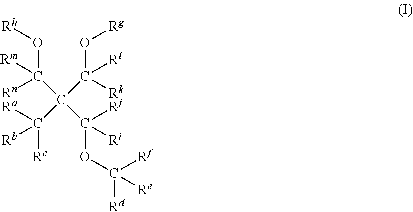

### TECHNICAL FIELD

The present application is filed, claiming the priorities based on the Japanese Patent Application Nos. 2011-236834 (filed on Oct. 28, 2011), 2012-010748 (filed on Jan. 23, 2012) and 2012-010749 (filed on Jan. 23, 2012), and a whole of the contents of the applications is incorporated herein by reference.

The present invention relates to an olefin polymerization catalyst, a process for producing an olefin polymer, a propylene polymer, a polypropylene resin composition and a molded article comprising the resin composition.

### BACKGROUND ART

It is known that ethers are used as an electron donor in an olefin polymerization catalyst.

For example, JP 4-96911 A describes an olefin polymerization catalyst which comprises a solid catalyst component comprising a titanium atom, a magnesium atom and a halogen atom as essential components, an organoaluminum and a diether compound as an external electron donor. US 2006-0142146 A1 describes an olefin polymerization catalyst which comprises a solid catalyst component comprising a titanium atom, a magnesium atom and a halogen atom as essential components, an organoaluminum and a diether compound having a Si—O bond as an external electron donor. In addition, CN 1324869 A describes a solid catalyst component which comprises a solution of magnesium acetate in isooctanol, titanium tetrachloride, and a compound having 2 to 4 ether bonds as an electron donor.

### DISCLOSURE OF INVENTION

### Problem to be Solved by the Invention

However, the olefin polymerization catalysts disclosed in the above documents, are still not entirely satisfactory from the viewpoint of their polymerization activity and their ability to produce a polymer with a low content of low-molecular weight components and amorphous components.

Therefore, an object of the present invention is to provide an olefin polymerization catalyst having a sufficiently high polymerization activity and an ability to produce a polymer with a low content of low-molecular weight components and amorphous components, a process for producing an olefin polymer, a propylene polymer with a low content of low-molecular weight components and amorphous components, a polypropylene resin composition comprising the propylene polymer and an article comprising the polypropylene resin composition.

### Means for Solving the Problem

The present invention is directed to the following olefin polymerization catalyst, process for producing an olefin polymer, propylene polymer, polypropylene resin composition and molded article comprising the resin composition.

[1] An olefin polymerization catalyst obtainable by bringing the following components (A), (B) and (C) into contact with one another:
(A) a solid catalyst component for olefin polymerization comprising a titanium atom, a magnesium atom and a halogen atom;
(B) an organoaluminum compound;
(C) a triether represented by formula (I):

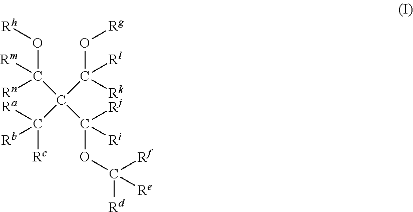

wherein R^{a} is a hydrogen atom or a hydrocarbyl group having 1 to 20 carbon atoms and optionally having a substituent, R^{b} and R^{c} each independently are a hydrocarbyl group having 1 to 20 carbon atoms and optionally having a substituent, R^{d} and R^{e} each independently are a hydrogen atom or a hydrocarbyl group having 1 to 20 carbon atoms and optionally having a substituent, R^{f} is a hydrocarbyl group having 1 to 20 carbon atoms and optionally having a substituent, R^{g} and R^{h} each independently are a hydrocarbyl group having 1 to 5 carbon atoms and optionally having a substituent, R^{u}, R^{j}, R^{k}, R^{l}, R^{m} and Rⁿ each independently are a hydrogen atom or a hydrocarbyl group having 1 to 5 carbon atoms and optionally having a substituent.

[2] An olefin polymerization catalyst obtainable by bringing the following components (A), (B), (C) and (D) into contact with one another:
(A) a solid catalyst component for olefin polymerization comprising a titanium atom, a magnesium atom and a halogen atom;
(B) an organoaluminum compound;
(C) a triether represented by formula (I):

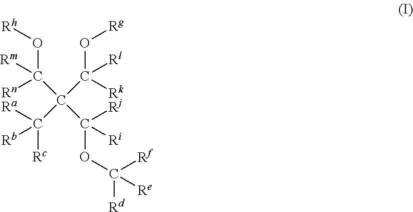

wherein R^{a} is a hydrogen atom or a hydrocarbyl group having 1 to 20 carbon atoms and optionally having a substituent, R^{b} and R^{c} each independently are a hydrocarbyl group having 1 to 20 carbon atoms and optionally having a substituent, R^{d} and R^{e} each independently are a hydrogen atom or a hydrocarbyl group having 1 to 20 carbon atoms and optionally having a substituent, R^{f} is a hydrocarbyl group having 1 to 20 carbon atoms and optionally having a substituent, R^{g} and R^{h} each independently are a hydrocarbyl group having 1 to 5 carbon atoms and optionally having a substituent, Rⁱ, R^{j}, R^{k}, R^{l}, R^{m} and Rⁿ each independently are a hydrogen atom or a hydrocarbyl group having 1 to 5 carbon atoms and optionally having a substituent;

(D) an alkoxysilane compound.
[3] The olefin polymerization catalyst according to the above item [1] or [2], wherein R^{e} in formula (I) is a hydrocarbyl group having 1 to 20 carbon atoms.
[4] The olefin polymerization catalyst according to the above item [1] or [2], wherein R^{g} and R^{h} in formula (I) each independently are a linear alkyl group having 1 to 5 carbon atoms.
[5] The olefin polymerization catalyst according to the above item [1] or [2], wherein each Rⁱ, R^{j}, R^{k}, R^{l}, R^{m} and Rⁿ is a hydrogen atom.
[6] The olefin polymerization catalyst according to the above item [1] or [2], wherein the solid catalyst component (A) for olefin polymerization is obtained by bringing a solid component (a) comprising a titanium atom and a magnesium atom into contact with an electron donor compound (b).
[7] The olefin polymerization catalyst according to the above item [1] or [2], wherein the solid catalyst component (A) for olefin polymerization is obtained by bringing a titanium compound (c), a magnesium compound (d) and an electron donor compound (b) into contact with one another.
[8] The olefin polymerization catalyst according to the above item [1] or [2], wherein the solid catalyst component (A) for olefin polymerization is obtained by bringing a titanium compound (c), a magnesium compound (d), an electron donor compound (b) and an organic acid chloride (e) into contact with one another.
[9] The olefin polymerization catalyst according to the above item [1] or [2], wherein the solid catalyst component (A) for olefin polymerization is obtained by bringing a solid component (a) comprising a titanium atom and a magnesium atom, an electron donor compound (b) and a metal halide compound represented by formula (vii) or (viii):

M¹R¹¹_{p-b}X³_{b} (vii)

M¹(OR¹¹)_{p-b}X³_{b} (viii)

wherein M¹ is an element of Group 4, 13 or 14 of the periodic table, R¹¹ is a hydrocarbyl group having 1 to 20 carbon atoms, X³ is a halogen atom, p represents a valency of the element M¹, and b is an integer number satisfying 0<b≦p, into contact with one another.

[10] The olefin polymerization catalyst according to the above item [1] or [2], wherein the solid catalyst component (A) for olefin polymerization is obtained by bringing a solid component (a) comprising a titanium atom and a magnesium atom, an electron donor compound (b), a metal halide compound represented by formula (vii) or (viii):

M¹R¹¹_{p-b}X³_{b} (vii)

M¹(OR¹¹)_{p-b}X³_{b} (viii)

wherein M¹ is an element of Group 4, 13 or 14 of the periodic table, R¹¹ is a hydrocarbyl group having 1 to 20 carbon atoms, X³ is a halogen atom, p represents a valency of the element M¹, and b is an integer number satisfying 0<b≦p,

and an organic acid chloride (e) into contact with one another.
[11] The olefin polymerization catalyst according to any one of the above items [6], [9] and [10], wherein the solid component (a) is a solid catalyst component precursor (a-1) for olefin polymerization comprising a titanium atom, a magnesium atom and a hydrocarbyloxy group.
[12] The olefin polymerization catalyst according to the above item [11], wherein the catalyst component precursor (a-1) for olefin polymerization is obtained by reducing a titanium compound (a-1b) represented by formula (iv):

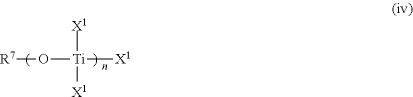

wherein n is an integer number of 1 to 20, R⁷ is a hydrocarbyl group having 1 to 20 carbon atoms, and each groups X¹ are a halogen atom or a hydrocarbyloxy group having 1 to 20 carbon atoms, and groups X¹ may be the same or different from each other,

with an organomagnesium compound (a-1c) in the presence of a silicon compound (a-1a) having a Si—O bond.
[13] The olefin polymerization catalyst according to any one of the above items [6] to [10], wherein the electron donor compound (b) is selected from the group consisting of an aliphatic carboxylate ester having an alkoxy group, a malonate diester, a succinate diester, a cyclohexane dicarboxylate diester, a phthalate diester, a dodecanedioic acid diester and a carbonate.
[14] The olefin polymerization catalyst according to the above item [7] or [8], wherein the magnesium compound (d) is a dialkoxy magnesium (d-2).
[15] The olefin polymerization catalyst according to the above item [7] or [8], wherein the magnesium compound (d) is a magnesium halide (d-1).
[16] A process for producing an olefin polymer, comprising a step of polymerizing an olefin in the presence of the olefin polymerization catalyst according to the above item [1] or [2].
[17] The process according to the above item [16], wherein the olefin is an α-olefin having 3 to 20 carbon atoms.
[18] A propylene polymer satisfying all of the following requirements (1) to (4):
(1) an intrinsic viscosity measured at 135° C. in tetralin is 1.0 dl/g or less;
(2) a ratio of a weight average molecular weight to a number average molecular weight measured by gel permeation chromatography is not less than 3.0 and not more than 4.0;
(3) a total amount of bonds resulting from 2,1-insetion reaction and 3,1-insertion reaction in the total structural units derived from propylene, measured by a ¹³C nuclear magnetic resonance spectrum, is 0.01 mol % or less;
(4) an amount of a constituent extracted by subjecting 1 g of a sheet having a thickness of 100 μm obtained by pressing the propylene polymer in 10 ml of tetrahydrofuran for 1 hour to an ultrasonic treatment is 1700 ppm or less.
[19] The propylene polymer according to the above item [18] produced by using the olefin polymerization catalyst according to the above item [1] or [2].
[20] A propylene polymer produced by using the olefin polymerization catalyst according to the above item [1] or [2].
[21] A polypropylene resin composition comprising the propylene polymer according to any one of the above items [18] to [20] and an ethylene-α-olefin copolymer.
[22] A polypropylene resin composition comprising the propylene polymer [component (E)] according to any one of claims 18 to 20, 0.01 to 0.5 parts by weight of the following compound [component (F)] per 100 parts by weight of the component (E) and 0.01 to 0.5 parts by weight of a compound [component (G)] having a hydroxyphenyl group per 100 parts by weight of the component (E):

Compound [component (F)]:
at least one compound selected from the group consisting of a compound represented by CₙHₙ₊₂(OH)ₙ wherein n is an integer of 4 or more; an alkoxylated compound defined as follows; a compound represented by the following formula (3); trehalose, sucrose, lactose, maltose, melezitose, stachyose, curdlan, glycogen, glucose and fructose;
   Alkoxylated compound:
   a compound in which at least one hydroxy group in a compound represented by formula (2):

CₘH₂ₘOₘ (2)
wherein m is an integer number of 3 or more, is alkoxylated with an alkyl group having 1 to 12 carbon atoms, the compound represented by formula (2) containing one aldehyde or ketone group and m-1 hydroxy groups;
   Compound represented by formula (3):

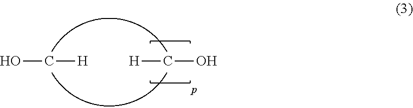

wherein p is an integer number of 2 or more.

[23] The polypropylene resin composition according to the item
[22], wherein the component (F) is trehalose.
[24] The polypropylene resin composition according to the above item [22], wherein the component (G) having a hydroxyphenyl group is selected from a group consisting of a compound represented by formula (4):

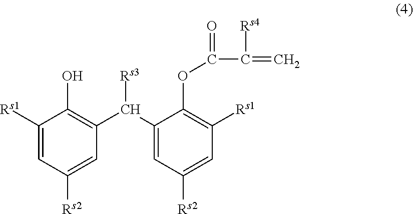

wherein R^{S1} and R^{S2} each independently are an alkyl group having 1 to 8 carbon atoms, an aryl group having 6 to 12 carbon atoms or an aralkyl group having 7 to 18 carbon atoms, the R^{S1} groups may be the same or different from each other, the R^{S2} groups may be the same or different from each other, R^{S3} is a hydrogen atom or an alkyl group having 1 to 3 carbon atoms, and R^{S4} is a hydrogen atom or a methyl group,

and a compound represented by formula (5):

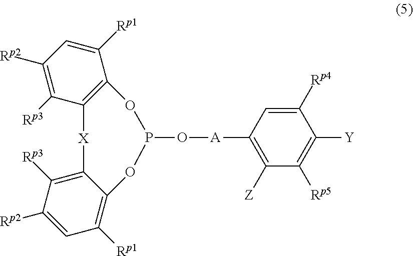

wherein R^{P1}, R^{P2}, R^{P4} and R^{P5} each independently are a hydrogen atom, an alkyl group having 1 to 8 carbon atoms, a cycloalkyl group having 5 to 8 carbon atoms, an alkyl cycloalkyl group having 6 to 12 carbon atoms, an aralkyl group having 7 to 12 carbon atoms or a phenyl group; R^{P3} groups each independently are a hydrogen atom or an alkyl group having 1 to 8 carbon atoms; X is a single bond, sulfur atom or a divalent group represented by formula (5-1):

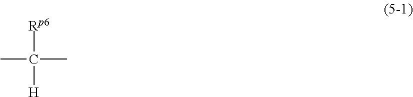

wherein R^{P6} is a hydrogen atom, an alkyl group having 1
to 8 carbon atoms or a cycloalkyl group having 5 to 8 carbon atoms;
   A is an alkylene group having 2 to 8 carbon atoms or a divalent group represented by formula (5-2):

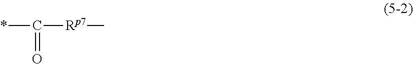

wherein R^{P7} is a single bond or an alkylene group having 1 to 8 carbon atoms, and * represents the binding site to an oxygen atom;
   one of Y or Z is a hydroxy group, an alkyl group having 1 to 8 carbon atoms, an alkoxy group having 1 to 8 carbon atoms or an aralkyloxy group having 7 to 12 carbon atoms and the other one is a hydrogen atom or an alkyl group having 1 to 8 carbon atoms.
   [25] The polypropylene resin composition according to the above item [22], wherein the component (G) is
2,4-di-t-pentyl-6-[1-(3,5-di-t-pentyl-2-hydroxyphenyl)ethyl]phenylacrylate or
6-[3-(3-t-butyl-4-hydroxy-5-methylphenyl)propoxy]-2,4,8,10-tetra-t-butyldibenz[d,f][1,3,2]dioxaphosphepin.
   [26] An article comprising the propylene polymer according to any one of the above items [18] to [20] or the polypropylene resin composition according to the above item [21] or [22].

### Modes for Carrying Out the Invention

Hereinafter, the present invention will be described in detail.

### <Triether Compound (C)>

As to R^{a}, R^{b} and R^{c} in formula (I), the hydrocarbyl group may be an alkyl group, an aralkyl group, an aryl group or an alkenyl group, which may be substituted with a halogen atom, a silyl group or the like.

Examples of the alkyl group for R^{a}, R^{b} and R^{c} include a linear alkyl group such as a methyl group, an ethyl group, an n-propyl group, an n-butyl group, an n-pentyl group, an n-hexyl group, an n-heptyl group and an n-octyl group; a branched alkyl group such as an isopropyl group, an isobutyl group, a sec-butyl group, a tert-butyl group, an isopentyl group, a 2,2-dimethylpropyl group, a 1,1-dimethylpropyl group, a 1,1,2-trimethylpropyl group, a 1,1,2,2-tetramethylpropyl group and a 2-ethylhexyl group; a cycloalkyl group such as a cyclopropyl group, a cyclobutyl group, a cyclopentyl group, a cyclohexyl group, a cycloheptyl group and cyclooctyl group. Among them, a linear, branched or cyclic alkyl group having 1 to 20 carbon atoms is preferable, and a linear or branched alkyl group having 1 to 20 carbon atoms is more preferable.

Examples of the aralkyl group for R^{a}, R^{b} and R^{c} include a benzyl group and a phenethyl group. Preferred is an aralkyl group having 7 to 20 carbon atoms.

Examples of the aryl group for R^{a}, R^{b} and R^{c} include a phenyl group, a tolyl group and a xylyl group, a mesityl group, a 2,6-diisopropylphenyl group. Preferred is an aryl group having 6 to 20 carbon atoms.

Examples of the alkenyl group for R^{a}, R^{b} and R^{c} include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is an alkenyl group having 2 to 20 carbon atoms.

R^{a} in formula (I) is preferably a hydrogen atom or an alkyl group having 1 to 20 carbon atoms, more preferably a hydrogen atom, a linear or branched alkyl group having 1 to 20 carbon atoms, still more preferably a hydrogen atom, a methyl group, an ethyl group, an n-propyl group, an n-butyl group, an n-pentyl group, an n-hexyl group, an n-heptyl group, an n-octyl group, an isopropyl group, an isobutyl group, a sec-butyl group, a tert-butyl group, an isopentyl group, a 2,2-dimethylpropyl group, a 1,1-dimethylpropyl group, a 1,1,2-trimethylpropyl group, a 1,1,2,2-tetramethylpropyl group and a 2-ethylhexyl group.

R^{b} and R^{c} in formula (I) is preferably an alkyl group having 1 to 20 carbon atoms, more preferably a linear or branched alkyl group having 1 to 20 carbon atoms, still more preferably a methyl group, an ethyl group, an n-propyl group, an n-butyl group, an n-pentyl group, an n-hexyl group, an n-heptyl group, an n-octyl group, an isopropyl group, an isobutyl group, a sec-butyl group, a tert-butyl group, an isopentyl group, a 2,2-dimethylpropyl group, a 1,1-dimethylpropyl group, a 1,1,2-trimethylpropyl group, a neo-pentyl group, a tert-pentyl group, a thexyl group, a 1,1,2,2-tetramethylpropyl group and a 2-ethylhexyl group.

R^{b} and R^{c} in formula (I) may be bonded to each other to form a ring. Examples of such a ring include a cyclopropane ring, a cyclobutane ring, a cyclopentane ring, a cyclohexane ring, a cycloheptane ring, a cyclooctane ring, a cyclononane ring, a cyclodecane ring, and a cyclododecane ring.

As to R^{d}, R^{e} and R^{f} in formula (I), the hydrocarbyl group may be an alkyl group, an aralkyl group, an aryl group or an alkenyl group, which may be substituted with a halogen atom, a silyl group or the like.

Examples of the alkyl group for R^{d}, R^{e} and R^{f} include a linear alkyl group such as a methyl group, an ethyl group, an n-propyl group, an n-butyl group, an n-pentyl group, an n-hexyl group, an n-heptyl group and an n-octyl group; a branched alkyl group such as an isopropyl group, an isobutyl group, a sec-butyl group, a tert-butyl group, an isopentyl group, a 2,2-dimethylpropyl group, a 1,1-dimethylpropyl group, a 1,1,2-trimethylpropyl group, a 1,1,2,2-tetramethylpropyl group and a 2-ethylhexyl group; a cycloalkyl group such as a cyclopropyl group, a cyclobutyl group, a cyclopentyl group, a cyclohexyl group, a cycloheptyl group and cyclooctyl group. Among them, a linear, branched or cyclic alkyl group having 1 to 20 carbon atoms is preferable, and a linear or branched alkyl group having 1 to 20 carbon atoms is more preferable.

Examples of the aralkyl group for R^{d}, R^{e} and R^{f} include a benzyl group and a phenethyl group. Preferred is an aralkyl group having 7 to 20 carbon atoms.

Examples of the aryl group for R^{d}, R^{e} and R^{f} include a phenyl group, a tolyl group and a xylyl group, a mesityl group, a 2,6-diisopropylphenyl group. Preferred is an aryl group having 6 to 20 carbon atoms.

Examples of the alkenyl group for R^{d}, R^{e} and R^{f} include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is an alkenyl group having 2 to 20 carbon atoms.

R^{d} in formula (I) is preferably a hydrogen atom or an alkyl group having 1 to 20 carbon atoms, more preferably a hydrogen atom, a linear or branched alkyl group having 1 to 20 carbon atoms, still more preferably a hydrogen atom, a methyl group, an ethyl group, an n-propyl group, an n-butyl group, an n-pentyl group, an n-hexyl group, an n-heptyl group, an n-octyl group, an isopropyl group, an isobutyl group, a sec-butyl group, a tert-butyl group, an isopentyl group, a 2,2-dimethylpropyl group, a 1,1-dimethylpropyl group, a 1,1,2-trimethylpropyl group, a 1,1,2,2-tetramethylpropyl group and a 2-ethylhexyl group.

R^{e} and R^{f} in formula (I) is preferably an alkyl group having 1 to 20 carbon atoms, more preferably a linear or branched alkyl group having 1 to 20 carbon atoms, still more preferably a methyl group, an ethyl group, an n-propyl group, an n-butyl group, an n-pentyl group, an n-hexyl group, an n-heptyl group, an n-octyl group, an isopropyl group, an isobutyl group, a sec-butyl group, a tert-butyl group, an isopentyl group, a 2,2-dimethylpropyl group, a 1,1-dimethylpropyl group, a 1,1,2-trimethylpropyl group, a 1,1,2,2-tetramethylpropyl group and a 2-ethylhexyl group.

R^{e} and R^{f} in formula (I) may be bonded to each other to form a ring. Examples of such a ring include a cycloalkane ring such as a cyclopropane ring, a cyclobutane ring, a cyclopentane ring, a cyclohexane ring, a cycloheptane ring, a cyclooctane ring, a cyclononane ring, a cyclodecane ring, and a cyclododecane ring; a bicycloalkane ring such as a norbornane and a decalin; and a tricycloalkane ring such as an adamantine.

As to R^{g} and R^{h} in formula (I), the hydrocarbyl group having 1 to 5 carbon atoms may be an alkyl group or an alkenyl group, which may be substituted with a halogen atom, a silyl group or the like.

Examples of the alkyl group for R^{g} and R^{h} include a linear alkyl group such as a methyl group, an ethyl group, an n-propyl group, an n-butyl group, and an n-pentyl group; and a branched alkyl group such as an isopropyl group, an isobutyl group, a tert-butyl group, and an isopentyl group.

Examples of the alkenyl group for R^{g} and R^{h} include a linear alkenyl group such as a vinyl group and an allyl group.

R^{g} and R^{h} in formula (I) is preferably a linear alkyl group having 1 to 5 carbon atoms or a linear alkenyl group having 2 to 5 carbon atoms, more preferably a linear alkyl group having 1 to 5 carbon atoms, still more preferably a methyl group or an ethyl group, and most preferably a methyl group.

As to Rⁱ, Rⱼ, R^{k}, R^{l}, R^{m} and Rⁿ in formula (I), the hydrocarbyl group having 1 to 5 carbon atoms may be an alkyl group. Specific examples thereof include a linear alkyl group such as a methyl group, an ethyl group, an n-propyl group, an n-butyl group, and an n-pentyl group, which may be substituted with a halogen atom.

Rⁱ, R^{j}, R^{k}, R^{l}, R^{m} and Rⁿ in formula (I) is preferably a hydrogen atom, methyl group, an ethyl group, or an n-propyl group, more preferably a hydrogen atom or a methyl group, and particularly preferably a hydrogen atom.

Specific examples of the triether represented by the formula (I) include the following compounds:

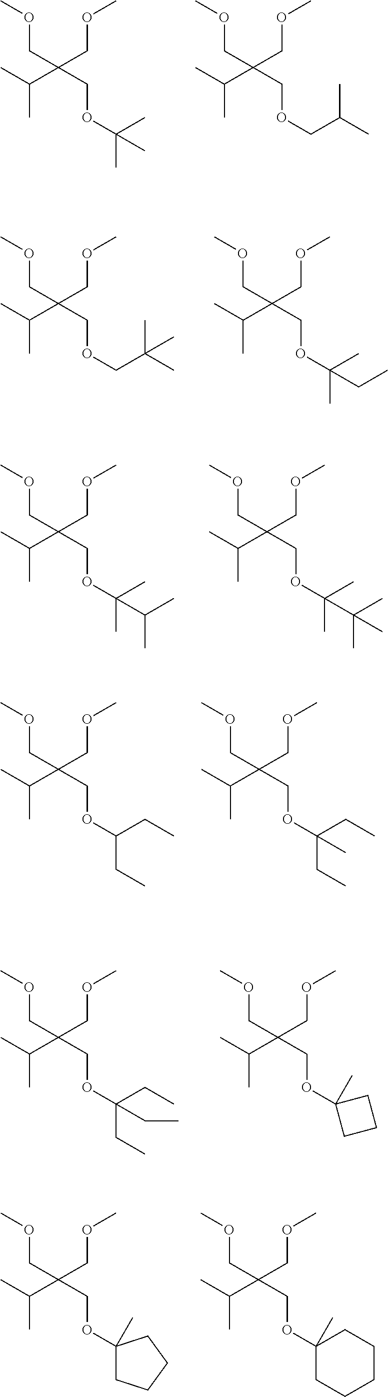

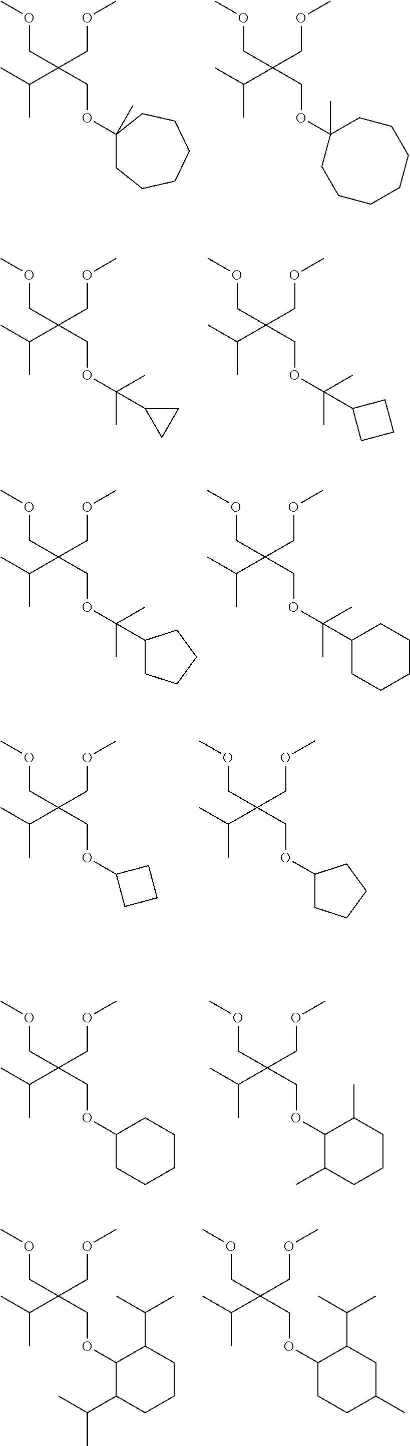

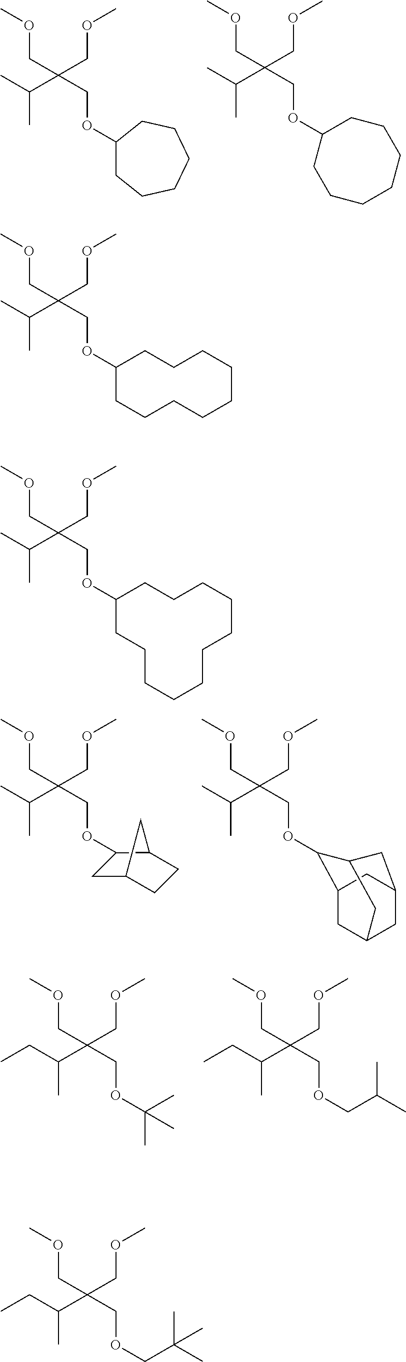

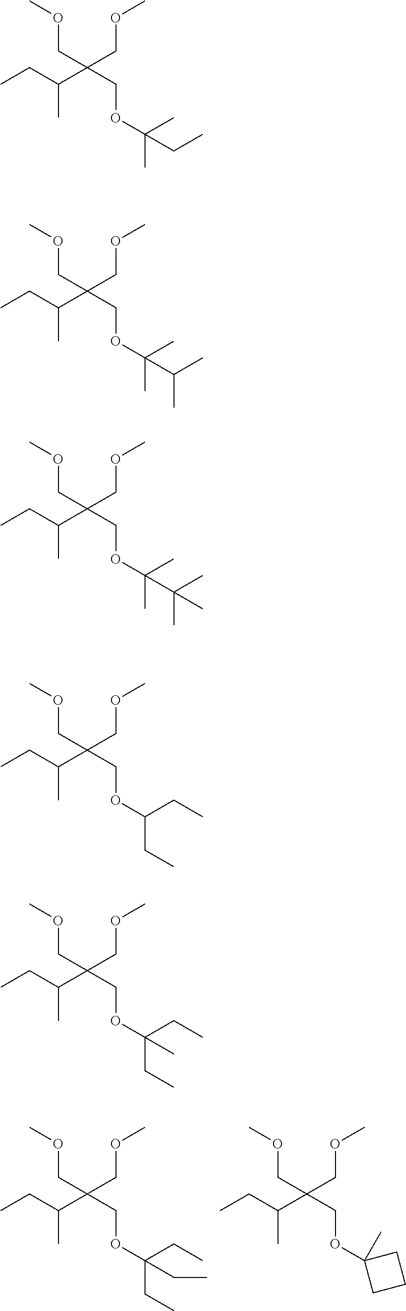

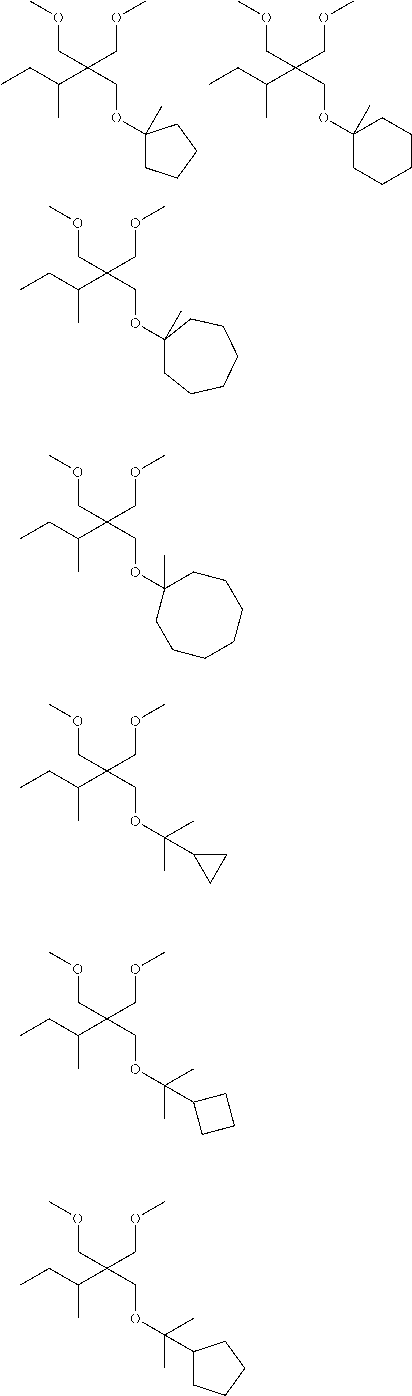

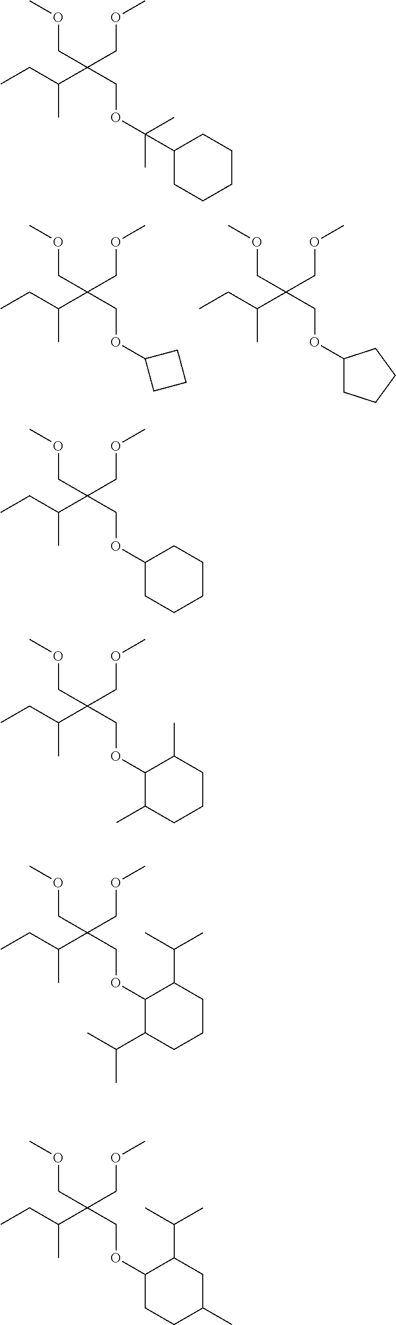

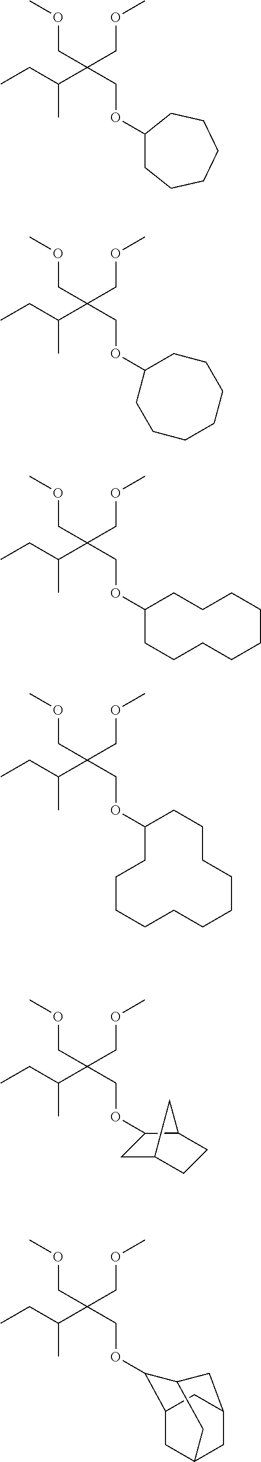

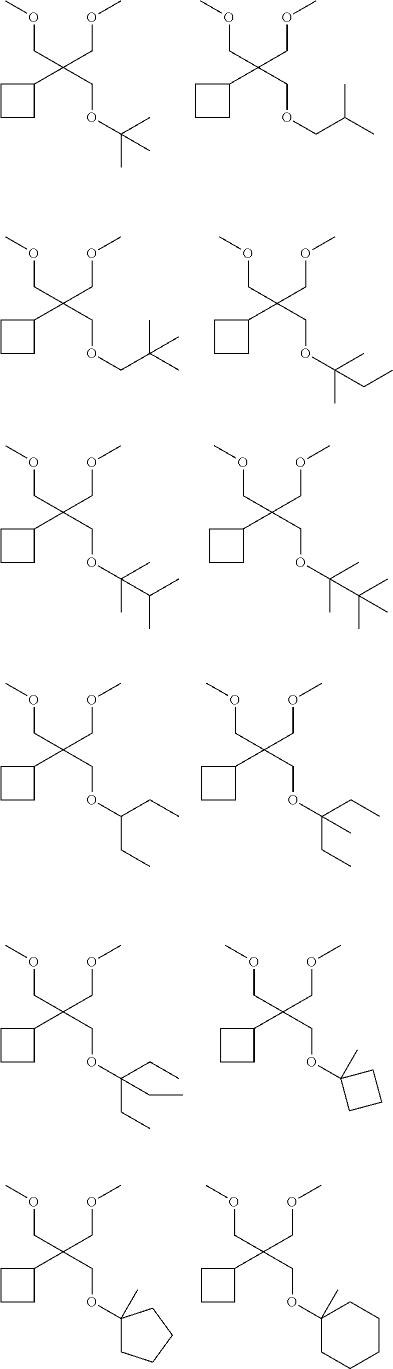

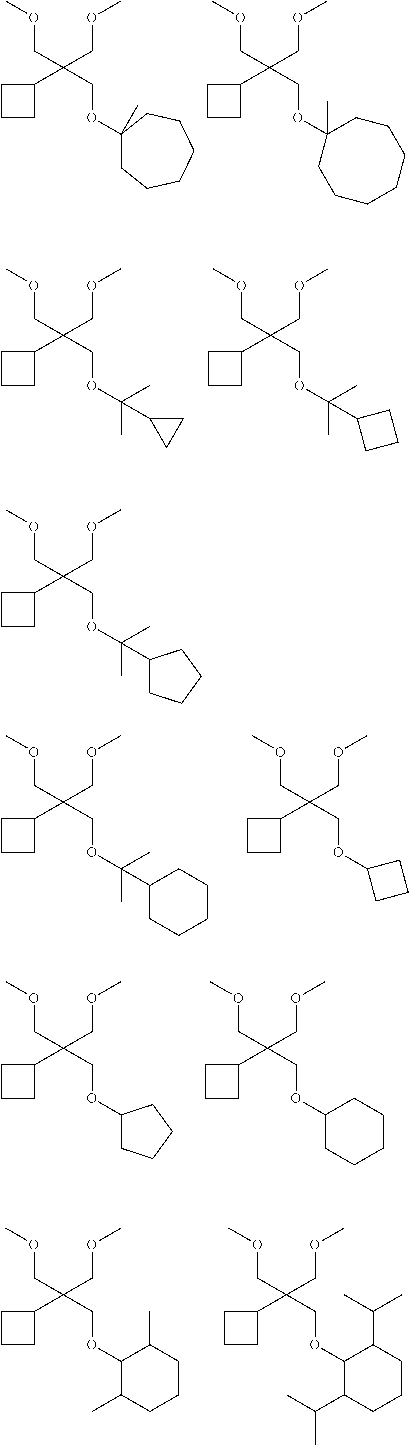

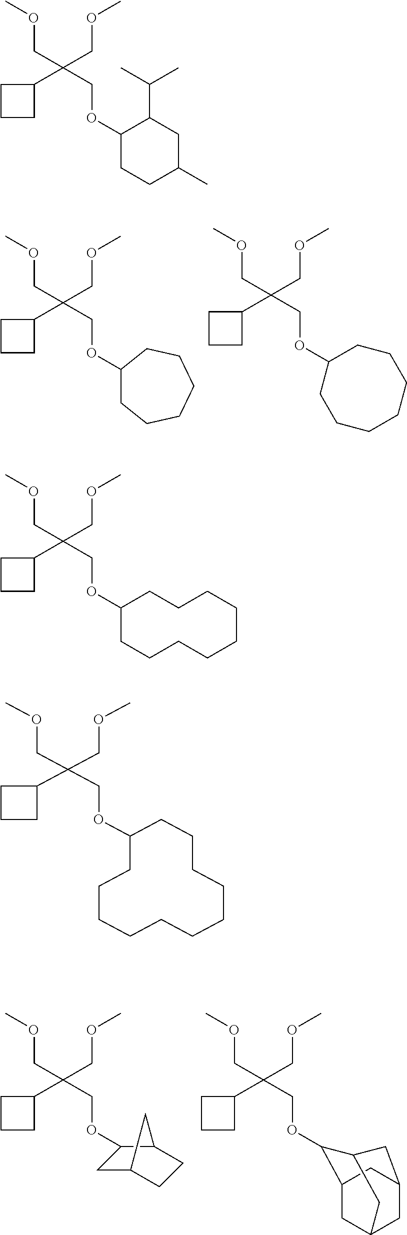

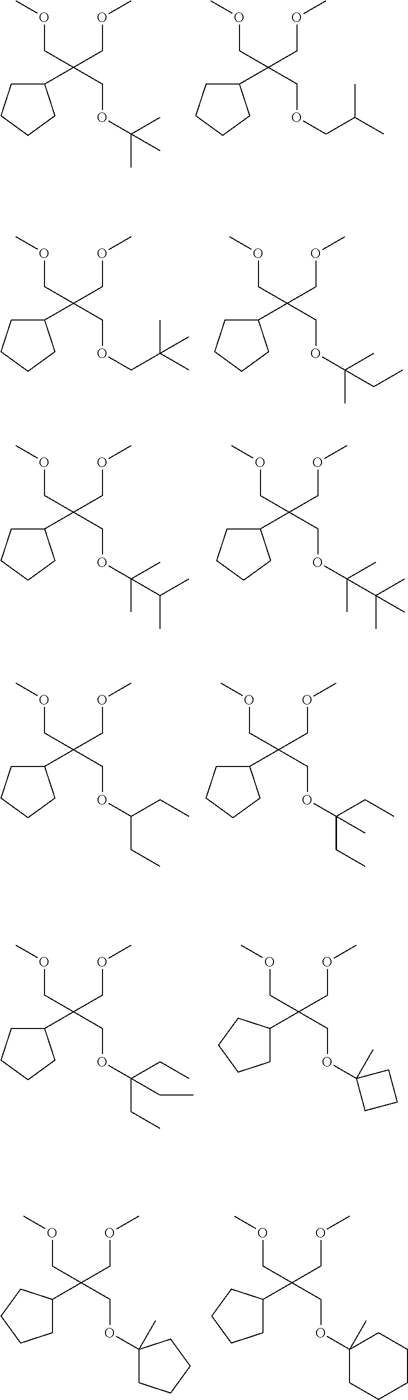

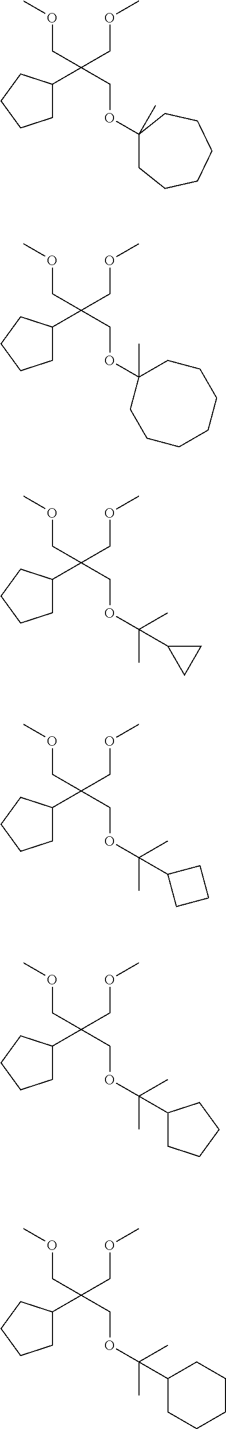 [SMILES: COCC(COC)(COC1(C)CCCCCC1)C1CCCC1 ; COCC(COC)(COC1(C)CCCCCCC1)C1CCCC1 ; COCC(COC)(COC(C)(C)C1CC1)C1CCCC1 ; COCC(COC)(COC(C)(C)C1CCC1)C1CCCC1 ; COCC(COC)(COC(C)(C)C1CCCC1)C1CCCC1 ; COCC(COC)(COC(C)(C)C1CCCCC1)C1CCCC1]

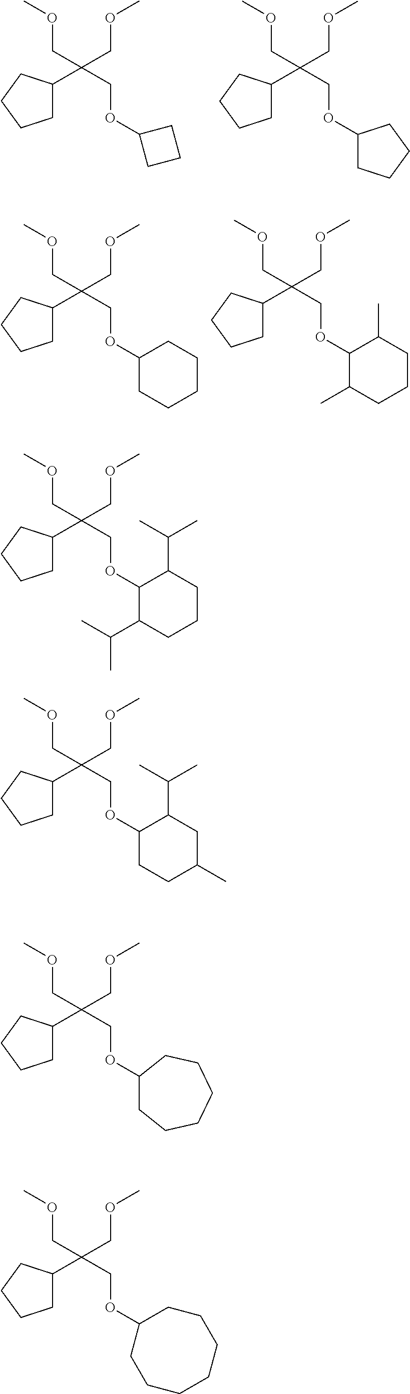

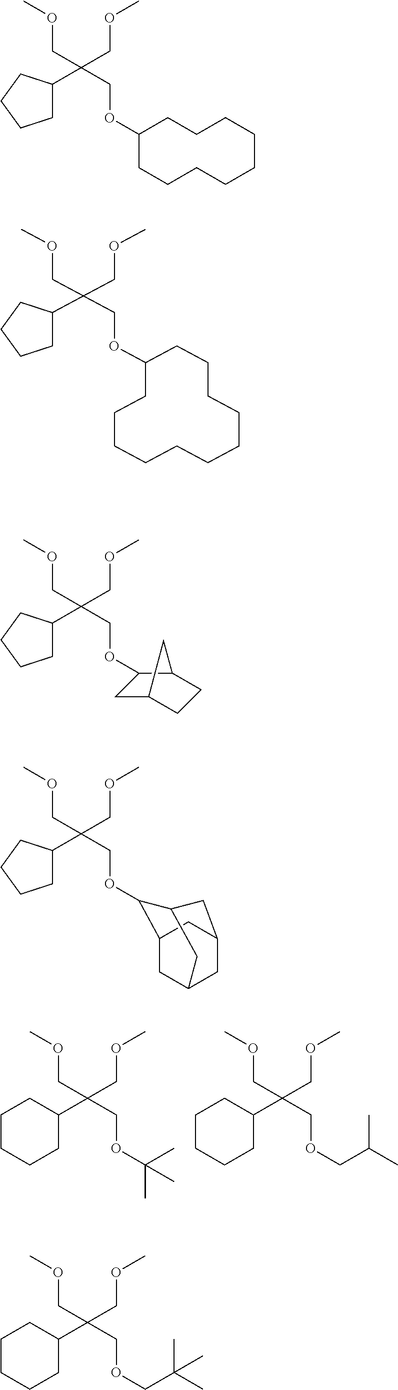

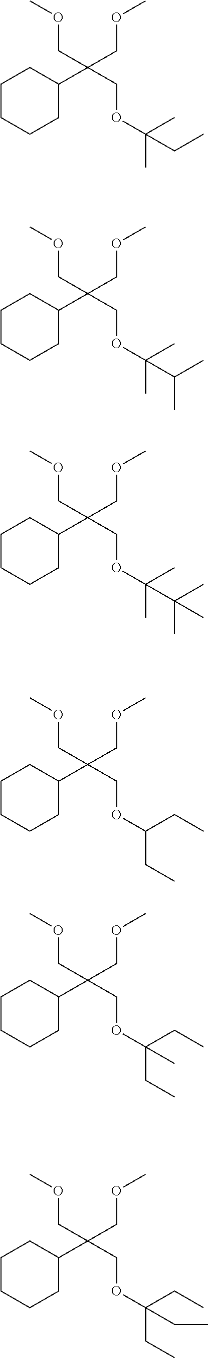

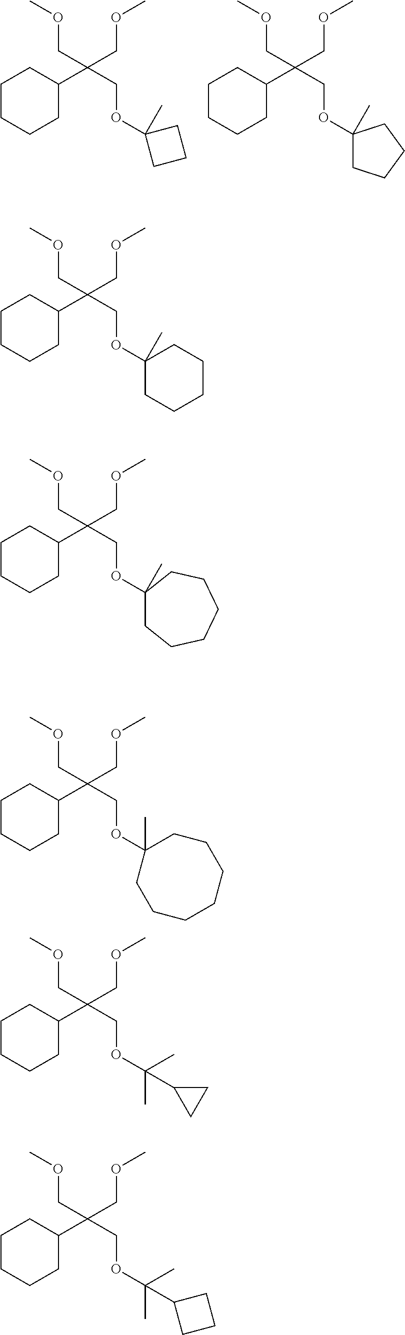

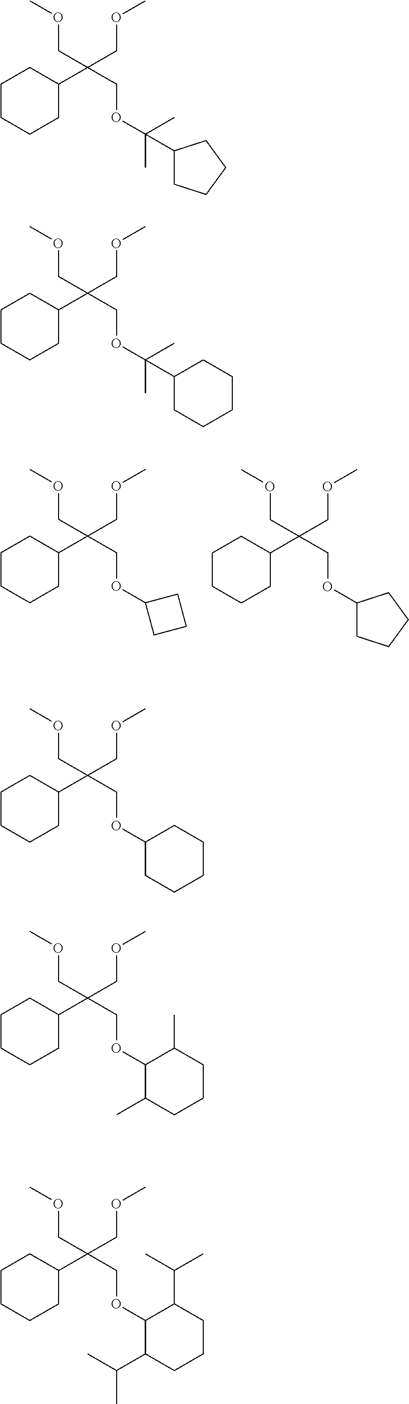

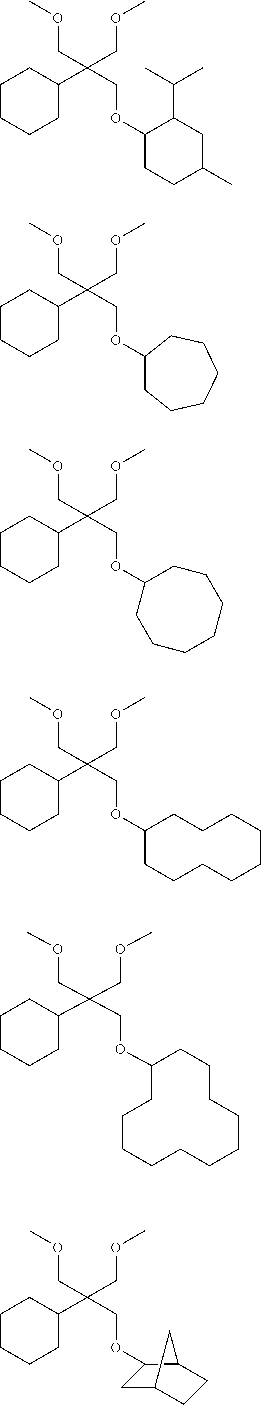 [SMILES: COCC(COC)(COC1CCC(C)CC1C(C)C)C1CCCCC1 ; COCC(COC)(COC1CCCCCC1)C1CCCCC1 ; COCC(COC)(COC1CCCCCCC1)C1CCCCC1 ; COCC(COC)(COC1CCCCCCCCC1)C1CCCCC1 ; COCC(COC)(COC1CCCCCCCCCCC1)C1CCCCC1 ; COCC(COC)(COC1CC2CCC1C2)C1CCCCC1]

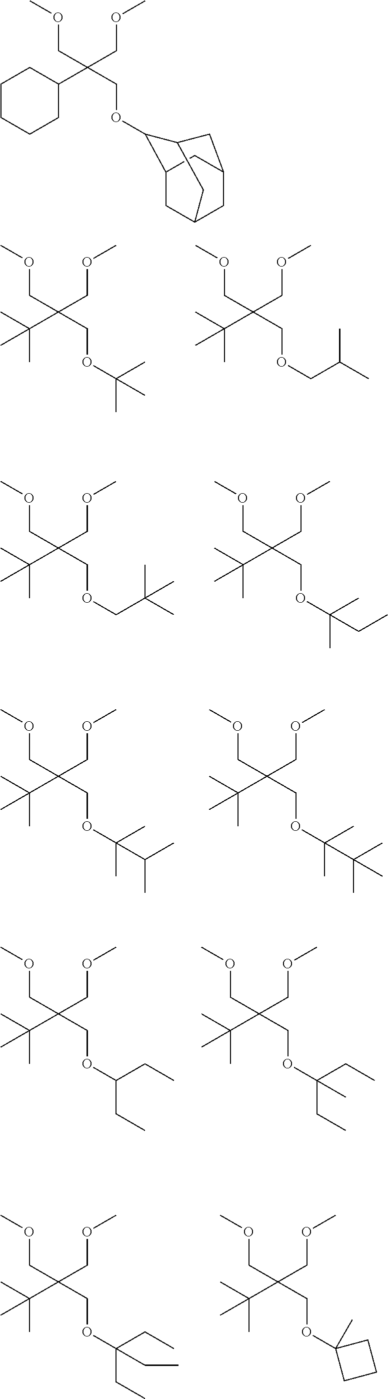

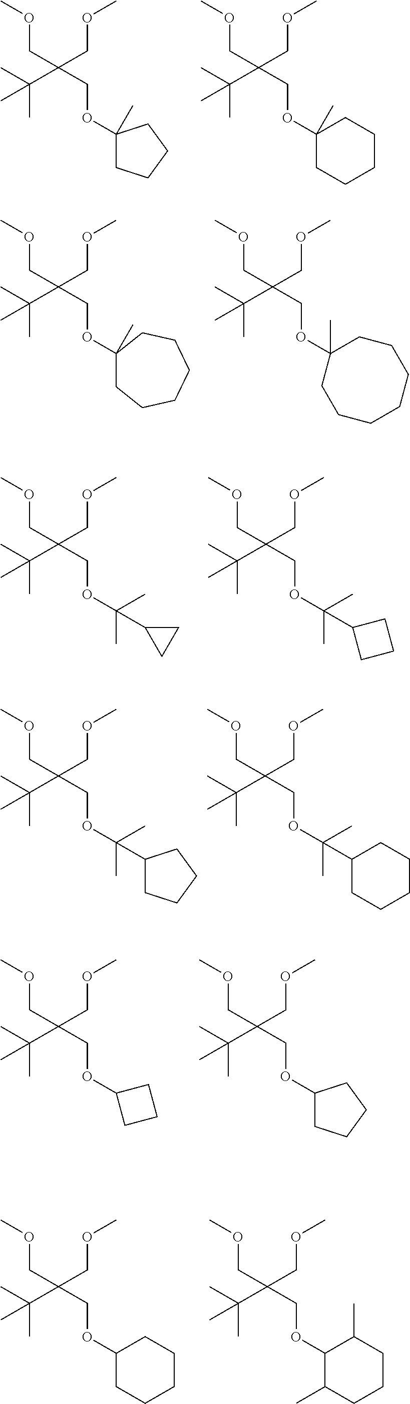

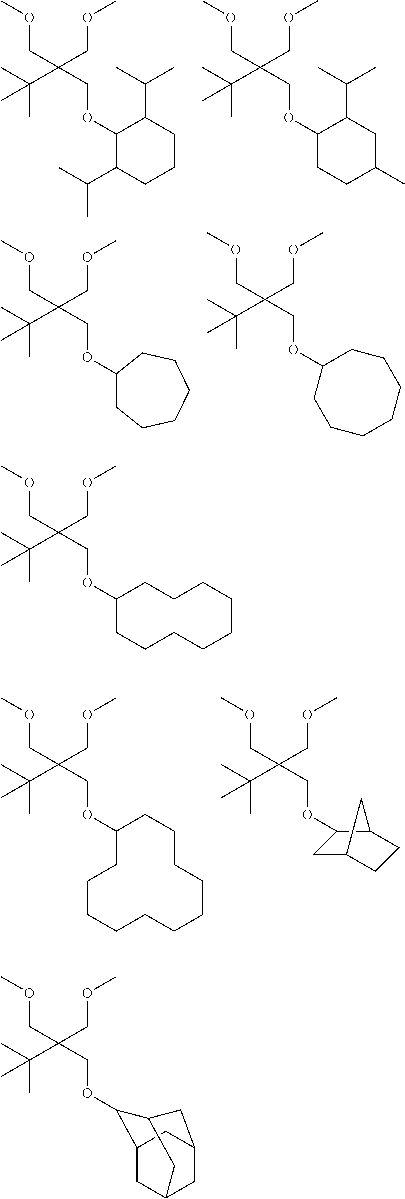

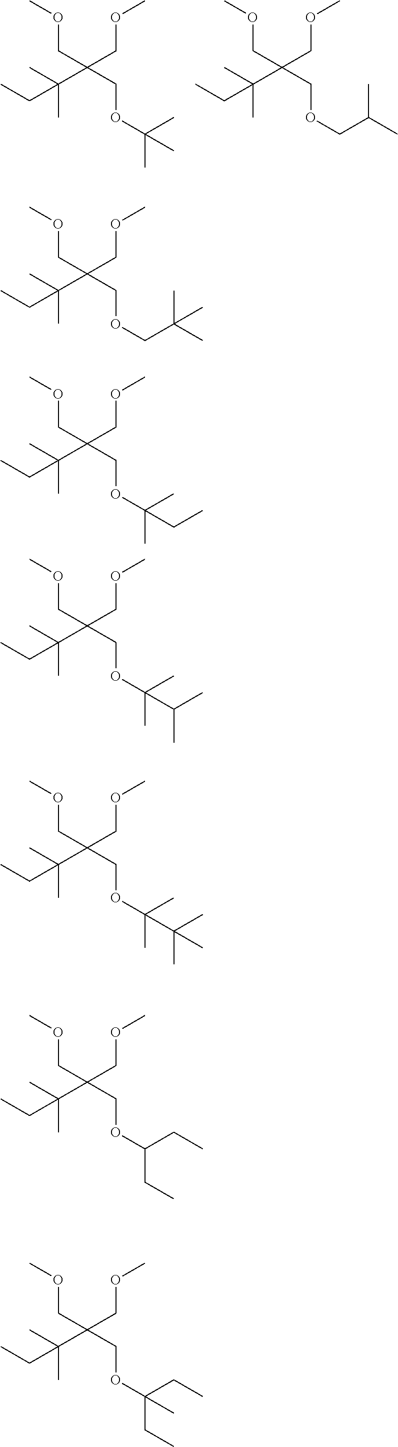

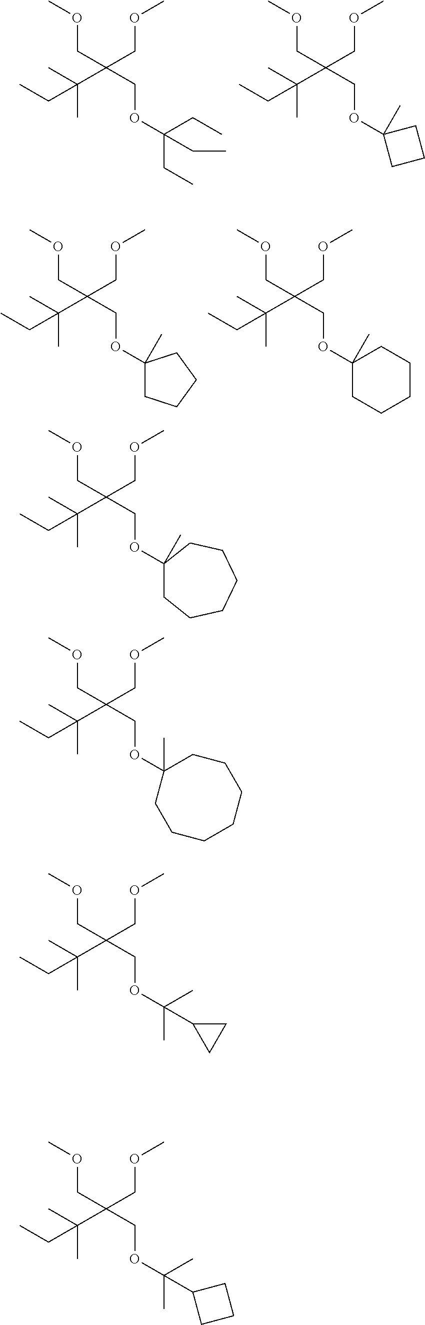

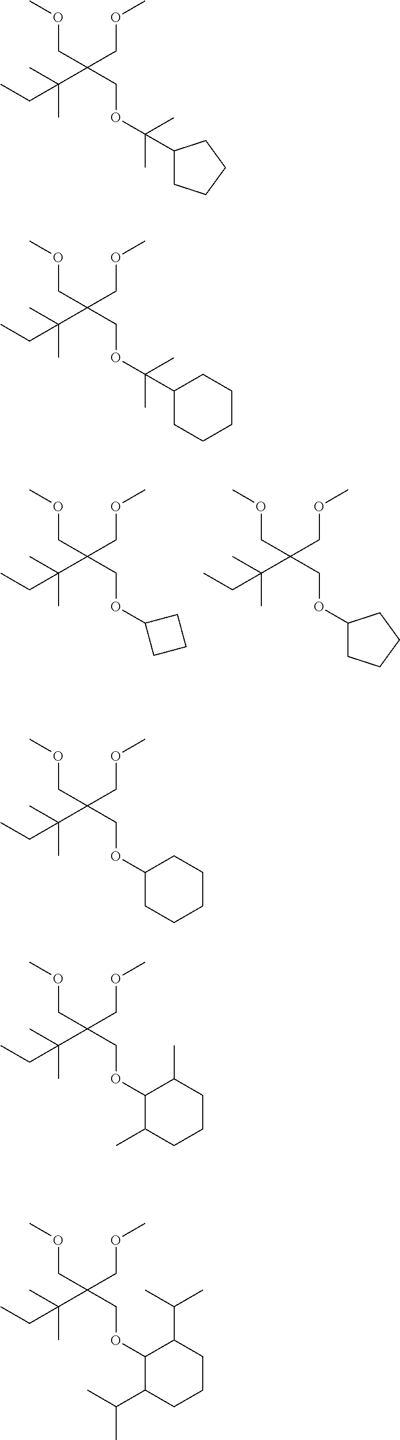

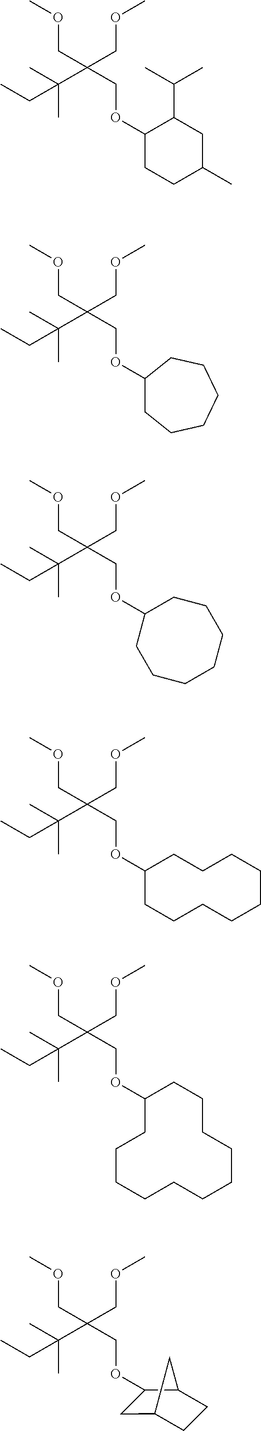

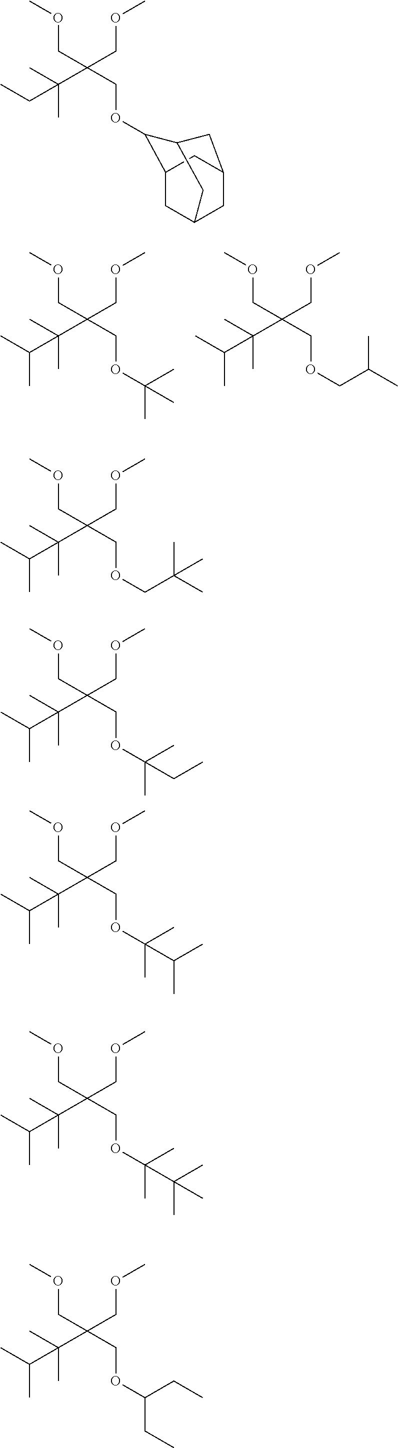

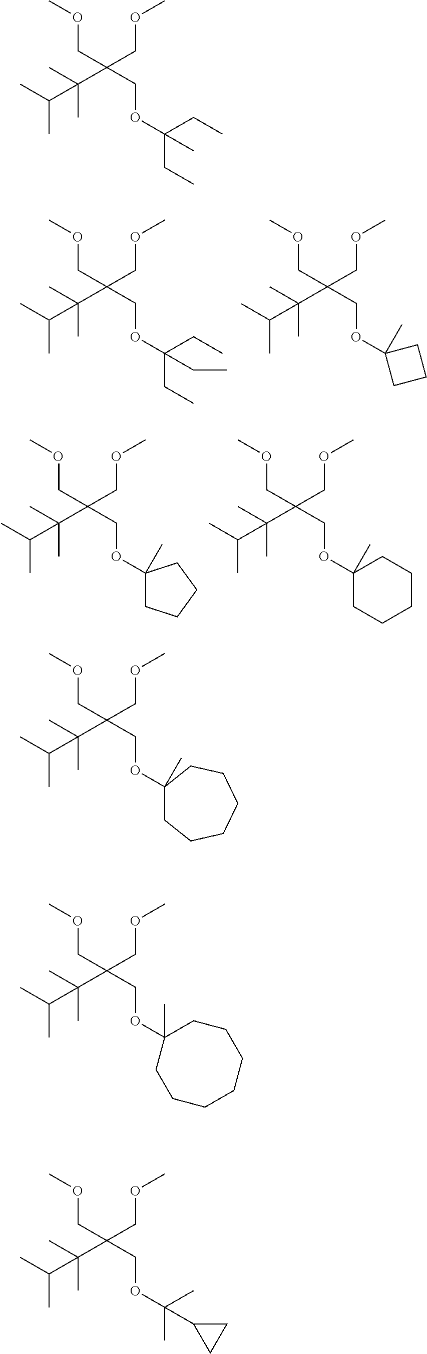

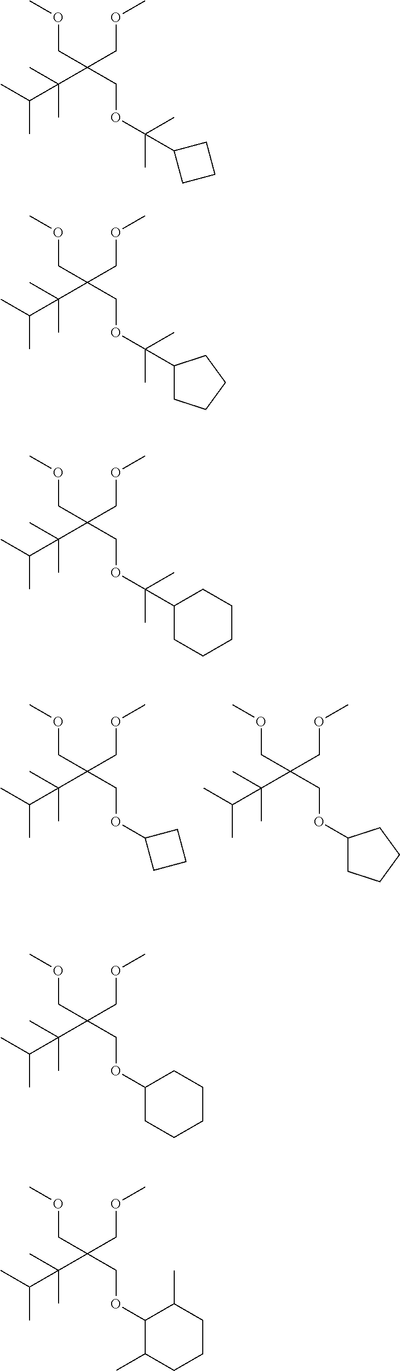

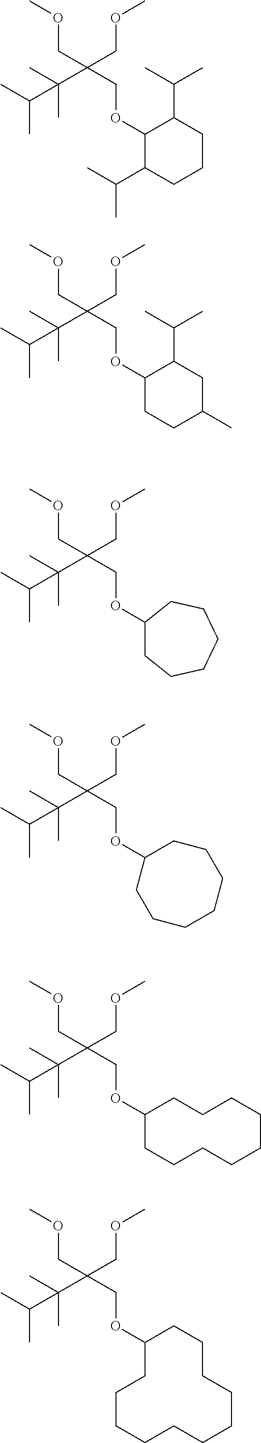

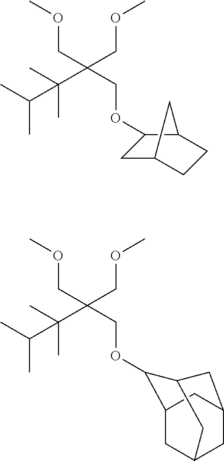 [SMILES: COCC(COC)(COC1CC2CCC1C2)C(C)(C)C(C)C ; COCC(COC)(COC1C2CC3CC(C2)CC1C3)C(C)(C)C(C)C]

In addition, as the triether represented by the formula (I), the compounds in which a methyl group corresponding to R^{g} and R^{h} in formula (I) is substituted by an ethyl group, an n-propyl group, an n-butyl group, or an n-pentyl group are employed.

### <Solid Catalyst Component (A)>

A method for producing the solid catalyst component (A) is not particularly limited, and it may be produced by the following methods (1) to (5):

production method (1): a method in which a solid component (a) comprising a titanium atom and a magnesium atom is brought into contact with an electron donor compound (b);

production method (2): a method in which a titanium compound (c), a magnesium compound (d) and an electron donor compound (b) are brought into contact with one another:

production method (3): a method in which a titanium compound (c), a magnesium compound (d), an electron donor compound (b) and an organic acid chloride (e) are brought into contact with one another;

production method (4): a method in which a solid component (a) comprising a titanium atom and a magnesium atom, an electron donor compound (b) and a metal halide compound represented by formula (vii) or (viii):

M¹R¹¹_{p-b}X³b (vii)

M¹(OR¹¹)_{p-b}X³_{b} (viii)

wherein M¹ is an element of Group 4, 13 or 14 of the periodic table, R¹¹ is a hydrocarbyl group having 1 to 20 carbon atoms, X³ is a halogen atom, p represents a valency of the element M¹, and b is an integer number satisfying 0<b≦p, are brought into contact with one another; and

production method (5): a method in which a solid component (a) comprising a titanium atom and a magnesium atom, an electron donor compound (b), a metal halide compound represented by formula (vii) or (viii):

M¹R¹¹_{p-b}X³_{b} (vii)

M¹(OR¹¹)_{p-b}X³_{b} (viii)

wherein M¹ is an element of Group 4, 13 or 14 of the periodic table, R¹¹ is a hydrocarbyl group having 1 to 20 carbon atoms, X³ is a halogen atom, p represents a valency of the element M¹, and b is an integer number satisfying 0<b≦p,

and an organic acid chloride (e) are brought into contact with one another.

### <Production Method (1)>

### <Solid Component (a) Comprising a Titanium Atom and a Magnesium Atom>

The solid component (a) is not particularly limited insofar as it contains a titanium atom and a magnesium atom. Examples thereof include a solid catalyst component precursor (a-1) comprising a titanium atom, a magnesium atom and a hydrocarbyloxy group, magnesium titanate and aluminum magnesium titanate described in WO 2004/039747. Among them, preferred is the solid catalyst component precursor (a-1).

The hydrocarbyloxy group which the solid catalyst component precursor (a-1) contains may be a hydrocarbyloxy group having 1 to 20 carbon atoms. Preferred are a methoxy group, an ethoxy group, an n-propoxy group, an isopropoxy group, an n-butoxy group, an isobutoxy group, a pentoxy group, a cyclopentoxy group and a cyclohexoxy group.

The solid catalyst component precursor (a-1) may be prepared by any production method. For example, a method in which a titanium compound (a-1b) is reduced with an organomagnesium compound (a-1c) in the presence of a silicon compound (a-1a) having a Si—O bond may be employed.

Examples of the silicon compound (a-1a) having a Si—O bond include those represented by the following formula (i), (ii) or (iii):

Si(OR¹)ₐR²₍₄₋ₐ₎ (i)

R³(R⁴₂SiO)₁SiR⁵₃ (ii)

(R⁶₂SiO)ₘ (iii)

wherein R¹ to R⁶ are each independently a hydrocarbyl group having 1 to 20 carbon atoms or a hydrogen atom, a is an integer number satisfying 0<a≦4, l is an integer number of 1 to 1000, and m is an integer number of 2 to 1000.

As to R¹ to R⁶ in formulae (i), (ii) and (iii), examples of the hydrocarbyl group include an alkyl group such as a methyl group, an ethyl group, an n-propyl group, an isopropyl group, an n-butyl group, an isobutyl group, an n-pentyl group, an isopentyl group, a hexyl group, a heptyl group, an octyl group, a decyl group and a dodecyl group; an aryl group such as a phenyl group, a cresyl group, a xylyl group and a naphthyl group; a cycloalkyl group such as a cyclohexyl group and a cyclopentyl group; an alkenyl group such as an allyl group; and an aralkyl group such as a benzyl group.

In the formulae (i), (ii) and (iii), R¹ to R⁶ are preferably an alkyl group having 2 to 18 carbon atoms or an aryl group having 6 to 18 carbon atoms, and particularly preferably a linear alkyl group having 2 to 18 carbon atoms.

Specific examples of the silicon compound (a-1a) include tetramethoxysilane, dimethyldimethoxysilane, tetraethoxysilane, triethoxyethylsilane, diethoxydiethylsilane, ethoxytriethylsilane, tetraisopropoxysilane, diisopropoxydiisopropylsilane, tetrapropoxysilane, dipropoxydipropylsilane, tetrabutoxysilane, dibutoxydibutylsilane, dicyclopentyloxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane and phenylhydropolysiloxane.

The silicon compound (a-1a) is preferably a compound represented by the formula (I) having “a” satisfying 1≦a≦4, more preferably a tetraalkoxysilane having “a” of 4, and most preferably tetraethoxysilane.

Examples of the titanium compound (a-1b) include those represented by the following formula (iv):

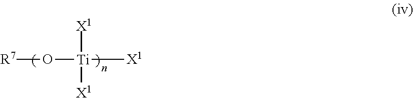

wherein n is an integer number of 1 to 20, R⁷ is a hydrocarbyl group having 1 to 20 carbon atoms, and groups X¹ each are a halogen atom or a hydrocarbyloxy group having 1 to 20 carbon atoms, and groups X¹ may be the same or different from each other.

Examples of R⁷ in formula (Iv) include an alkyl group such as a methyl group, an ethyl group, an n-propyl group, an isopropyl group, an n-butyl group, an isobutyl group, an n-pentyl group, an isopentyl group, a hexyl group, a heptyl group, an octyl group, a decyl group and a dodecyl group; an aryl group such as a phenyl group, a cresyl group, a xylyl group and a naphthyl group; a cycloalkyl group such as a cyclohexyl group and a cyclopentyl group; an alkenyl group such as an allyl group; and an aralkyl group such as a benzyl group. R⁷ is preferably an alkyl group having 2 to 18 carbon atoms or an aryl group having 6 to 18 carbon atoms, and particularly preferably a linear alkyl group having 2 to 18 carbon atoms.

As to X¹ in formula (Iv), the halogen atom may be a chlorine atom, a bromine atom and an iodine atom. Among them, a chlorine atom is particularly preferable.

The hydrocarbyloxy group having 1 to 20 carbon atoms for X¹ in formula (Iv) is preferably an alkoxy group having 2 to 18 carbon atoms, more preferably an alkoxy group having 2 to 10 carbon atoms, and particularly preferably an alkoxy group having 2 to 6 carbon atoms.

Specific examples of the titanium compound (a-1b) include tetramethoxytitanium, tetraethoxytitanium, tetrapropoxytitanium, tetraisopropoxytitanium, tetrabutoxytitanium, tetraisobutoxytitanium, butoxytitanium trichloride, dibutoxytitanium dichloride, tributoxytitanium chloride, ditetraisopropylpolytitanate which is a mixture of compounds having “n” of 2 to 10 in the above formula (iv), tetrabutylpolytitanate which is a mixture of compounds having “n” of 2 to 10 in the above formula (iv), tetrahexylpolytitanate which is a mixture of compounds having “n” of 2 to 10 in the above formula (iv), tetraoctylpolytitanate which is a mixture of compounds having “n” of 2 to 10 in the above formula (iv), a condensate obtained by reacting tetraalkoxytitanium with a small amount of water, and a combination of two or more thereof.

The titanium compound (a-1b) represented by the formula (iv) is preferably a titanium compound having “n” of 1, 2 or 4 in formula (iv), particularly preferably is tetra-n-alkoxytitanium, and still more preferably tetrabutoxytitanium.

The organomagnesium compound (a-1c) is a compound containing a magnesium-carbon bond therein. Examples of the organomagnesium compound (a-1c) include the compounds represented by the following formula (v) or (vi):

R⁸MgX² (v)

R⁹R¹⁰Mg (vi)

wherein R⁸, R⁹ and R¹⁰ are each independently a hydrocarbyl group having 1 to 20 carbon atoms, and X² is a halogen atom. As the organomagnesium compound (a-1c), a Grignard compound represented by the formula (v) is preferable, and an ether solution of the Grignard compound is particularly preferable, because a catalyst having a good shape can be obtained.

As to R⁸, R⁹ and R¹⁰ in formulae (v) and (vi), examples of the hydrocarbyl group having 1 to 20 carbon atoms include an alkyl group, an aryl group, an aralkyl group and an alkenyl group, those groups having 1 to 20 carbon atoms, such as a methyl group, an ethyl group, an n-propyl group, an isopropyl group, an n-butyl group, a sec-butyl group, a tert-butyl group, an isopentyl group, a hexyl group, an n-octyl group, a 2-ethylhexyl group, a phenyl group, an allyl group and a benzyl group.

In the formulae (v) and (vi), R⁸, R⁹ and R¹⁰ are preferably an alkyl group having 2 to 18 carbon atoms or an aryl group having 6 to 18 carbon atoms, and particularly preferably an alkyl group having 2 to 18 carbon atoms.

Examples of X² in formula (v) include a chlorine atom, a bromine atom and an iodine atom. Among them, a chlorine atom is particularly preferable.

Examples of the Grignard compound represented by the above formulae include methylmagnesium chloride, ethylmagnesium chloride, propylmagnesium chloride, isopropylmagnesium chloride, butylmagnesium chloride, isobutylmagnesium chloride, tert-butylmagnesium chloride, pentylmagnesium chloride, isopentylmagnesium chloride, cyclopentylmagnesium chloride, hexylmagnesium chloride, cyclohexylmagnesium chloride, octylmagnesium chloride, 2-ethylhexylmagnesium chloride, phenylmagnesium chloride and benzylmagnesium chloride. Among them, ethylmagnesium chloride, propylmagnesium chloride, isopropylmagnesium chloride, butylmagnesium chloride and isobutylmagnesium chloride are preferable, and butylmagnesium chloride is particularly preferable.

These Grignard compounds are preferably used in the form of an ether solution thereof. Examples of the ether include a dialkyl ether such as diethyl ether, dipropyl ether, diisopropyl ether, dibutyl ether, diisobutyl ether, ethyl butyl ether and diisopentyl ether, as well as a cyclic ether such as tetrahydrofuran. Among them, a dialkyl ether is preferable, and dibutyl ether and diisobutyl ether are particularly preferable.

When the titanium compound (a-1b) is reduced with the organomagnesium compound (a-1c) in the presence of the silicon compound (a-1a) having a Si—O bond, an esters (a-1d) may be additionally present.

Examples of the esters (a-1d) are aliphatic carboxylic acid esters, aromatic carboxylic acid esters, aliphatic dicarboxylic acid diesters, and aromatic dicarboxylic acid diesters. Specific examples thereof include methyl acetate, ethyl acetate, phenyl acetate, methyl propionate, ethyl propionate, ethyl butyrate, ethyl valerate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, monoethyl phthalate, dimethyl phthalate, methyl ethyl phthalate, diethyl phthalate, dipropyl phthalate, diisopropyl phthalate, dibutyl phthalate, diisobutyl phthalate, dipentyl phthalate, dihexyl phthalate, diheptyl phthalate, dioctyl phthalate, di(2-ethylhexyl) phthalate, diisodecyl phthalate, dicyclohexyl phthalate and diphenyl phthalate. Among them, preferred are aromatic carboxylic acid esters such as benzoic acid esters and aromatic dicarboxylic acid diesters such as phthalic acid esters.

In the reduction reaction, a solvent may be used. Examples of the solvent include aliphatic hydrocarbon solvents such as hexane, heptane, octane and decane; aromatic hydrocarbon solvents such as toluene and xylene; alicyclic hydrocarbon solvents such as cyclohexane, methylcyclohexane and decalin; dialkyl ether such as diethyl ether, dipropyl ether, diisopropyl ether, dibutyl ether, diisobutyl ether, ethyl butyl ether and diisopentyl ether; a cyclic ether such as tetrahydrofuran; halogenated hydrocarbon solvents such as chlorobenzene and dichlorobenzene; and combinations of two or more thereof. Among them, aliphatic hydrocarbon solvents, aromatic hydrocarbon solvents and alicyclic hydrocarbon solvents are preferable, aliphatic hydrocarbon solvents and alicyclic hydrocarbon solvents are more preferable, aliphatic hydrocarbon solvents are still more preferable, and hexane and heptane are particularly preferable.

In the reduction reaction, it is preferable to use the silicon compound (a-1a) having a Si—O bond in an amount so that the total amount of the silicon atom may be usually 1 mol to 500 mol, preferably 1 mol to 300 mol, and particularly preferably 3 mol to 100 mol, per 1 mol of the titanium atoms which the titanium compound (a-1b) to be used contains.

In the reduction reaction, it is preferable to use the organomagnesium compound (a-1c) in an amount so that the total amount of the titanium atom and the silicon atom may be usually 0.1 mol to 10 mol, preferably 0.2 mol to 5.0 mol, and particularly preferably 0.5 mol to 2.0 mol, per 1 mol of the magnesium atoms which the organomagnesium compound (a-1c) to be used contains.

In addition, the amount of the titanium compound (a-1b), the silicon compound (a-1a) having a Si—O bond and the organomagnesium compound (a-1c) to be used in the reduction reaction may be decided so that the amount of the magnesium atom which the resultant solid catalyst component precursor (a-1) contains may be 1 mol to 51 mol, preferably 2 mol to 31 mol, and particularly preferably 4 mol to 26 mol, per 1 mol of the titanium atom which the precursor (a-1) contains.

In the reduction reaction, it is preferable to use the esters (a-1d) in an amount of usually 0.05 mol to 100 mol, preferably 0.1 mol to 60 mol, and particularly preferably 0.2 mol to 30 mol.

When an organomagnesium compound (a-1c) is added to a solution containing a silicon compound (a-1a) having a Si—O bond and a titanium compound (a-1b) and a solvent in the reduction reaction, the organomagnesium compound (a-1c) is added at a temperature of usually −50° C. to 100° C., preferably −30° C. to 70° C., and particularly preferably −25° C. to 50° C. An addition time of the organomagnesium compound (a-1c) is usually from 30 minutes to 10 hours. It is preferable to add the organomagnesium compound (a-1c) continuously so as to obtain a catalyst having good shape. The reaction may be further carried out at 5° C. to 120° C. in order to promote the reaction.

In addition, it is possible to use a carrier in the reduction reaction so as to support the solid catalyst component precursor (a-1) on the carrier. The carrier is not particularly limited, and examples thereof include porous inorganic oxides such as SiO₂, Al₂O₃, MgO, TiO₂ and ZrO₂; and porous organic polymers such as polystyrene, a styrene-divinylbenzene copolymer, a styrene-ethylene glycol-dimethacrylate copolymer, polymethyl acrylate, polyethyl acrylate, a methyl acrylate-divinylbenzene copolymer, polymethyl methacrylate, a methyl methacrylate-divinylbenzene copolymer, polyacrylonitrile, an acrylonitrile-divinylbenzene copolymer, polyvinyl chloride, polyethylene and polypropylene. Among them, preferred are porous organic polymers, and particularly preferred is a porous organic polymer which is composed of a styrene-divinylbenzene copolymer.

Preferred is a porous carrier in which a pore volume of pores having a pore radius of 20 nm to 200 nm is preferably 0.3 cm³/g or more, and more preferably 0.4 cm³/g or more, and the above pore volume is preferably 35% or more, and more preferably 40% or more relative to the pore volume of pores having a pore radius of 3.5 nm to 7500 nm, in order to efficiently fix the solid catalyst component precursor (a-1) on a carrier.

The titanium atom is reduced from quadrivalent to trivalent since the reduction reaction of a titanium compound with an organomagnesium compound (a-1c) is promoted by adding a silicon compound (a-1a) having a Si—O bond, a titanium compound (a-1b) represented by formula (v), and optionally esters (a-1d). Preferably, all of titanium atoms are substantially reduced from quadrivalent to trivalent in the present invention. The obtained solid catalyst component precursor (a-1) contains trivalent titanium atoms, magnesium atoms and hydrocarbyloxy groups, and has generally an amorphous or very weak crystalline structure. Preferably, the precursor (a-1) has an amorphous structure.

The obtained solid catalyst component precursor (a-1) may be washed with a solvent. Examples of the solvent include aliphatic hydrocarbon solvents such as pentane, hexane, heptane, octane and decane; aromatic hydrocarbon solvents such as benzene, toluene, ethylbenzene and xylene; alicyclic hydrocarbon solvents such as cyclohexane and cyclopentane; halogenated hydrocarbon solvents such as 1,2-dichloroethane and monochlorobenzene. Among them, aliphatic hydrocarbon solvents and aromatic hydrocarbon solvents are preferable, aromatic hydrocarbon solvents are more preferable, and toluene and xylene are particularly preferable.

### <Electron Donor Compound (B)>

The electron donor compound (b) is an organic compound containing an oxygen atom or a nitrogen atom. Examples thereof include alcohols, ethers, esters, ketones, aldehydes, amines, and amides.

Examples of the alcohols include an aliphatic alcohol such as methanol, ethanol, propanol and 2-ethylhexanol; and an aromatic alcohol such as phenol and cresol.

Examples of the ketones include an aliphatic ketone such as acetone, methyl ethyl ketone and methyl butyl ketone; and an aromatic ketone such as acetophenone and benzophenone.

Examples of the aldehydes include an aliphatic aldehyde such as acetaldehyde, propionaldehyde and octylaldehyde; and an aromatic aldehyde such as benzaldehyde.

Examples of the ethers include a dialkyl ether such as dimethyl ether, diethyl ether, dipropyl ether, dibutyl ether, dipentyl ether and the tert-butylmethyl ether; an aromatic ether such as diphenyl ether; an aliphatic diether such as 2-butyl-2-ethyl-1,3-dimethoxypropane, 2-isopropyl-2-isopentyl-1,3-dimethoxypropane, 2,2-diisobutyl-1,3-dimethoxypropane, 2,2-dicyclohexyl-1,3-dimethoxypropane, 2,2-bis(cyclohexylmethyl)-1,3-dimethoxypropane, 2-cyclohexyl-2-isopropyl-1,3-dimethoxypropane, 2-isopropyl-2-sec-butyl-1,3-dimethoxypropane, 2,2-diphenyl-1,3-dimethoxypropane and 2-cyclopentyl-2-isopropyl-1,3-dimethoxypropane; and an aromatic diether such as 1,1-bis(methoxymethyl)indenyl and 9,9-bis(methoxymethyl)fluorene.

Examples of the esters include aliphatic carboxylic acid esters, aromatic carboxylic acid esters, aliphatic dicarboxylic acid diesters, aromatic dicarboxylic acid diesters, and diol esters.

Specific examples the aliphatic carboxylic acid esters include aliphatic monocarboxylic acid esters such as methyl formate, ethyl acetate, vinyl acetate, propyl acetate, octyl acetate, cyclohexyl acetate, ethyl propionate and ethyl butyrate; aliphatic carboxylic acid esters having an alkoxy group, such as ethyl 3-ethoxy-2-isopropylpropionate, ethyl 3-ethoxy-2-isobutylpropionate, ethyl 3-ethoxy-2-tert-butylpropionate, ethyl 3-ethoxy-2-tert-pentylpropionate, ethyl 3-ethoxy-2-cyclohexylpropionate, ethyl 3-ethoxy-2-cyclopentylpropionate, ethyl 3-ethoxy-2-adamantylpropionate, ethyl 3-ethoxy-2-(2,3-dimethylbutan-2-yl)propionate, ethyl 3-ethoxy-2-(2,3,3-trimethylbutan-2-yl)propionate, ethyl 3-ethoxy-2-(2-methylhexan-2-yl)propionate, ethyl 3-isobutoxy-2-isopropylpropionate, ethyl 3-isobutoxy-2-isobutylpropionate, ethyl 3-isobutoxy-2-tert-butylpropionate, ethyl 3-isobutoxy-2-tert-pentylpropionate, ethyl 3-isobutoxy-2-cyclohexylpropionate, ethyl 3-isobutoxy-2-cyclopentylpropionate, ethyl 3-isobutoxy-2-adamantylpropionate, ethyl 3-methoxy-2-isopropylpropionate, ethyl 3-methoxy-2-isobutylpropionate, ethyl 3-methoxy-2-tert-butylpropionate, ethyl 3-methoxy-2-tert-pentylpropionate, ethyl 3-methoxy-2-cyclohexylpropionate, ethyl 3-methoxy-2-cyclopentylpropionate, ethyl 3-methoxy-2-adamantylpropionate, ethyl 3-methoxy-2-(2,3-dimethylbutan-2-yl)propionate, ethyl 3-methoxy-2-(2,3,3-trimethylbutan-2-yl)propionate, ethyl 3-methoxy-2-(2-methylhexan-2-yl)propionate, methyl 3-ethoxy-2-isopropylpropionate, methyl 3-ethoxy-2-isobutylpropionate, methyl 3-ethoxy-2-tert-butylpropionate, methyl 3-ethoxy-2-tert-pentylpropionate, methyl 3-ethoxy-2-cyclohexylpropionate, methyl 3-ethoxy-2-cyclopentylpropionate, methyl 3-ethoxy-2-adamantylpropionate, methyl 3-ethoxy-2-(2,3-dimethylbutan-2-yl)propionate, methyl 3-ethoxy-2-(2,3,3-trimethylbutan-2-yl)propionate, methyl 3-ethoxy-2-(2-methylhexan-2-yl)propionate, methyl 3-methoxy-2-isopropylpropionate, methyl 3-methoxy-2-isobutyl propionate, methyl 3-methoxy-2-tert-butylpropionate, methyl 3-methoxy-2-tert-pentylpropionate, methyl 3-methoxy-2-cyclohexylpropionate, methyl 3-methoxy-2-cyclopentylpropionate, methyl 3-methoxy-2-adamantylpropionate, methyl 3-methoxy-2-(2,3-dimethylbutan-2-yl)propionate, methyl 3-methoxy-2-(2,3,3-trimethylbutan-2-yl)propionate, methyl 3-methoxy-2-(2-methylhexan-2-yl)propionate, ethyl 3-ethoxy-3-isopropyl-2-isobutylpropionate, ethyl 3-ethoxy-3-isobutyl-2-isobutylpropionate, ethyl 3-ethoxy-3-isobutyl-2-tert-butylpropionate, ethyl 3-ethoxy-2,3-di-tert-butylpropionate, ethyl 3-ethoxy-3-isobutyl-2-tert-pentylpropionate, ethyl 3-ethoxy-3-tert-butyl-2-tert-pentylpropionate, ethyl 3-ethoxy-2,3-di-tert-pentylpropionate, ethyl 3-ethoxy-3-isobutyl-2-cyclohexylpropionate, ethyl 3-ethoxy-2,3-dicyclohexylpropionate, ethyl 3-ethoxy-3-isobutyl-2-cyclopentylpropionate, ethyl 3-ethoxy-2,3-dicyclopentylpropionate, ethyl 3-methoxy-2,2-diisopropylpropionate, methyl 3-methoxy-2,2-diisopropylpropionate, ethyl 3-ethoxy-2,2-diisopropylpropionate, methyl 3-ethoxy-2,2-diisopropylpropionate, methyl 3-methoxy-2-isopropyl-2-isobutylpropionate, ethyl 3-methoxy-2-isopropyl-2-isobutylpropionate, ethyl 3-ethoxy-2-isopropyl-2-isobutylpropionate, methyl 3-methoxy-2-isopropyl-2-tert-butylpropionate, ethyl 3-methoxy-2-isopropyl-2-tert-butylpropionate, ethyl 3-ethoxy-2-isopropyl-2-tert-butylpropionate, methyl 3-methoxy-2-isopropyl-2-tert-pentylpropionate, ethyl 3-methoxy-2-isopropyl-2-tert-pentylpropionate, ethyl 3-ethoxy-2-isopropyl-2-tert-pentylpropionate, methyl 3-methoxy-2-isopropyl-2-cyclopentylpropionate, ethyl 3-methoxy-2-isopropyl-2-cyclopentylpropionate, ethyl 3-ethoxy-2-isopropyl-2-cyclopentylpropionate, methyl 3-methoxy-2-isopropyl-2-cyclohexylpropionate, ethyl 3-methoxy-2-isopropyl-2-cyclohexylpropionate, ethyl 3-ethoxy-2-isopropyl-2-cyclohexylpropionate, ethyl 3-methoxy-2,2-diisobutylpropionate, methyl 3-methoxy-2,2-diisobutylpropionate, ethyl 3-ethoxy-2,2-diisobutylpropionate, methyl 3-ethoxy-2,2-diisobutylpropionate, methyl 3-methoxy-2-isobutyl-2-tert-butylpropionate, ethyl 3-methoxy-2-isobutyl-2-tert-butylpropionate, ethyl 3-ethoxy-2-isobutyl-2-tert-butylpropionate, methyl 3-methoxy-2-isobutyl-2-tert-pentylpropionate, ethyl 3-methoxy-2-isobutyl-2-tert-pentylpropionate, ethyl 3-ethoxy-2-isobutyl-2-tert-pentylpropionate, methyl 3-methoxy-2-isobutyl-2-cyclopentylpropionate, ethyl 3-methoxy-2-isobutyl-2-cyclopentylpropionate, ethyl 3-ethoxy-2-isobutyl-2-cyclopentylpropionate, methyl 3-methoxy-2-isobutyl-2-cyclohexylpropionate, ethyl 3-methoxy-2-isobutyl-2-cyclohexylpropionate, ethyl 3-ethoxy-2-isobutyl-2-cyclohexylpropionate, ethyl 3-methoxy-2,2-di-tert-butylpropionate, methyl 3-methoxy-2,2-di-tert-butylpropionate, ethyl 3-ethoxy-2,2-di-tert-butylpropionate, methyl 3-ethoxy-2,2-di-tert-butylpropionate, methyl 3-methoxy-2-tert-butyl-2-methylpropionate, ethyl 3-methoxy-2-tert-butyl-2-methylpropionate, ethyl 3-ethoxy-2-tert-butyl-2-methylpropionate, methyl 3-methoxy-2-tert-butyl-2-ethylpropionate, ethyl 3-methoxy-2-tert-butyl-2-ethylpropionate, ethyl 3-ethoxy-2-tert-butyl-2-ethylpropionate, methyl 3-methoxy-2-tert-butyl-2-propylpropionate, ethyl 3-methoxy-2-tert-butyl-2-propylpropionate, ethyl 3-ethoxy-2-tert-butyl-2-propylpropionate, methyl 3-methoxy-2-tert-butyl-2-butylpropionate, ethyl 3-methoxy-2-tert-butyl-2-butylpropionate, ethyl 3-ethoxy-2-tert-butyl-2-butylpropionate, methyl 3-methoxy-2-tert-butyl-2-pentylpropionate, ethyl 3-methoxy-2-tert-butyl-2-pentylpropionate, ethyl 3-ethoxy-2-tert-butyl-2-pentylpropionate, ethyl 3-ethoxy-2,2-dicyclohexylpropionate, and ethyl 3-ethoxy-2,2-dicyclopentylpropionate.

Specific examples of the aromatic carboxylic acid esters include a benzoic acid ester such as ethyl benzoate, propyl benzoate, butyl benzoate, octyl benzoate, cyclohexyl benzoate, phenyl benzoate, methyl p-toluate and ethyl p-toluate; and an anisic acid ester such as methyl anisate and ethyl anisate.

Specific examples of the aliphatic dicarboxylic acid diester include a malonic acid diester such as dimethyl diisopropylmalonate, diethyl diisopropylmalonate, dipropyl diisopropylmalonate, diisopropyl diisopropylmalonate, dibutyl diisopropylmalonate, diisobutyl diisopropylmalonate, bis(2,2-dimethylpropyl) diisopropylmalonate, dimethyl diisobutylmalonate, diethyl diisobutylmalonate, dipropyl diisobutylmalonate, diisopropyl diisobutylmalonate, dibutyl diisobutylmalonate, diisobutyl diisobutylmalonate, bis(2,2-dimethylpropyl) diisobutylmalonate, dimethyl diisopentylmalonate, diethyl diisopentylmalonate, dipropyl diisopentylmalonate, diisopropyl diisopentylmalonate, dibutyl diisopentylmalonate, diisobutyl diisopentylmalonate, bis(2,2-dimethylpropyl) diisopentylmalonate, dimethyl isopropylisobutylmalonate, diethyl isopropylisobutylmalonate, dipropyl isopropylisobutylmalonate, diisopropyl isopropylisobutylmalonate, dibutyl isopropylisobutylmalonate, diisobutyl isopropylisobutylmalonate, bis(2,2-dimethylpropyl)isopropylisobutylmalonate, dimethyl isopropylisopentylmalonate, diethyl isopropylisopentylmalonate, dipropyl isopropylisopentylmalonate, diisopropyl isopropylisopentylmalonate, dibutyl isopropylisopentylmalonate, diisobutyl isopropylisopentylmalonate and bis(2,2-dimethylpropyl)isopropylisopentylmalonate; a succinic acid diester such as diethyl 2,3-diethylsuccinate, diethyl 2,3-dipropylsuccinate, diethyl 2,3-diisopropylsuccinate, diethyl 2,3-dibutylsuccinate, diethyl 2,3-dibutylsuccinate, diethyl 2,3-di-tert-butylsuccinate, dibutyl 2,3-diethylsuccinate, dibutyl 2,3-dipropylsuccinate, dibutyl 2,3-diisopropylsuccinate, dibutyl 2,3-dibutylsuccinate, dibutyl 2,3-diisobutylsuccinate and dibutyl 2,3-di-tert-butylsuccinate;

a glutaric acid diester such as diisobutyl 3-methylglutarate, diisobutyl 3-phenylglutarate, diethyl 3-ethylglutarate, diethyl 3-propylglutarate, diethyl 3-isopropylglutarate, diethyl 3-isobutylglutarate, diethyl 3-phenylglutarate, diisobutyl 3-ethylglutarate, diisobutyl 3-isopropylglutarate, diisobutyl 3-isobutylglutarate, diethyl 3-(3,3,3-trifluoropropyl)glutarate, diethyl 3-cyclohexylmethylglutarate, diethyl 3-tert-butylglutarate, diethyl 3,3-dimethylglutarate, diisobutyl 3,3-dimethylglutarate, diethyl 3-methyl-3-isobutylglutarate and diethyl 3-methyl-3-tert-butylglutarate;

a cyclohexene dicarboxylic acid diester such as diethyl 1-cyclohexene-1,2-dicarboxylate, dipropyl 1-cyclohexene-1,2-dicarboxylate, dibutyl 1-cyclohexene-1,2-dicarboxylate, di-isobutyl 1-cyclohexene-1,2-dicarboxylate, bis(2,2-dimethylpropyl) 1-cyclohexene-1,2-dicarboxylate and bis(2,2-dimethylhexyl) 1-cyclohexene-1,2-dicarboxylate;

a cyclohexane dicarboxylic acid diester such as diethyl cyclohexane-1,2-dicarboxylate, dipropyl cyclohexane-1,2-dicarboxylate, dibutyl cyclohexane-1,2-dicarboxylate, di-isobutyl cyclohexane-1,2-dicarboxylate, bis(2,2-dimethylpropyl)cyclohexane-1,2-dicarboxylate, bis(2,2-dimethylhexyl)cyclohexane-1,2-dicarboxylate, diethyl 3-methylcyclohexane-1,2-dicarboxylate, diethyl 4-methylcyclohexane-1,2-dicarboxylate, diethyl cyclohexane-1,1-dicarboxylate, dipropyl cyclohexane-1,1-dicarboxylate, dibutyl cyclohexane-1,1-dicarboxylate, di-isobutyl cyclohexane-1,1-dicarboxylate, bis(2,2-dimethylpropyl)cyclohexane-1,1-dicarboxylate, bis(2,2-dimethylhexyl)cyclohexane-1,1-dicarboxylate, diethyl 3-methylcyclohexane-1,1-dicarboxylate and diethyl 4-methylcyclohexane-1,1-dicarboxylate;

a maleic acid diester such as diethyl maleate and dibutyl maleate; an adipic acid diester such as dimethyl adipate, diethyl adipate, dipropyl adipate, diisopropyl adipate, dibutyl adipate, diisodecyl adipate and dioctyl adipate;

a dodecanedioic acid diester such as dimethyl dodecanedioate, diethyl dodecanedioate, dipropyl dodecanedioate, diisopropyl dodecanedioate, dibutyl dodecanedioate, diisobutyl dodecanedioate, dipentyl dodecanedioate, diisopentyl dodecanedioate, dihexyl dodecanedioate, diisohexyl dodecanedioate, diheptyl dodecanedioate, diisoheptyl dodecanedioate, dioctyl dodecanedioate, diisooctyl dodecanedioate, bis(2-ethylhexyl)dodecanedioate, dimethyl α-methyldodecanedioate, diethyl α-methyldodecanedioate, dipropyl α-methyldodecanedioate, diisopropyl α-methyldodecanedioate, dibutyl α-methyldodecanedioate, diisobutyl α-methyldodecanedioate, dipentyl α-methyldodecanedioate, diisopentyl α-methyldodecanedioate, dihexyl α-methyldodecanedioate, diisohexyl α-methyldodecanedioate, diheptyl α-methyldodecanedioate, diisoheptyl α-methyldodecanedioate, dioctyl α-methyldodecanedioate, diisooctyl α-methyldodecanedioate, bis(2-ethylhexyl) α-methyldodecanedioate, dimethyl α-ethyldodecanedioate, diethyl α-ethyldodecanedioate, dipropyl α-ethyldodecanedioate, diisopropyl α-ethyldodecanedioate, dibutyl α-ethyldodecanedioate, diisobutyl α-ethyldodecanedioate, dipentyl α-ethyldodecanedioate, diisopentyl α-ethyldodecanedioate, dihexyl α-ethyldodecanedioate, diisohexyl α-ethyldodecanedioate, diheptyl α-ethyldodecanedioate, diisoheptyl α-ethyldodecanedioate, dioctyl α-ethyldodecanedioate, diisooctyl α-ethyldodecanedioate, bis(2-ethylhexyl) α-ethyldodecanedioate, dimethyl α-isopropyldodecanedioate, diethyl α-isopropyldodecanedioate, dipropyl α-isopropyldodecanedioate, diisopropyl α-isopropyldodecanedioate, dibutyl α-isopropyldodecanedioate, diisobutyl α-isopropyldodecanedioate, dipentyl α-isopropyldodecanedioate, diisopentyl α-isopropyldodecanedioate, dihexyl α-isopropyldodecanedioate, diisohexyl α-isopropyldodecanedioate, diheptyl α-isopropyldodecanedioate, diisoheptyl α-isopropyldodecanedioate, dioctyl isopropyldodecanedioate, diisooctyl α-isopropyldodecanedioate, bis(2-ethylhexyl) α-isopropyldodecanedioate, dimethyl β-methyldodecanedioate, diethyl β-methyldodecanedioate, dipropyl β-methyldodecanedioate, diisopropyl β-methyldodecanedioate, dibutyl β-methyldodecanedioate, diisobutyl β-methyldodecanedioate, dipentyl β-methyldodecanedioate, diisopentyl β-methyldodecanedioate, dihexyl β-methyldodecanedioate, diisohexyl β-methyldodecanedioate, diheptyl β-methyldodecanedioate, diisoheptyl β-methyldodecanedioate, dioctyl β-methyldodecanedioate, diisooctyl β-methyldodecanedioate, bis(2-ethylhexyl)]-methyldodecanedioate, dimethyl β-ethyldodecanedioate, diethyl β-ethyldodecanedioate, dipropyl β-ethyldodecanedioate, diisopropyl β-ethyldodecanedioate, dibutyl β-ethyldodecanedioate, diisobutyl β-ethyldodecanedioate, dipentyl β-ethyldodecanedioate, diisopentyl β-ethyldodecanedioate, dihexyl β-ethyldodecanedioate, diisohexyl β-ethyldodecanedioate, diheptyl β-ethyldodecanedioate, diisoheptyl β-ethyldodecanedioate, dioctyl β-ethyldodecanedioate, diisooctyl β-ethyldodecanedioate, bis(2-ethylhexyl) β-ethyldodecanedioate, dimethyl β-isopropyldodecanedioate, diethyl β-isopropyldodecanedioate, dipropyl β-isopropyldodecanedioate, diisopropyl β-isopropyldodecanedioate, dibutyl β-isopropyldodecanedioate, diisobutyl β-isopropyldodecanedioate, dipentyl β-isopropyldodecanedioate, diisopentyl β-isopropyldodecanedioate, dihexyl β-isopropyldodecanedioate, diisohexyl β-isopropyl dodecanedioate, diheptyl β-isopropyldodecanedioate, diisoheptyl β-isopropyldodecanedioate, dioctyl β-isopropyldodecanedioate, diisooctyl β-isopropyldodecanedioate, bis(2-ethylhexyl) β-isopropyldodecanedioate, dimethyl γ-methyldodecanedioate, diethyl γ-methyldodecanedioate, dipropyl γ-methyldodecanedioate, diisopropyl γ-methyldodecanedioate, dibutyl γ-methyldodecanedioate, diisobutyl γ-methyldodecanedioate, dipentyl γ-methyldodecanedioate, diisopentyl γ-methyldodecanedioate, dihexyl γ-methyldodecanedioate, diisohexyl γ-methyldodecanedioate, diheptyl γ-methyldodecanedioate, diisoheptyl γ-methyldodecanedioate, dioctyl γ-methyldodecanedioate, diisooctyl γ-methyldodecanedioate, bis(2-ethylhexyl) γ-methyldodecanedioate, dimethyl γ-ethyldodecanedioate, diethyl γ-ethyldodecanedioate, dipropyl γ-ethyldodecanedioate, diisopropyl γ-ethyldodecanedioate, dibutyl γ-ethyldodecanedioate, diisobutyl γ-ethyldodecanedioate, dipentyl γ-ethyldodecanedioate, diisopentyl γ-ethyldodecanedioate, dihexyl γ-ethyldodecanedioate, diisohexyl γ-ethyldodecanedioate, diheptyl γ-ethyldodecanedioate, diisoheptyl γ-ethyldodecanedioate, dioctyl γ-ethyldodecanedioate, diisooctyl γ-ethyldodecanedioate, bis(2-ethylhexyl) γ-ethyldodecanedioate, dimethyl γ-isopropyldodecanedioate, diethyl γ-isopropyldodecanedioate, dipropyl γ-isopropyldodecanedioate, diisopropyl γ-isopropyldodecanedioate, dibutyl γ-isopropyldodecanedioate, diisobutyl γ-isopropyldodecanedioate, dipentyl γ-isopropyldodecanedioate, diisopentyl γ-isopropyldodecanedioate, dihexyl γ-isopropyldodecanedioate, diisohexyl γ-isopropyldodecanedioate, diheptyl γ-isopropyldodecanedioate, diisoheptyl γ-isopropyldodecanedioate, dioctyl γ-isopropyldodecanedioate, diisooctyl γ-isopropyldodecanedioate, bis(2-ethylhexyl) γ-isopropyldodecanedioate, dimethyl α,α-dimethyldodecanedioate, diethyl α,α-dimethyldodecanedioate, dipropyl α,α-dimethyldodecanedioate, diisopropyl α,α-dimethyldodecanedioate, dibutyl α,α-dimethyldodecanedioate, diisobutyl α,α-dimethyldodecanedioate, dipentyl α,α-dimethyldodecanedioate, diisopentyl α,α-dimethyldodecanedioate, dihexyl α,α-dimethyldodecanedioate, diisohexyl α,α-dimethyldodecanedioate, diheptyl α,α-dimethyldodecanedioate, diisoheptyl α,α-dimethyldodecanedioate, dioctyl α,α-dimethyldodecanedioate, diisooctyl α,α-dimethyldodecanedioate, bis(2-ethylhexyl) α,α-dimethyldodecanedioate, dimethyl α,β-dimethyldodecanedioate, diethyl α,β-dimethyldodecanedioate, dipropyl α,β-dimethyldodecanedioate, diisopropyl α,β-dimethyldodecanedioate, dibutyl α,β-dimethyldodecanedioate, diisobutyl α,β-dimethyldodecanedioate, dipentyl α,β-dimethyldodecanedioate, diisopentyl α,β-dimethyldodecanedioate, dihexyl α,β-dimethyldodecanedioate, diisohexyl α,β-dimethyldodecanedioate, diheptyl α,β-dimethyldodecanedioate, diisoheptyl α,β-dimethyldodecanedioate, dioctyl α,β-dimethyldodecanedioate, diisooctyl α,β-dimethyldodecanedioate, bis(2-ethylhexyl)α,β-dimethyldodecanedioate, dimethyl α,α-diethyldodecanedioate, diethyl α,α-diethyldodecanedioate, dipropyl α,α-diethyldodecanedioate, diisopropyl α,α-diethyldodecanedioate, dibutyl α,α-diethyldodecanedioate, diisobutyl α,α-diethyldodecanedioate, dipentyl α,α-diethyldodecanedioate, diisopentyl α,α-diethyldodecanedioate, dihexyl α,α-diethyldodecanedioate, diisohexyl α,α-diethyldodecanedioate, diheptyl α,α-diethyldodecanedioate, diisoheptyl α,α-diethyldodecanedioate, dioctyl α,α-diethyldodecanedioate, diisooctyl α,α-diethyldodecanedioate, bis(2-ethylhexyl)α,α-diethyldodecanedioate, dimethyl α,β-diethyldodecanedioate, diethyl α,β-diethyldodecanedioate, dipropyl α,β-diethyldodecanedioate, diisopropyl α,β-diethyldodecanedioate, dibutyl α,β-diethyldodecanedioate, diisobutyl α,β-diethyldodecanedioate, dipentyl α,β-diethyldodecanedioate, diisopentyl α,β-diethyldodecanedioate, dihexyl α,β-diethyldodecanedioate, diisohexyl α,β-diethyldodecanedioate, diheptyl α,β-diethyldodecanedioate, diisoheptyl α,β-diethyldodecanedioate, dioctyl α,β-diethyldodecanedioate, diisooctyl α,β-diethyldodecanedioate, bis(2-ethylhexyl) α,β-diethyldodecanedioate, dimethyl α,α-diisopropyldodecanedioate, diethyl α,α-diisopropyldodecanedioate, dipropyl α,α-diisopropyldodecanedioate, diisopropyl α,α-diisopropyldodecanedioate, dibutyl α,α-diisopropyldodecanedioate, diisobutyl α,α-diisopropyldodecanedioate, dipentyl α,α-diisopropyldodecanedioate, diisopentyl α,α-diisopropyldodecanedioate, dihexyl α,α-diisopropyldodecanedioate, diisohexyl α,α-diisopropyldodecanedioate, diheptyl α,α-diisopropyldodecanedioate, diisoheptyl α,α-diisopropyldodecanedioate, dioctyl α,α-diisopropyldodecanedioate, diisooctyl α,α-diisopropyldodecanedioate, bis(2-ethylhexyl) α,α-diisopropyldodecanedioate, dimethyl α,β-diisopropyldodecanedioate, diethyl α,β-diisopropyldodecanedioate, dipropyl α,β-diisopropyldodecanedioate, diisopropyl α,β-diisopropyldodecanedioate, dibutyl α,β-diisopropyldodecanedioate, diisobutyl α,β-diisopropyldodecanedioate, dipentyl α,β-diisopropyldodecanedioate, diisopentyl α,β-diisopropyldodecanedioate, dihexyl α,β-diisopropyldodecanedioate, diisohexyl α,β-diisopropyldodecanedioate, diheptyl α,β-diisopropyldodecanedioate, diisoheptyl α,β-diisopropyldodecanedioate, dioctyl α,β-diisopropyldodecanedioate, diisooctyl α,β-diisopropyldodecanedioate, bis(2-ethylhexyl)α,β-diisopropyldodecanedioate;

a dicarbonate such as diethyl 2,5-dioxahexanedioate, diethyl 2,5-dioxahexanedioate, diethyl 2,5-dioxa-3-methyl hexanedioate, diethyl 2,5-dioxa-3-methylhexanedioate, diethyl 2,5-dioxa-3-ethylhexanedioate, diethyl 2,5-dioxa-3-ethylhexanedioate, diethyl 2,5-dioxa-3-propylhexanedioate, diethyl 2,5-dioxa-3-isopropylhexanedioate, diethyl 2,5-dioxa-3-cyclohexylhexanedioate, diethyl 2,5-dioxa-3-tert-butylhexanedioate, diethyl 2,5-dioxa-3-thexylhexanedioate, diethyl 2,5-dioxa-3-phenylhexanedioate, diethyl 2,5-dioxa-3-benzylhexanedioate, diethyl 2,5-dioxa-3,4-dimethylhexanedioate, diethyl 2,5-dioxa-3,4-diethylhexanedioate, diethyl 2,5-dioxa-3,4-dipropylhexanedioate, diethyl 2,5-dioxa-3,4-diisopropylhexanedioate, diethyl 2,5-dioxa-3,4-dicyclohexylhexanedioate, diethyl 2,5-dioxa-3,4-di(tert-butyl)hexanedioate, diethyl 2,5-dioxa-3,4-dithexylhexanedioate, diethyl 2,5-dioxa-3,4-diphenylhexanedioate, diethyl 2,5-dioxa-3,4-dibenzylhexanedioate, dibutyl 2,5-dioxahexanedioate, dibutyl 2,5-dioxahexanedioate, dibutyl 2,5-dioxa-3-methylhexanedioate, dibutyl 2,5-dioxa-3-methylhexanedioate, dibutyl 2,5-dioxa-3-ethylhexanedioate, dibutyl 2,5-dioxa-3-ethylhexanedioate, dibutyl 2,5-dioxa-3-propylhexanedioate, dibutyl 2,5-dioxa-3-isopropylhexanedioate, dibutyl 2,5-dioxa-3-cyclohexylhexanedioate, dibutyl 2,5-dioxa-3-tert-butylhexanedioate, dibutyl 2,5-dioxa-3-thexylhexanedioate, dibutyl 2,5-dioxa-3-phenylhexanedioate, dibutyl 2,5-dioxa-3-benzylhexanedioate, dibutyl 2,5-dioxa-3,4-dimethylhexanedioate, dibutyl 2,5-dioxa-3,4-diethylhexanedioate, dibutyl 2,5-dioxa-3,4-dipropylhexanedioate, dibutyl 2,5-dioxa-3,4-diisopropylhexanedioate, dibutyl 2,5-dioxa-3,4-dicyclohexylhexanedioate, dibutyl 2,5-dioxa-3,4-di(tert-butyl)hexanedioate, dibutyl 2,5-dioxa-3,4-dithexylhexanedioate, dibutyl 2,5-dioxa-3,4-diphenylhexanedioate, dibutyl 2,5-dioxa-3,4-dibenzylhexanedioate, di(2-ethylhexyl) 2,5-dioxahexanedioate, di(2-ethylhexyl) 2,5-dioxahexanedioate, di(2-ethylhexyl) 2,5-dioxa-3-methylhexanedioate, di(2-ethylhexyl) 2,5-dioxa-3-methylhexanedioate, di(2-ethylhexyl) 2,5-dioxa-3-ethylhexanedioate, di(2-ethylhexyl) 2,5-dioxa-3-ethylhexanedioate, di(2-ethylhexyl) 2,5-dioxa-3-propylhexanedioate, di(2-ethylhexyl) 2,5-dioxa-3-isopropylhexanedioate, di(2-ethylhexyl) 2,5-dioxa-3-cyclohexylhexanedioate, di(2-ethylhexyl) 2,5-dioxa-3-tert-butylhexanedioate, di(2-ethylhexyl) 2,5-dioxa-3-thexylhexanedioate, di(2-ethylhexyl) 2,5-dioxa-3-phenylhexanedioate, di(2-ethylhexyl) 2,5-dioxa-3-benzylhexanedioate, di(2-ethylhexyl) 2,5-dioxa-3,4-dimethylhexanedioate, di(2-ethylhexyl) 2,5-dioxa-3,4-diethylhexanedioate, di(2-ethylhexyl) 2,5-dioxa-3,4-dipropylhexanedioate, di(2-ethylhexyl) 2,5-dioxa-3,4-diisopropylhexanedioate, di(2-ethylhexyl) 2,5-dioxa-3,4-dicyclohexylhexanedioate, di(2-ethylhexyl) 2,5-dioxa-3,4-di(tert-butyl)hexanedioate, di(2-ethylhexyl) 2,5-dioxa-3,4-dithexylhexanedioate, di(2-ethylhexyl) 2,5-dioxa-3,4-diphenylhexanedioate, and di(2-ethylhexyl) 2,5-dioxa-3,4-dibenzylhexanedioate.

Specific examples of the aromatic dicarboxylic acid diesters include a phthalic acid diester such as dimethyl phthalate, diethyl phthalate, dipropyl phthalate, diisopropyl phthalate, dibutyl phthalate, diisobutyl phthalate, methyl ethyl phthalate, isopropyl methyl phthalate, propyl ethyl phthalate, butyl ethyl phthalate, isobutyl ethyl phthalate, dipentyl phthalate, diisopentyl phthalate, bis(2,2-dimethylpropyl)phthalate, dihexyl phthalate, diheptyl phthalate, dioctyl phthalate, bis(2,2-dimethylhexyl)phthalate, bis(2-ethylhexyl)phthalate, dinonyl phthalate, diisodecyl phthalate, bis(2,2-dimethylheptyl)phthalate, isohexyl butyl phthalate, 2-ethylhexyl butyl phthalate, hexyl pentyl phthalate, isohexyl pentyl phthalate, heptyl isopentyl phthalate, 2-ethylhexyl pentyl phthalate, isononyl pentyl phthalate, decyl isopentyl phthalate, undecyl pentyl phthalate, isohexyl isopentyl phthalate, 2,2-dimethylhexyl hexyl phthalate, isononyl hexyl phthalate, decyl hexyl phthalate, 2-ethylhexyl heptyl phthalate, isononyl heptyl phthalate, decyl heptyl phthalate, isononyl (2-ethylhexyl)phthalate, bis(2,2-dimethylpropyl)-4-methylphthalate, bis(2,2-dimethylpropyl)-4-ethylphthalate, bis(2,2-dimethylpropyl)-4,5-dimethylphthalate, bis(2,2-dimethylpropyl)-4,5-diethylphthalate, diethyl 4-chlorophthalate, dibutyl 4-chlorophthalate, bis(2,2-dimethylpropyl)-4-chlorophthalate, diisobutyl 4-chlorophthalate, diisohexyl 4-chlorophthalate, diisooctyl 4-chlorophthalate, diethyl 4-bromophthalate, dibutyl 4-bromophthalate, bis(2,2-dimethylpropyl)-4-bromophthalate, diisobutyl 4-bromophthalate, diisohexyl 4-bromophthalate, diisooctyl 4-bromophthalate, diethyl 4,5-dichlorophthalate, dibutyl 4,5-dichlorophthalate, diisohexyl 4,5-dichlorophthalate and diisooctyl 4,5-dichlorophthalate. Specific examples of the diol ester include 1,2-propylene-glycol dibenzoate, 1,2-propylene-glycol di(p-chlorobenzoate), 1,2-propylene-glycol di(m-chlorobenzoate), 1,2-propylene-glycol di(p-bromobenzoate), 1,2-propylene-glycol di(p-bromobenzoate), 1,2-propylene-glycol di(p-methylbenzoate), 1,2-propylene-glycol di(p-tert-butylbenzoate), 1,2-propylene-glycol di(p-butylbenzoate), 1,2-propylene-glycol monobenzoate monocinnamate, 1,2-propylene-glycol dicinnamate, 2-methyl-1,2-propylene-glycol dibenzoate, 2-methyl-1,2-propylene-glycol di(p-chlorobenzoate), 2-methyl-1,2-propylene-glycol di(m-chlorobenzoate), 2-methyl-1,2-propylene-glycol di(p-bromobenzoate), 2-methyl-1,2-propylene-glycol di(o-bromobenzoate), 2-methyl-1,2-propylene-glycol di(p-methylbenzoate), 2-methyl-1,2-propylene-glycol di(p-tert-butylbenzoate), 2-methyl-1,2-propylene-glycol di(p-butylbenzoate), 2-methyl-1,2-propylene-glycol monobenzoate monocinnamate, 2-methyl-1,2-propylene-glycol dicinnamate, 1,3-propylene-glycol dibenzoate, 2-methyl-1,3-propylene-glycol dibenzoate, 2-ethyl-1,3-propylene-glycol dibenzoate, 2-propyl-1,3-propylene-glycol dibenzoate, 2-butyl-1,3-propylene-glycol dibenzoate, 2,2-dimethyl-1,3-propylene-glycol dibenzoate, (R)-1-phenyl-1,3-propylene-glycol dibenzoate, (S)-1-phenyl-1,3-propylene-glycol dibenzoate, 1,3-diphenyl-1,3-propylene-glycol dibenzoate, 2-methyl-1,3-diphenyl-1,3-propylene-glycol dibenzoate, 1,3-diphenyl-1,3-propylene-glycol dipropionate, 2-methyl-1,3-diphenyl-1,3-propylene-glycol dipropionate, 2-methyl-1,3-diphenyl-1,3-propylene-glycol diacetate, 2,2-dimethyl-1,3-diphenyl-1,3-propylene-glycol dibenzoate, 2,2-dimethyl-1,3-diphenyl-1,3-propylene-glycol dipropionate, 2-ethyl-1,3-di(tert-butyl)-1,3-propylene-glycol dibenzoate, 1,3-diphenyl-1,3-propylene-glycol diacetate, 2-butyl-2-ethyl-1,3-propylene-glycol dibenzoate, 2,2-diethyl-1,3-propylene-glycol dibenzoate, 2-dimethoxymethyl-1,3-propylene-glycol dibenzoate, 2-methyl-2-propyl-1,3-propylene-glycol dibenzoate, 2-isopentyl-2-isopropyl-1,3-propylene-glycol dibenzoate, 2-isopentyl-2-isopropyl-1,3-propylene-glycol di(p-chlorobenzoate), 2-isopentyl-2-isopropyl-1,3-propylene-glycol di(m-chlorobenzoate), 2-isopentyl-2-isopropyl-1,3-propylene-glycol di(p-methoxybenzoate), 2-isopentyl-2-isopropyl-1,3-propylene-glycol di(p-methylbenzoate), 2-isopentyl-2-isopropyl-1,3-propylene-glycol monobenzoate monopropionate, 2-isopentyl-2-isopropyl-1,3-propylene-glycol dipropionate, 2-isopentyl-2-isopropyl-1,3-propylene-glycol diacrylate, 2-isopentyl-2-isopropyl-1,3-propylene-glycol dicinnamate, 2,2-diisobutyl-1,3-propylene-glycol dibenzoate, 2-isopentyl-2-isopropyl-1,3-propylene-glycol 2,2′-biphenyl diformate, 2-isopentyl-2-isopropyl-1,3-propylene-glycol phthalate, 1,3-diisopropyl-1,3-propylene-glycol di(4-butylbenzoate), 2-ethyl-2-methyl-1,3-propylene-glycol dibenzoate, 2-amino-1-phenyl-1,3-propylene-glycol dibenzoate, 2,2-dimethyl-1,3-propylene-glycol dibenzoate, 1,2-butylene-glycol dibenzoate, 2-methyl-1,2-butylene-glycol dibenzoate, 2,3-dimethyl-1,2-butylene-glycol dibenzoate, 2,3-dimethyl-1,2-butylene-glycol di(p-chlorobenzoate), 2,3,3-trimethyl-1,2-butylene-glycol dibenzoate, 2,3,3-trimethyl-1,2-butylene-glycol di(p-chlorobenzoate), 1,2-butylene-glycol di(p-chlorobenzoate), 2,3-butylene-glycol dibenzoate, 2,3-butylene-glycol di(o-bromobenzoate), 2,3-butylene-glycol di(methylbenzoate), 2,3-butylene-glycol di(m-chlorobenzoate), 2-methyl-2,3-butylene-glycol dibenzoate, 2-methyl-2,3-butylene-glycol di(o-bromobenzoate), 2-methyl-2,3-butylene-glycol di(methylbenzoate), 2-methyl-2,3-butylene-glycol di(m-chlorobenzoate), 2,3-dimethyl-2,3-butylene-glycol dibenzoate, 2,3-dimethyl-2,3-butylene-glycol di(o-bromobenzoate), 2,3-dimethyl-2,3-butylene-glycol di(methylbenzoate), 2,3-dimethyl-2,3-butylene-glycol di(m-chlorobenzoate), 2-methyl-1-phenyl-1,3-butylene-glycol dibenzoate, 2-methyl-1-phenyl-1,3-butylene-glycol dipivalate, 2-methyl-2-(2-furyl)-1,3-butylene-glycol dibenzoate, 1,4-butylene-glycol dibenzoate, 2,3-diisopropyl-1,4-butylene-glycol dibenzoate, 2,3-dimethyl-1,4-butylene-glycol dibenzoate, 2,3-diethyl-1,4-butylene-glycol dibenzoate, 2,3-dibutyl-1,4-butylene-glycol dibenzoate, 2,3-diisopropyl-1,4-butylene-glycol dibutylate, 4,4,4-trifluoro-1-(2-naphthyl)-1,3-butylene-glycol dibenzoate, 2,3-pentanediol dibenzoate, 2-methyl-2,3-pentanediol dibenzoate, 3-methyl-2,3-pentanediol dibenzoate, 4-methyl-2,3-pentanediol dibenzoate, 2,3-dimethyl-2,3-pentanediol dibenzoate, 2,4-dimethyl-2,3-pentanediol dibenzoate, 3,4-dimethyl-2,3-pentanediol dibenzoate, 4,4-dimethyl-2,3-pentanediol dibenzoate, 2,3,4-trimethyl-2,3-pentanediol dibenzoate, 2,4,4-trimethyl-2,3-pentanediol dibenzoate, 3,4,4-trimethyl-2,3-pentanediol dibenzoate, 2,3,4,4-tetramethyl-2,3-pentanediol dibenzoate, 3-ethyl-2,3-pentanediol dibenzoate, 3-ethyl-2-methyl-2,3-pentanediol dibenzoate, 3-ethyl-2,4-dimethyl-2,3-pentanediol dibenzoate, 3-ethyl-2,4,4-trimethyl-2,3-pentanediol dibenzoate, 2,4-pentanediol dibenzoate, 3-methyl-2,4-pentanediol dibenzoate, 3-ethyl-2,4-pentanediol dibenzoate, 3-propyl-2,4-pentanediol dibenzoate, 3-butyl-2,4-pentanediol dibenzoate, 3,3-dimethyl-2,4-pentanediol dibenzoate, (2S,4S)-(+)-2,4-pentanediol dibenzoate, (2R,4R)-(+)-2,4-pentanediol dibenzoate, 2,4-pentanediol di(p-chlorobenzoate), 2,4-pentanediol di(m-chlorobenzoate), 2,4-pentanediol di(p-bromobenzoate), 2,4-pentanediol di(o-bromobenzoate), 2,4-pentanediol di(p-methylbenzoate), 2,4-pentanediol di(p-tert-butyl benzoate), 2,4-pentanediol di(p-butylbenzoate), 2,4-pentanediol monobenzoate monocinnamate, 2,4-pentanediol dicinnamate, 1,3-pentanediol dipropionate, 2-methyl-1,3-pentanediol dibenzoate, 2-methyl-1,3-pentanediol di(p-chlorobenzoate), 2-methyl-1,3-pentanediol di(p-methylbenzoate), 2-butyl-1,3-pentanediol di(p-methylbenzoate), 2-methyl-1,3-pentanediol di(p-tert-butylbenzoate), 2-methyl-1,3-pentanediol dipivalate, 2-methyl-1,3-pentanediol monobenzoate monocinnamate, 2,2-dimethyl-1,3-pentanediol dibenzoate, 2,2-dimethyl-1,3-pentanediol monobenzoate monocinnamate, 2-ethyl-1,3-pentanediol dibenzoate, 2-butyl-1,3-pentanediol dibenzoate, 2-allyl-1,3-pentanediol dibenzoate, 2-methyl-1,3-pentanediol monobenzoate monocinnamate, 2-methyl-1,3-pentanedioldibenzoate, 2-ethyl-1,3-pentanediol dibenzoate, 2-propyl-1,3-pentanediol dibenzoate, 2-butyl-1,3-pentanediol dibenzoate, 1,3-pentanediol di(p-chlorobenzoate), 1,3-pentanediol di(m-chlorobenzoate), 1,3-pentanediol di(p-bromobenzoate), 1,3-pentanediol di(o-bromobenzoate), 1,3-pentanediol di(p-methylbenzoate), 1,3-pentanediol di(p-tert-butylbenzoate), 1,3-pentanediol di(p-butylbenzoate), 1,3-pentanediol monobenzoate monocinnamate, 1,3-pentanediol dicinnamate, 2,2,4-trimethyl-1,3-pentanediol dibenzoate, 2,2,4-trimethyl-1,3-pentanediol di(isopropylformate), 3-methyl-1-trifluoromethyl-2,4-pentanediol dibenzoate, 2,4-pentanediol di(p-fluoromethylbenzoate), 2,4-pentanediol di(2-furancarboxylate), 3-butyl-3-methyl-2,4-pentanediol dibenzoate, 2,2-dimethyl-1,5-pentanediol dibenzoate, 1,5-diphenyl-1,5-pentanediol dibenzoate, 1,5-diphenyl-1,5-pentanediol dipropionate, 2,3-hexanediol dibenzoate, 2-methyl-2,3-hexanediol dibenzoate, 3-methyl-2,3-hexanediol dibenzoate, 4-methyl-2,3-hexanediol dibenzoate, 5-methyl-2,3-hexanediol dibenzoate, 2,3-dimethyl-2,3-hexanediol dibenzoate, 2,4-dimethyl-2,3-hexanediol dibenzoate, 2,5-dimethyl-2,3-hexanediol dibenzoate, 3,4-dimethyl-2,3-hexanediol dibenzoate, 3,5-dimethyl-2,3-hexanediol dibenzoate, 4,4-dimethyl-2,3-hexanediol dibenzoate, 4,5-dimethyl-2,3-hexanediol dibenzoate, 5,5-dimethyl-2,3-hexanediol dibenzoate, 2,3,4-trimethyl-2,3-hexanediol dibenzoate, 2,3,5-trimethyl-2,3-hexanediol dibenzoate, 2,4,4-trimethyl-2,3-hexanediol dibenzoate, 2,4,5-trimethyl-2,3-hexanediol dibenzoate, 2,5,5-trimethyl-2,3-hexanediol dibenzoate, 3,4,4-trimethyl-2,3-hexanediol dibenzoate, 3,4,5-trimethyl-2,3-hexanediol dibenzoate, 3,5,5-trimethyl-2,3-hexanediol dibenzoate, 2,3,4,4,-tetramethyl-2,3-hexanediol dibenzoate, 2,3,4,5,-tetramethyl-2,3-hexanediol dibenzoate, 2,3,5,5,-tetramethyl-2,3-hexanediol dibenzoate, 3-ethyl-2,3-hexanediol dibenzoate, 3-propyl-2,3-hexanediol dibenzoate, 3-isopropyl-2,3-hexanediol dibenzoate, 4-ethyl-2,3-hexanediol dibenzoate, 3-ethyl-2-methyl-2,3-hexanediol dibenzoate, 4-ethyl-2-methyl-2,3-hexanediol dibenzoate, 2-methyl-3-propyl-2,3-hexanediol dibenzoate, 4-ethyl-3-methyl-2,3-hexanediol dibenzoate, 3,4-diethyl-2,3-hexanediol dibenzoate, 4-ethyl-3-propyl-2,3-hexanediol dibenzoate, 3-ethyl-2,4-dimethyl-2,3-hexanediol dibenzoate, 3-ethyl-2,5-dimethyl-2,3-hexanediol dibenzoate, 3-ethyl-2,4,4-trimethyl-2,3-hexanediol dibenzoate, 3-ethyl-2,4,5-trimethyl-2,3-hexanediol dibenzoate, 2,5-dimethyl-3-propyl-2,3-hexanediol dibenzoate, 2,4,4-trimethyl-3-propyl-2,3-hexanediol dibenzoate, 2,5,5-trimethyl-3-propyl-2,3-hexanediol dibenzoate, 2,4,5-trimethyl-3-propyl-2,3-hexanediol dibenzoate, 3,4-diethyl-2-methyl-2,3-hexanediol dibenzoate, 2-ethyl-1,3-hexanediol dibenzoate, 2-propyl-1,3-hexanediol dibenzoate, 2-butyl-1,3-hexanediol dibenzoate, 4-ethyl-1,3-hexanediol dibenzoate, 4-methyl-1,3-hexanediol dibenzoate, 3-methyl-1,3-hexanediol dibenzoate, 3-ethyl-1,3-hexanediol dibenzoate, 2,2,4,6,6-pentamethyl-3,5-hexanediol dibenzoate, 2,5-hexanediol dibenzoate, 2,5-dimethyl-2,5-hexanediol dibenzoate, 2,5-dimethyl-2,5-hexanediol dipropionate, 2,5-dimethyl-hex-3-yne-2,5-diol dibenzoate, hex-3-yne-2,5-diol dibenzoate, hex-3-yne-2,5-diol di(2-furancarboxylate), 3,4-dibutyl-1,6-hexanediol dibenzoate, 1,6-hexanediol dibenzoate, hept-6-ene-2,4-diol dibenzoate, 2-methyl-hept-6-ene-2,4-diol dibenzoate, 3-methyl-hept-6-ene-2,4-diol dibenzoate, 4-methyl-hept-6-ene-2,4-diol dibenzoate, 5-methyl-hept-6-ene-2,4-diol dibenzoate, 6-methyl-hept-6-ene-2,4-diol dibenzoate, 3-ethyl-hept-6-ene-2,4-diol dibenzoate, 4-ethyl-hept-6-ene-2,4-diol dibenzoate, 5-ethyl-hept-6-ene-2,4-diol dibenzoate, 6-ethyl-hept-6-ene-2,4-diol dibenzoate, 3-propyl-hept-6-ene-2,4-diol dibenzoate, 4-propyl-hept-6-ene-2,4-diol dibenzoate, 5-propyl-hept-6-ene-2,4-diol dibenzoate, 6-propyl-hept-6-ene-2,4-diol dibenzoate, 3-butyl-hept-6-ene-2,4-diol dibenzoate, 4-butyl-hept-6-ene-2,4-diol dibenzoate, 5-butyl-hept-6-ene-2,4-diol dibenzoate, 6-butyl-hept-6-ene-2,4-diol dibenzoate, 3,5-dimethyl-hept-6-ene-2,4-diol dibenzoate, 3,5-diethyl-hept-6-ene-2,4-diol dibenzoate, 3,5-dipropyl-hept-6-ene-2,4-diol dibenzoate, 3,5-dibutyl-hept-6-ene-2,4-diol dibenzoate, 3,3-dimethyl-hept-6-ene-2,4-diol dibenzoate, 3,3-diethyl-hept-6-ene-2,4-diol dibenzoate, 3,3-dipropyl-hept-6-ene-2,4-diol dibenzoate, 3,3-dibutyl-hept-6-ene-2,4-diol dibenzoate, 3,5-heptanediol dibenzoate, 2-methyl-3,5-heptanediol dibenzoate, 3-methyl-3,5-heptanediol dibenzoate, 4-methyl-3,5-heptanediol dibenzoate, 5-methyl-3,5-heptanediol dibenzoate, 6-methyl-3,5-heptanediol dibenzoate, 3-ethyl-3,5-heptanediol dibenzoate, 4-ethyl-3,5-heptanediol dibenzoate, 5-ethyl-3,5-heptanediol dibenzoate, 3-propyl-3,5-heptanediol dibenzoate, 4-propyl-3,5-heptanediol dibenzoate, 3-butyl-3,5-heptanediol dibenzoate, 2,3-dimethyl-3,5-heptanediol dibenzoate, 2,4-dimethyl-3,5-heptanediol dibenzoate, 2,5-dimethyl-3,5-heptanediol dibenzoate, 2,6-dimethyl-3,5-heptanediol dibenzoate, 3,3-dimethyl-3,5-heptanediol dibenzoate, 4,4-dimethyl-3,5-heptanediol dibenzoate, 6,6-dimethyl-3,5-heptanediol dibenzoate, 3,4-dimethyl-3,5-heptanediol dibenzoate, 3,5-dimethyl-3,5-heptanediol dibenzoate, 3,6-dimethyl-3,5-heptanediol dibenzoate, 4,5-dimethyl-3,5-heptanediol dibenzoate, 4,6-dimethyl-3,5-heptanediol dibenzoate, 4,4-dimethyl-3,5-heptanediol dibenzoate, 6,6-dimethyl-3,5-heptanediol dibenzoate, 3-ethyl-2-methyl-3,5-heptanediol dibenzoate, 4-ethyl-2-methyl-3,5-heptanediol dibenzoate, 5-ethyl-2-methyl-3,5-heptanediol dibenzoate, 3-ethyl-3-methyl-3,5-heptanediol dibenzoate, 4-ethyl-3-methyl-3,5-heptanediol dibenzoate, 5-ethyl-3-methyl-3,5-heptanediol dibenzoate, 3-ethyl-4-methyl-3,5-heptanediol dibenzoate, 4-ethyl-4-methyl-3,5-heptanediol dibenzoate, 5-ethyl-4-methyl-3,5-heptanediol dibenzoate, 2-methyl-3-propyl-3,5-heptanediol dibenzoate, 2-methyl-4-propyl-3,5-heptanediol dibenzoate, 2-methyl-5-propyl-3,5-heptanediol dibenzoate, 3-methyl-3-propyl-3,5-heptanediol dibenzoate, 3-methyl-4-propyl-3,5-heptanediol dibenzoate, 3-methyl-5-propyl-3,5-heptanediol dibenzoate, 4-methyl-3-propyl-3,5-heptanediol dibenzoate, 4-methyl-4-propyl-3,5-heptanediol dibenzoate, 4-methyl-5-propyl-3,5-heptanediol dibenzoate, 6-methyl-2,4-heptanediol di(p-chlorobenzoate), 6-methyl-2,4-heptanediol di(p-methylbenzoate), 6-methyl-2,4-heptanediol di(m-methylbenzoate), 6-methyl-2,4-heptanediol dipivalate, hept-6-ene-2,4-diol dipivalate, 3,6-dimethyl-2,4-heptanediol dibenzoate, 2,2,6,6-tetramethyl-3,5-heptanediol dibenzoate, 2,6-dimethyl-2,6-heptanediol dibenzoate, 4-methyl-3,5-octanediol dibenzoate, 4-ethyl-3,5-octanediol dibenzoate, 4-propyl-3,5-octanediol dibenzoate, 5-propyl-3,5-octanediol dibenzoate, 4-butyl-3,5-octanediol dibenzoate, 4,4-dimethyl-3,5-octanediol dibenzoate, 4,4-diethyl-3,5-octanediol dibenzoate, 4,4-dipropyl-3,5-octanediol dibenzoate, 4-ethyl-4-methyl-3,5-octanediol dibenzoate, 3-phenyl-3,5-octanediol dibenzoate, 3-ethyl-2-methyl-3,5-octanediol dibenzoate, 4-ethyl-2-methyl-3,5-octanediol dibenzoate, 5-ethyl-2-methyl-3,5-octanediol dibenzoate, 6-ethyl-2-methyl-3,5-octanediol dibenzoate, 5-methyl-4,6-nonanediol dibenzoate, 5-ethyl-4,6-nonanediol dibenzoate, 5-propyl-4,6-nonanediol dibenzoate, 5-butyl-4,6-nonanediol dibenzoate, 5,5-dimethyl-4,6-nonanediol dibenzoate, 5,5-diethyl-4,6-nonanediol dibenzoate, 5,5-dipropyl-4,6-nonanediol dibenzoate, 5,5-dibutyl-4,6-nonanediol dibenzoate, 4-ethyl-5-methyl-4,6-nonanediol dibenzoate, 5-phenyl-4,6-nonanediol dibenzoate, 4,6-nonanediol dibenzoate, 1,1-cyclohexanedimethanol dibenzoate, 1,2-cyclohexanediol dibenzoate, 1,3-cyclohexanediol dibenzoate, 1,4-cyclohexanediol dibenzoate, 1,1-bis(benzoyloxyethyl)cyclohexane, 1,4-bis(benzoyloxymethyl)cyclohexane, 1,1-bis(benzoyloxymethyl)-3-cyclohexene, 1,1-bis(propionyloxymethyl)-3-cyclohexene, 9,9-bis(benzoyloxymethyl)fluorene, 9,9-bis((m-methoxybenzoyloxy)methyl)fluorene, 9,9-bis((m-chlorobenzoyloxy)methyl)fluorene, 9,9-bis((p-chlorobenzoyloxy)methyl)fluorene, 9,9-bis(cinnamoyloxymethyl)fluorene, 9-(benzoyloxymethyl)-9-(propionyloxymethyl)fluorene, 9,9-bis(propionyloxymethyl)fluorene, 9,9-bis(acryloyloxymethyl)fluorene, 9,9-bis(pivaloyloxymethyl)fluorene, 9,9-fluorenedimethanol dibenzoate, 1,3-phenylene dibenzoate, 1,4-phenylene dibenzoate, 2,2′-biphenylene dibenzoate, bis(2-benzoyloxynaphthyl)methane, 1,2-xylenediol dibenzoate, 1,3-xylenediol dibenzoate, 1,4-xylenediol dibenzoate, 2,2′-biphenyldimethanol-dipivalate, 2,2′-biphenyldimethanol-dibenzoate, 2,2′-biphenyldimethanol-dipropionate, 2,2′-binaphthyldimethanol-dibenzoate, 1,2-phenylene dibenzoate, 3-methyl-5-tert-butyl-1,2-phenylene dibenzoate, 3,5-diisopropyl-1,2-phenylene dibenzoate, 3,6-dimethyl-1,2-phenylene dibenzoate, 4-tert-butyl-1,2-phenylene dibenzoate, 4-methyl-1,2-phenylene dibenzoate, 1,2-naphthalene benzoate, 2,3-naphthalene benzoate.

Specific examples of the amines include an alkylamine having 6 or more carbon atoms, such as heptylamine, octylamine, nonylamine, laurylamine and 2-ethylhexylamine; a cyclic amine such as piperidine and 2,2,6,6-tetramethylpiperidine; an aromatic amine such as aniline and pyridine; and an aliphatic diamine such as N,N,N′,N′-tetramethylethylenediamine.

Specific examples of the amides include oleamide and stearamide. Specific examples of the nitriles include acetonitrile, benzonitrile and tolunitrile. Specific examples of the isocyanates include methyl isocyanate and ethyl isocyanate.

The electron donor compound (b) is preferably ethers or esters, more preferably an aliphatic diether, an aromatic diether, an aliphatic carboxylic acid ester, an aromatic carboxylic acid ester, an aliphatic dicarboxylic acid diester or an aromatic dicarboxylic acid diester, still more preferably an aliphatic diether, an aliphatic carboxylic acid ester having an alkoxy group, a benzoic acid ester, an anisic acid ester, a malonic acid diester, a succinic acid diester, a cyclohexene dicarboxylic acid diester, a cyclohexane dicarboxylic acid diester, a phthalic acid diester or a dodecanedioic acid diester, particularly preferably an aliphatic diether, an aliphatic carboxylic acid ester having an alkoxy group, a malonic acid diester, a succinic acid diester, a cyclohexane dicarboxylic acid diester, a phthalic acid diester, a dodecanedioic acid diester or a carbonate, and most preferably an aliphatic diether, an aliphatic carboxylic acid ester having an alkoxy group or a phthalic acid diester.

The aforementioned electron donor compound (b) may be used as a combination of two or more kinds thereof.

### <Condition of Production Method (1)>

In the production method (1), the electron donor compound (b) is used in an amount of usually 0.01 ml to 100 ml, preferably 0.03 ml to 50 ml, and particularly preferably 0.05 ml to 30 ml, per 1 g of the solid component (a).

In the production method (1), the contact temperature is not particularly limited. The solid component (a) and the electron donor compound (b) may be brought into contact with one another at a temperature of usually −50° C. to 200° C., preferably 0° C. to 170° C., more preferably 50° C. to 150° C. and particularly preferably 50° C. to 120° C.

In the production method (1), the contact time of the solid component (a) with the electron donor compound (b) is not particularly limited, and is usually from 10 minutes to 12 hours, preferably 30 minutes to 10 hours, and particularly preferably 1 hour to 8 hours.

The production method (1) for producing a catalyst component is not particularly limited in its method for bringing the solid component (a) and the electron donor compound (b) into contact with one another. For example, the known methods such as a slurry method and a mechanically-grinding method (for example, a method of grinding them with a ball mill) may be employed. The mechanically-grinding method is carried out preferably in the presence of a diluent to suppress a content of a fine powder in the resultant solid catalyst component or its extended particle size distribution. Examples of the diluent include aliphatic hydrocarbons such as pentane, hexane, heptane and octane; aromatic hydrocarbons such as benzene, toluene and xylene; alicyclic hydrocarbons such as cyclohexane and cyclopentane; and halogenated hydrocarbons such as 1,2-dichloroethane and monochlorobenzene. Among them, particularly preferred are aromatic hydrocarbons and halogenated hydrocarbons.

In the slurry method, the concentration of slurry is usually 0.05 to 0.7 g-solid/ml-solvent, and particularly preferably 0.1 to 0.5 g-solid/ml-solvent. The contact temperature is usually −50° C. to 200° C., preferably 0° C. to 170° C., more preferably 50° C. to 150° C., and particularly preferably 50° C. to 120° C. The contact time is not particularly limited, and is usually from 30 minutes to 6 hours.

### <Production Method (2)>

The production method (2) is a method in which a titanium compound (c), a magnesium compound (d) and an electron donor compound (b) are brought into contact with one another. Examples of the electron donor compound (b) to be used in the production method (2) are the same as those mentioned in the production method (1).

<Titanium Compound (c)>

The titanium compound (c) is not particularly limited insofar as it contains a titanium atom. Examples thereof include titanium tetrahalides such as titanium tetrachloride, titanium tetrabromide, and titanium tetraiodide; tetraalkoxy titanium such as tetramethoxytitanium, tetraethoxytitanium, tetrapropoxytitanium, tetraisopropoxytitanium, tetrabutoxytitanium, tetraisobutoxytitanium and tetracyclohexyloxytitanium; tetraaryloxy titanium compounds such as tetraphenoxytitanium; alkoxytitanium trihalides such as methoxytitanium trichloride, ethoxytitanium trichloride, propoxytitanium trichloride, butoxytitanium trichloride and ethoxytitaniumtribromide; dialkoxytitanium dihalides such as dimethoxytitanium dichloride, diethoxytitanium dichloride, iisopropoxytitanium dichloride, dipropoxytitanium dichloride and diethoxytitanium dibromide; and trialkoxytitanium monohalides such as trimethoxytitanium chloride, triethoxytitanium chloride, triisopropoxytitanium chloride, tripropoxytitanium chloride and tributoxytitanium chloride. The titanium compound (c) is preferably a titanium tetrahalide or an alkoxytitanium trichloride, more preferably a titanium tetrahalide, still more preferably titanium tetrachloride. These titanium compounds (c) may be used alone or as a combination of two or more kinds thereof.

<Magnesium Compound (d)>

The magnesium compound (d) is not particularly limited insofar as it contains a magnesium atom. Examples thereof are the compounds represented by the following formula (ix) or (x):

MgR¹²_{c}X⁴_{2-c} (ix)

Mg(OR¹²)_{c}X⁴_{2-c} (x)

wherein c is an integer number satisfying 0≦c≦2, R¹² is a hydrocarbyl group having 1 to 20 carbon atoms, and X⁴ is a halogen atom.

R¹² may be an alkyl group, an aralkyl group, an aryl group or an alkenyl group, which may be substituted with a halogen atom, a hydrocarbyloxy group, a nitro group, a sulfonyl group, a silyl group or the like.

Examples of the alkyl group for R¹² include a linear alkyl group such as a methyl group, an ethyl group, an n-propyl group, an n-butyl group, an n-pentyl group, an n-hexyl group, an n-heptyl group and an n-octyl group; a branched alkyl group such as an isopropyl group, an isobutyl group, a tert-butyl group, an isopentyl group, a 2,2-dimethylpropyl group, and a 2-ethylhexyl group; a cycloalkyl group such as a cyclopropyl group, a cyclobutyl group, a cyclopentyl group, a cyclohexyl group, a cycloheptyl group and cyclooctyl group. Among them, a linear or branched alkyl group having 1 to 20 carbon atoms is preferable.

Examples of the aralkyl group for R¹² include a benzyl group and a phenethyl group. Preferred is an aralkyl group having 7 to 20 carbon atoms.

Examples of the aryl group for R¹² include a phenyl group, a naphthyl group and a tolyl group. Preferred is an aryl group having 6 to 20 carbon atoms.

Examples of the alkenyl group for R¹² include a linear alkenyl group such as a vinyl group, an allyl group, a 3-butenyl group and a 5-hexenyl group; a branched alkenyl group such as an isobutenyl group and a 4-methyl-3-pentenyl group; and a cyclic alkenyl group such as a 2-cyclohexenyl group and a 3-cyclohexenyl group. Preferred is an alkenyl group having 2 to 20 carbon atoms. The R¹² groups may be the same or different.

Examples of the halogen atom for X⁴ include a chlorine atom, a bromine atom, an iodine atom and a fluorine atom. Among them, a chlorine atom is particularly preferable.

Specific examples of the magnesium compound (d) represented by the formula (ix) or (x) include alkyl magnesium compounds such as dimethyl magnesium, diethyl magnesium, diisopropyl magnesium, dibutyl magnesium, dihexyl magnesium, dioctyl magnesium, ethylbutyl magnesium and butyloctyl magnesium; dialkoxy magnesium compounds such as dimethoxy magnesium, diethoxy magnesium, dipropoxy magnesium, dibutoxy magnesium and dioctoxy magnesium; alkylmagnesium halide compounds such as methylmagnesium chloride, ethylmagnesium chloride, isopropylmagnesium chloride, isobutylmagnesium chloride, tert-butylmagnesium chloride, isobutylmagnesium chloride, benzylmagnesium chloride, methylmagnesium bromide, ethylmagnesium bromide, isopropylmagnesium bromide, isobutylmagnesium bromide, tert-butylmagnesium bromide, hexylmagnesium bromide, isobutylmagnesium bromide, benzylmagnesium bromide, methylmagnesium iodide, ethylmagnesium iodide, isopropylmagnesium iodide, isobutylmagnesium iodide, tert-butylmagnesium iodide, isobutylmagnesium iodide, benzylmagnesium iodide; alkoxy magnesium halide compounds such as methoxymagnesium chloride, ethoxymagnesium chloride, isopropoxymagnesium chloride, butoxy magnesium chloride and hexyloxymagnesium chloride; and halogenated magnesium compounds such as magnesium fluoride, magnesium chloride, magnesium bromide and magnesium iodide.

The magnesium compound (d) is preferably a halogenated magnesium compound (d-1) or a dialkoxy magnesium compound (d-2). The halogenated magnesium compound (d-1) is preferably magnesium chloride. The dialkoxy magnesium compound (d-2) is preferably a dialkoxy magnesium compound having 1 to 20 carbon atoms, more preferably a dialkoxy magnesium compound having 1 to 10 carbon atoms, particularly preferably dimethoxy magnesium, diethoxy magnesium, dipropoxy magnesium, diisopropoxy magnesium, and dibutoxy magnesium. These magnesium compounds may be used in the form of a solution in which they are dissolved in an alcohol such as methanol, ethanol and 2-ethylhexanol or in a hydrocarbon solvent such as toluene or hexane. They also may be used in the form of a solid, and may contain an alcohol, ether, or ester.

The dialkoxy magnesium compound (d-2) can be produced by a method in which a metal magnesium and an alcohol are brought into contact with one another in the presence of a catalyst, for example. Examples of the alcohol include methanol, ethanol, propanol, butanol and octanol. Examples of the catalyst include halides such as iodine, chlorine and bromine; and halogenated magnesium such as magnesium iodide and magnesium chloride. The catalyst is preferably iodine.

The magnesium compound (d) may be supported on a carrier. The carrier is not particularly limited, and may be porous inorganic oxides such as SiO₂, Al₂O₃, MgO, TiO₂ and ZrO₂; and porous organic polymers such as polystyrene, a styrene-divinylbenzene copolymer, a styrene-ethylene glycol dimethacrylate copolymer, polymethyl acrylate, polyethyl acrylate, a methyl acrylate-divinylbenzene copolymer, polymethyl methacrylate, a methyl methacrylate-divinylbenzene copolymer, polyacrylonitrile, an acrylonitrile-divinylbenzene copolymer, polyvinyl chloride, polyethylene and polypropylene. Among them, preferred is a porous inorganic oxide, and particularly preferred is SiO₂.

Preferred is a porous carrier in which a pore volume of pores having a pore radius of 20 nm to 200 nm is preferably 0.3 cm³/g or more, and more preferably 0.4 cm³/g or more, and the above pore volume is preferably 35% or more, and more preferably 40% or more relative to the pore volume of pores having a pore radius of 3.5 nm to 7500 nm, in order to efficiently fix the magnesium compound (d) on a carrier.

### <Condition of Production Method (2)>

In the production method (2) for producing a solid catalyst component (A), the titanium compound (c) is used in an amount of usually 0.01 mol to 100 mol, preferably 0.03 mol to 50 mol, and particularly preferably 0.05 mol to 30 mol, per 1 mol of the magnesium atoms which the magnesium compound (d) to be used contains. The titanium compound (c) may be used all at once or dividedly in a plurality of times.

In the production method (2) for producing a solid catalyst component (A), the electron donor compound (b) is used in an amount of usually 0.01 ml to 10000 ml, preferably 0.03 ml to 5000 ml, and particularly preferably 0.05 ml to 3000 ml, per 1 g of the magnesium compound (d) to be used. The electron donor compound (b) may be used all at once or dividedly in a plurality of times.

The production method (2) is not particularly limited in its method for bringing the titanium compound (c), the magnesium compound (d) and the electron donor compound (b) into contact with one another. For example, the known methods such as a slurry method and a mechanically-grinding method (for example, a method of grinding them with a ball mill) may be employed.

In the slurry method, the concentration of slurry is usually 0.05 to 0.7 g-solid/ml-solvent, and particularly preferably 0.1 to 0.5 g-solid/ml-solvent. The contact temperature is usually −50° C. to 200° C., preferably 0° C. to 170° C., more preferably 50° C. to 150° C., and particularly preferably 50° C. to 120° C. The contact time is not particularly limited, and is usually from 30 minutes to 6 hours.

The mechanically-grinding method is carried out preferably in the presence of a diluent to suppress a content of a fine powder in the resultant solid catalyst component (A) or its extended a particle size distribution.

In the production method (2), the contact temperature of contacting the titanium compound (c), the magnesium compound (d) and the electron donor compound (b) with one another is not particularly limited. The titanium compound (c), the magnesium compound (d) and the electron donor compound (b) may be brought into contact with one another at a temperature of usually −50° C. to 200° C., preferably −20° C. to 150° C., more preferably −20° C. to 130° C. and particularly preferably −20° C. to 120° C.

In the production method (2), the contact time of the titanium compound (c) with the magnesium compound (d) and the electron donor compound (b) is not particularly limited, and is usually from 10 minutes to 12 hours, preferably 30 minutes to 10 hours, and particularly preferably 1 hour to 8 hours. The contact may be carried out at once or dividedly in a plurality of times.

### <Production Method (3)>

The production method (3) is a method in which a titanium compound (c), a magnesium compound (d), an electron donor compound (b) and an organic acid chloride (e) are brought into contact with one another. Examples of the titanium compound (c) and the magnesium compound (d) to be used in the production method (3) are the same as those mentioned in the production method (2), respectively. Examples of the electron donor compound (b) to be used in the production method (3) are the same as those mentioned in the production method (1).

### <Organic Acid Chloride (E)>

Specific examples of the organic acid chloride (e) include an aromatic dicarboxylic acid dichloride such as phthaloyl dichloride and telephthaloyl dichloride; an aromatic carboxylic acid chloride such as benzoyl chloride, toluoyl chloride and anisoyl chloride; an aliphatic dicarboxylic acid dichloride such as succinyl dichloride, malonyl dichloride, maleoyl dichloride, itaconyl dichloride, adipoyl dichloride and dodecanedioyl dichloride; and an aliphatic carboxylic acid chloride such as acetyl chloride, propionyl chloride, butyroyl chloride, valeroyl chloride, acryloyl chloride, methacryloyl chloride, and 3-ethoxy-2-tert-butylpropionyl chloride. Preferred are an aromatic dicarboxylic acid dichloride and an aliphatic carboxylic acid chloride, and more preferred is phthaloyl dichloride.

### <Condition of the Production Method (3)>

In the production method (3) for producing a solid catalyst component (A), the organic chloride compound (e) is used in an amount of usually 0.01 ml to 100 ml, preferably 0.03 ml to 50 ml, and particularly preferably 0.05 ml to 30 ml, per 1 g of the solid component (a) to be used. The organic acid chloride (e) may be used all at once or dividedly in a plurality of times.

The production method (3) is not particularly limited in its method for bringing the titanium compound (c), the magnesium compound (d), the electron donor compound (b) and the organic chloride compound (e) into contact with one another. For example, the known methods such as a slurry method and a mechanically-grinding method (for example, a method of grinding them with a ball mill) may be employed.

In the slurry method, the concentration of slurry is usually 0.05 to 0.7 g-solid/ml-solvent, and particularly preferably 0.1 to 0.5 g-solid/ml-solvent. The contact temperature is usually 30° C. to 150° C., preferably 45° C. to 135° C., and particularly preferably 60° C. to 120° C. The contact time is not particularly limited, and is usually from 30 minutes to 6 hours.

The mechanically-grinding method is carried out preferably in the presence of a diluent to suppress a content of a fine powder in the resultant solid catalyst component (A) or its extended particle size distribution.

In the production method (3), the contact temperature is not particularly limited. The titanium compound (c), the magnesium compound (d), the electron donor compound (b) and the organic chloride compound (e) may be brought into contact with one another at a temperature of usually −50° C. to 200° C., preferably −20° C. to 150° C., more preferably −20° C. to 130° C. and particularly preferably −20° C. to 120° C.

In the production method (3), the contact time of the titanium compound (c) with the magnesium compound (d), the electron donor compound (b) and the organic chloride compound (e) is not particularly limited, and is usually from 10 minutes to 12 hours, preferably 30 minutes to 10 hours, and particularly preferably 1 hour to 8 hours. The contact may be carried out at once or dividedly in a plurality of times.

### <Production Method (4)>

The production method (4) is a method in which a solid component (a) comprising a titanium atom and a magnesium atom, an electron donor compound (b) and a metal halide compound represented by formula (vii) or (viii):

M¹R¹¹_{p-b}X³_{b} (vii)

M¹(OR¹¹)_{p-b}X³_{b} (viii)

wherein M¹ is an element of Group 4, 13 or 14 of the periodic table (IUPAC, 2012), R¹¹ is a hydrocarbyl group having 1 to 20 carbon atoms, X³ is a halogen atom, p represents a valency of the element M¹, and b is an integer number satisfying 0<b≦P,

are brought into contact with one another. Examples of the solid component (a) and electron donor compound (b) to be used in the production method (4) are the same as those mentioned in the production method (1).

### <Metal Halide Compound>

In the production method (4), a metal halide compound represented by formula (vii) or (viii) is used.

As to M¹ in the formulae (vii) and (viii), the element of Group 4 of the periodic table may be titanium, zirconium and hafnium. Preferred is titanium. The element of Group 13 of the periodic table may be boron, aluminum, gallium, indium and thallium. Preferred are boron and aluminum, and more preferred is aluminum. The element of Group 14 of the periodic table may be silicon, germanium, tin and lead. Preferred are silicon, germanium and tin, and more preferred is silicon.

As to R¹¹ in formulae (vii) and (viii), examples of the hydrocarbyl group include a linear or branched alkyl group such as a methyl group, an ethyl group, an n-propyl group, an isopropyl group, an n-butyl group, an isobutyl group, an n-pentyl group, an isopentyl group, a hexyl group, a heptyl group, an octyl group, a decyl group and a dodecyl group; a cycloalkyl group such as a cyclohexyl group and a cyclopentyl group; an alkenyl group such as an allyl group; and an aryl group such as a phenyl group, a cresyl group, a xylyl group and a naphthyl group.

R¹¹ in formulae (vii) and (viii) is preferably an alkyl group having 2 to 18 carbon atoms or an aryl group having 6 to 18 carbon atoms.

Examples of X³ in formulae (vii) and (viii) include a fluorine atom, a chlorine atom, a bromine atom and an iodine atom. Among them, a chlorine atom and a bromine atom are preferable.

In the formulae (vii) and (viii), p represents a valency of the element M¹. When M¹ is an element of Group 4 of the periodic table, p is 4. When M¹ is an element of Group 13 of the periodic table, p is 3. When M¹ is an element of Group 14 of the periodic table, p is 4.

In the formulae (vii) and (viii), b is an integer number satisfying 0<b≦p. When M¹ is an element of Group 4 or 14 of the periodic table, b is an integer number satisfying 0<b≦4. When M¹ is an element of Group 13 of the periodic table, b is an integer number satisfying 0<b≦3. When M¹ is an element of Group 4 or 14 of the periodic table, b is preferably 3 or 4, more preferably 4. When M¹ is an element of Group 13 of the periodic table, b is preferably 3.

The metal halide compound represented by the formula (vii) or (viii) may be a titanium halide compound. Preferred examples thereof are titanium tetrahalide compounds such as titanium tetrachloride, titanium tetrabromide, and titanium tetraiodide; alkoxytitanium trihalide compounds such as methoxytitanium trichloride, ethoxytitanium trichloride, butoxytitanium trichloride, and ethoxytitanium tribromide; and aryloxytitanium trihalide such as phenoxytitanium trichloride. Among them, titanium tetrahalide compounds are more preferable, and titanium tetrachloride is particularly preferable.

The metal halide compound represented by the formula (vii) or (viii) may be a chlorinated compound of the element of Group 13 or 14 of the periodic table. Preferred examples thereof are ethylaluminum dichloride, ethylaluminum sesquichloride, diethylaluminium chloride, trichloroaluminum, tetrachlorosilane, phenyltrichlorosilane, methyltrichlorosilane, ethyltrichlorosilane, n-propyltrichlorosilane or p-tolyltrichlorosilane. Among them, a chlorinated compound of the element of Group 14 of the periodic table is more preferable, and tetrachlorosilane and phenyltrichlorosilane are particularly preferable.

### <Condition of Production Method (4)>

The metal halide compound represented by the formula (vii) or (viii) is used in an amount of usually 0.1 mmol to 1000 mmol, preferably 0.3 mmol to 500 mmol, and particularly preferably 0.5 mmol to 300 mmol, per 1 g of the solid component (a) to be used. The metal halide compound may be used all at once or dividedly in a plurality of times.

The production method (4) is not particularly limited in its method for bringing the solid component (a), the electron donor compound (b) and the metal halide compound represented by the formula (vii) or (viii) into contact with one another. For example, the known methods such as a slurry method and a mechanically-grinding method (for example, a method of grinding them with a ball mill) may be employed.

In the slurry method, the concentration of slurry is usually 0.05 to 0.7 g-solid/ml-solvent, and particularly preferably 0.1 to 0.5 g-solid/ml-solvent. The contact temperature is usually −50° C. to 200° C., preferably 0° C. to 170° C., more preferably 50° C. to 150° C., and particularly preferably 50° C. to 120° C. The contact time is not particularly limited, and is usually from 30 minutes to 6 hours.

The mechanically-grinding method is carried out preferably in the presence of a diluent to suppress a content of a fine powder in the resultant solid catalyst component (A) or its extended particle size distribution.

In the production method (4), the contact temperature is not particularly limited. The solid component (a), the electron donor compound (b) and the metal halide compound represented by the formula (vii) or (viii) may be brought into contact with one another at a temperature of usually −50° C. to 200° C., preferably −20° C. to 150° C., more preferably −20° C. to 130° C. and particularly preferably −20° C. to 120° C.

In the production method (4), the contact time of the solid component (a), the electron donor compound (b) and the metal halide compound represented by the formula (vii) or (viii) is not particularly limited, and is usually from 10 minutes to 12 hours, preferably 30 minutes to 10 hours, and particularly preferably 1 hour to 8 hours. The contact may be carried out at once or dividedly in a plurality of times.

### <Production Method (5)>

The production method (5) is a method in which a solid component (a) comprising a titanium atom and a magnesium atom, an electron donor compound (b), a metal halide compound represented by formula (vii) or (viii)

M¹R¹¹_{p-b}X³_{b} (vii)

M¹(OR¹¹)_{p-b}X³_{b} (viii)

wherein M¹ is an element of Group 4, 13 or 14 of the periodic table, R¹¹ is a hydrocarbyl group having 1 to 20 carbon atoms, X³ is a halogen atom, p represents a valency of the element M¹, and b is an integer number satisfying 0<b≦p, and an organic acid chloride (e) are brought into contact with one another.

### <Condition of the Production Method (5)>

Examples of the solid component (a) and the electron donor compound (b) to be used in the production method (5) are the same as those mentioned in the production method (4). Examples of the metal halide compound represented by formula (vii) or (viii) to be used in the production method (5) are the same as those mentioned in the production method (4). Examples of the organic acid chloride (e) to be used in the production method (5) are the same as those mentioned in the production method (3).

In the production method (5) for producing a solid catalyst component (A), the organic chloride compound (e) is used in an amount of usually 0.01 ml to 100 ml, preferably 0.03 ml to 50 ml, and particularly preferably 0.05 ml to 30 ml, per 1 g of the solid component (a) to be used. The organic chloride compound (e) may be used all at once or dividedly in a plurality of times.

In the production method (5), the metal halide compound is used in an amount of usually 0.01 mol to 100 mol, preferably 0.03 mol to 50 mol, and particularly preferably 0.05 mol to 30 mol, per 1 mol of the magnesium atoms which the solid component (a) to be used contains. The metal halide compound may be used all at once or dividedly in a plurality of times.

The production method (5) is not particularly limited in its method for bringing the solid component (a), the electron donor compound (b), the metal halide compound represented by the formula (vii) or (viii) and the organic chloride compound (e) into contact with one another. For example, the known methods such as a slurry method and a mechanically-grinding method (for example, a method of grinding them with a ball mill) may be employed.

In the slurry method, the concentration of slurry is usually 0.05 to 0.7 g-solid/ml-solvent, and particularly preferably 0.1 to 0.5 g-solid/ml-solvent. The contact temperature is usually −50° C. to 200° C., preferably −20° C. to 150° C., more preferably −20° C. to 130° C., and particularly preferably −20° C. to 120° C. The contact time is not particularly limited, and is usually from 30 minutes to 6 hours.

The mechanically-grinding method is carried out preferably in the presence of a diluent to suppress a content of a fine powder in the resultant solid catalyst component (A) or its extended particle size distribution.

In the production method (5), the contact temperature is not particularly limited. The solid component (a), the electron donor compound (b), the metal halide compound represented by the formula (vii) or (viii) and the organic acid chloride (e) may be brought into contact with one another at a temperature of usually −50° C. to 200° C., preferably −20° C. to 150° C., more preferably −20° C. to 130° C. and particularly preferably −20° C. to 120° C.

In the production method (5), the contact time of the solid component (a), the electron donor compound (b), the metal halide compound represented by the formula (vii) or (viii) and the organic acid chloride (e) is not particularly limited, and is usually from 10 minutes to 12 hours, preferably 30 minutes to 10 hours, and particularly preferably 1 hour to 8 hours. The contact may be carried out at once or dividedly in a plurality of times.

### <Organoaluminum Compound (B)>

Examples of the organoaluminum compound (B) to be used in the present invention include the compounds as described in U.S. Pat. No. 6,903,041. In particular, a trialkylaluminum, a mixture of a trialkylaluminum and a dialkylaluminum halide, and an alkylalumoxane are preferable, and triethylaluminum, triisobutylalminum, and a mixture of triethylaluminum and diethylaluminum chloride, are more preferable.

### <Alkoxysilane Compound (D)>

As an alkoxysilane compound (D) to be used in the present invention, the alkoxysilane compounds represented by following formula (xiii), (xiv) or (xv) are preferable.

R¹⁴eSi(OR¹⁵)₄₋ₑ (xiii)

Si(OR¹⁶)₃(NR¹⁷R¹⁸) (xiv)

Si(OR¹⁶)₃(NR¹⁹) (xv)

In the above formulae, R¹⁴ is a hydrocarbyl group having 1 to 20 carbon atoms or a hydrogen atom, R¹⁵ is a hydrocarbyl group having 1 to 20 carbon atoms; and e is an integer number satisfying 0≦e<4. When there are more than one R¹⁴ groups and R¹⁵ groups, the R¹⁴ groups and R¹⁵ groups are the same or different, respectively. In the above formulae, R¹⁶ is a hydrocarbyl group having 1 to 6 carbon atoms; R¹⁷ and R¹⁸ are independently a hydrogen atom or a hydrocarbyl group having 1 to 12 carbon atoms; and NR¹⁹ is a cyclic amino group having 5 to 20 carbon atoms.

As to R¹⁴ in formula (xiii), the hydrocarbyl group may be an alkyl group, an aralkyl group, an aryl group and an alkenyl group. Examples of the alkyl group for R¹⁴ include a linear alkyl group such as a methyl group, an ethyl group, an n-propyl group, an n-butyl group, an n-pentyl group, an n-hexyl group, an n-heptyl group and an n-octyl group; a branched alkyl group such as an isopropyl group, an isobutyl group, a tert-butyl group, an isopentyl group, a neopentyl group and a 2-ethylhexyl group; a cycloalkyl group such as a cyclopropyl group, a cyclobutyl group, a cyclopentyl group, a cyclohexyl group, a cycloheptyl group and cyclooctyl group. Among them, a linear, branched or cyclic alkyl group having 1 to 20 carbon atoms is preferable.

Examples of the aralkyl group for R¹⁴ include a benzyl group and a phenethyl group. Preferred is an aralkyl group having 7 to 20 carbon atoms.

Examples of the aryl group for R¹⁴ include a phenyl group, a tolyl group and a xylyl group. Preferred is an aryl group having 6 to 20 carbon atoms.

Examples of the alkenyl group for R¹⁴ include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is an alkenyl group having 2 to 10 carbon atoms.

R¹⁴ is preferably a linear, branched or cyclic alkyl group having 1 to 20 carbon atoms, and more preferably a methyl group, an ethyl group, an n-propyl group, an n-butyl group, an n-pentyl group, an n-hexyl group, an n-heptyl group and an n-octyl group, an isopropyl group, an isobutyl group, a tert-butyl group, an isopentyl group, a neopentyl group and a 2-ethylhexyl group, a cyclopropyl group, a cyclobutyl group, a cyclopentyl group, a cyclohexyl group, a cycloheptyl group or cyclooctyl group.

As to R¹⁵ in formula (xiii), the hydrocarbyl group may be an alkyl group. Examples of the alkyl group for R¹⁵ include a linear alkyl group such as a methyl group, an ethyl group, an n-propyl group, an n-butyl group, an n-pentyl group, an n-hexyl group, an n-heptyl group and an n-octyl group; a branched alkyl group such as an isopropyl group, an isobutyl group, a tert-butyl group, an isopentyl group, a neopentyl group and a 2-ethylhexyl group; a cycloalkyl group such as a cyclopropyl group, a cyclobutyl group, a cyclopentyl group, a cyclohexyl group, a cycloheptyl group and cyclooctyl group. Among them, a linear, branched or cyclic alkyl group having 1 to 20 carbon atoms is preferable, a linear alkyl group having 1 to 5 carbon atoms is more preferable, and a methyl group and ethyl group are particularly preferable.

Examples of the alkoxysilane represented by the formula (xiii) include cyclohexylmethyldimethoxysilane, cyclohexylethyldimethoxysilane, di-isopropyldimethoxysilane, tert-butylethyldimethoxysilane, tert-butylpropyldimethoxysilane, dicyclobutyldimethoxysilane, dicyclopentyldimethoxysilane, cyclohexyltriethoxysilane, and cyclopentyltriethoxysilane.

As to R¹⁶ in formulae (xiv) and (xv), the hydrocarbyl group may be an alkyl group. Examples of the alkyl group for R¹⁶ include a linear alkyl group such as a methyl group, an ethyl group, an n-propyl group, an n-butyl group, an n-pentyl group, and an n-hexyl group; a branched alkyl group such as an isopropyl group, an isobutyl group, a tert-butyl group, an isopentyl group, and a neopentyl group; a cycloalkyl group such as a cyclopropyl group, a cyclobutyl group, a cyclopentyl group, and a cyclohexyl group. Preferred is a linear alkyl group having 1 to 6 carbon atoms, and particularly preferred are a methyl group and an ethyl group.

As to R¹⁷ and R¹⁸ in formula (xiv), the hydrocarbyl group may be an alkyl group or an alkenyl group. Examples of the alkyl group for R¹⁷ and R¹⁸ include a linear alkyl group such as a methyl group, an ethyl group, an n-propyl group, an n-butyl group, an n-pentyl group, and an n-hexyl group; a branched alkyl group such as an isopropyl group, an isobutyl group, a tert-butyl group, an isopentyl group, and a neopentyl group; a cycloalkyl group such as a cyclopropyl group, a cyclobutyl group, a cyclopentyl group, and a cyclohexyl group. Among them, a linear alkyl group having 1 to 6 carbon atoms is preferable. Examples of the alkenyl group for R¹⁷ and R¹⁸ include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is a linear alkenyl group having 2 to 6 carbon atoms, and particularly preferred are a methyl group and an ethyl group.

Examples of the alkoxysilane represented by the formula (xiv) include dimethylaminotrimethoxysilane, diethylaminotrimethoxysilane, dipropylaminotrimethoxysilane, dimethylaminotriethoxysilane, diethylaminotriethoxysilane, dipropylaminotriethoxysilane, methylethylaminotriethoxysilane, methylpropylaminotriethoxysilane, tert-butylaminotriethoxysilane, diisopropylaminotriethoxysilane, and methylisopropylaminotriethoxysilane.

As to NR¹⁹ in formula (xv), examples of the cyclic amino group include a perhydroquinolino group, a perhydroisoquinolino group, a 1,2,3,4-tetrahydroquinolino group, a 1,2,3,4-tetrahydroisoquinolino group, and an octamethyleneimino group.

Examples of the alkoxysilane represented by the formula (xv) include perhydroquinolinotriethoxysilane, perhydroisoquinolinotriethoxysilane, 1,2,3,4-tetrahydroquinolinotriethoxysilane, 1,2,3,4-tetrahydroisoquinolinotriethoxysilane, and octamethyleneiminotriethoxysilane.

The alkoxysilane compound (D) is preferably an alkoxysilane compound represented by the formula (xiii), more preferably an alkoxysilane compound represented by the formula (xiii) having “h” of 1 or 2, and most preferably cyclohexylmethyldimethoxysilane, cyclohexylethyldimethoxysilane, diisopropyldimethoxysilane, tert-butylethyldimethoxysilane, tert-butylpropyldimethoxysilane, phenyltrimethoxysilane, diphenyldimethoxysilane, dicyclobutyldimethoxysilane, dicyclopentyldimethoxysilane, vinyltriethoxysilane, cyclohexyltriethoxysilane, and cyclopentyltriethoxysilane.

### <Preparation Method for Olefin Polymerization Catalyst>

The method for bringing a solid catalyst component (A), an organoaluminum compound (B), a triether (C) and an alkoxysilane compound (D) into contact with one another is not particularly limited, and a known method may be employed.

The contact of a solid catalyst component (A), an organoaluminum compound (B) and a triether (C) may be carried out by the following method (1), (2) or (3):

(1): a method in which the solid catalyst component (A), the organoaluminum compound (B) and the triether (C) are brought into contact with one another at the same time;

(2): a method in which the organoaluminum compound (B) and the triether (C) are brought into contact with one another, and then the solid catalyst component (A) is brought into contact therewith;

(3): a method in which the solid catalyst component (A) and the organoaluminum compound (B) are brought into contact with one another, and then the triether (C) is brought into contact therewith.

The order of contacting a solid catalyst component (A), an organoaluminum compound (B), a triether (C) and an alkoxysilane compound (D) is not particularly limited, and the contact may be carried out by the following method (1), (2), (3) or (4):

(1): a method in which the solid catalyst component (A), the organoaluminum compound (B), the triether (C) and the alkoxysilane compound (D) are brought into contact with one another at once;

(2): a method in which the organoaluminum compound (B), the triether (C) and the alkoxysilane compound (D) are brought into contact with one another, and then the solid catalyst component (A) is brought into contact therewith;

(3): a method in which a mixture solution of the triether (C) and the alkoxysilane compound (D) is brought into contact with the organoaluminum compound (B), and then the solid catalyst component (A) is brought into contact therewith;

(4): a method in which the solid catalyst component (A) and the organoaluminum compound (B) are brought into contact with one another, and then the triether (C) and the alkoxysilane compound (D) are brought into contact therewith.

The preparation of the olefin polymerization catalyst is preferably carried out in the presence of an inert hydrocarbon, more preferably in the presence of a solvent to be used in the pre-polymerization or main-polymerization.

It may be preferable that the process for producing an olefin polymerization catalyst comprises the following steps (1) and (2):

step (1) of preparing a pre-polymerized catalyst component: polymerizing a small amount of an olefin in the presence of the solid catalyst component (A) and the organoaluminum compound (B) to form a catalyst component whose surface is covered with the resultant olefin polymer, this polymerization being generally referred to as “pre-polymerization” and the obtained catalyst component in the above pre-polymerization step being generally referred to as “pre-polymerized catalyst component”; and

step (2) of preparing a main-polymerized catalyst component: bringing the pre-polymerized catalyst component formed in the step (1) and optionally the organoaluminum compound (B) into contact with one another.

The olefin to be used in the above step (1) may be the same as, or different from an olefin to be used in the main polymerization. In addition, a chain-transfer agent such as hydrogen may be used in the pre-polymerization step (1).

The triether (C) may be used in the above step (1) and/or step (2). The alkoxysilane compound (D) also may be used in the above step (1) and/or step (2).

The pre-polymerization is preferably a slurry polymerization using an inert hydrocarbon solvent such as propane, butane, isobutane, pentane, isopentane, hexane, heptane, octane, cyclohexane, benzene and toluene.

The organoaluminum compound (B) in the step (1) is used in an amount of usually 0.5 mol to 700 mol, preferably 0.8 mol to 500 mol, and particularly preferably 1 mol to 200 mol, per 1 mol of the titanium atoms which the solid catalyst component (A) to be used in the step (1) contains.

The olefin in the step (1) is pre-polymerized in an amount of usually 0.01 g to 1,000 g, preferably 0.05 g to 500 g, and particularly preferably 0.1 g to 200 g, per 1 g of the solid catalyst component (A) to be used in the step (1).

When the pre-polymerization of step (1) is a slurry polymerization, the slurry concentration of the solid catalyst component (A) is preferably 1 to 500 g-solid catalyst component/liter-solvent, and particularly preferably 3 to 300 g-solid catalyst component/liter-solvent.

The pre-polymerization is carried out at preferably −20° C. to 100° C., and particularly preferably 0° C. to 80° C., and under a partial pressure of an olefin in a gas phase of preferably 0.01 MPa to 2 MPa, and particularly preferably 0.1 MPa to 1 MPa, provided that an olefin in a liquid state under a pre-polymerization temperature and a pre-polymerization pressure is not limited thereto. The pre-polymerization time is not particularly limited, and is preferably 2 minutes to 15 hours.

For example, in the pre-polymerization, the solid catalyst component (A), the organoaluminum compound (B) and the olefin may be supplied to a polymerization reactor according to the following method (1) or (2):

(1): a method in which the solid catalyst component (A) and the organoaluminum compound (B) are supplied, and then the olefin is supplied; or

(2): a method in which the solid catalyst component (A) and the olefin are supplied, and then the organoaluminum compound (B) is supplied.

For example, in the pre-polymerization, the olefin may be supplied to a polymerization reactor according to the following method (1) or (2):

(1): a method of sequentially feeding the olefin to the polymerization reactor, such that an inner pressure of the polymerization reactor is kept at a prescribed level; or

(2): a method of feeding a prescribed total amount of the olefin at the same time to the polymerization reactor.

The triether (C) in the pre-polymerization is used in an amount of usually 0.01 mol to 400 mol, preferably 0.02 mol to 200 mol, and particularly preferably 0.03 mol to 100 mol, per 1 mol of titanium atoms which the solid catalyst component (A) to be used pre-polymerization contains. In addition, it is used in an amount of usually 0.003 mol to 5 mol, preferably 0.005 mol to 3 mol, and particularly preferably 0.01 mol to 2 mol, per 1 mol of the organoaluminum compound (B) to be used in the pre-polymerization.

The alkoxysilane compound (D) in the pre-polymerization is used in an amount of usually 0.01 mol to 400 mol, preferably 0.02 mol to 200 mol, and particularly preferably 0.03 mol to 100 mol, per 1 mol of titanium atoms which the solid catalyst component (A) to be used pre-polymerization contains. In addition, it is used in an amount of usually 0.003 mol to 5 mol, preferably 0.005 mol to 3 mol, and particularly preferably 0.01 mol to 2 mol, per 1 mol of the organoaluminum compound (B) to be used in the pre-polymerization.

For example, in the pre-polymerization, the triether (C) and the alkoxysilane compound (D) may be supplied to a polymerization reactor according to any one of the following methods (1) to (6):

(1): a method of feeding independently the triether (C) to a polymerization reactor;

(2): a method of feeding independently the alkoxysilane compound (D) to a polymerization reactor;

(3): a method of feeding a mixture of the triether (C) and the alkoxysilane compound (D) to a polymerization reactor;

(4): a method of feeding a product obtained by bringing the triether (C) into contact with the organoaluminum compound (B) to a polymerization reactor;

(5): a method of feeding a product obtained by bringing the alkoxysilane compound (D) into contact with the organoaluminum compound (B) to a polymerization reactor;

(6): a method of feeding a product obtained by bringing a mixture of the triether (C) and the alkoxysilane compound (D) into contact with the organoaluminum compound (B) to a polymerization reactor.

The organoaluminum compound (B) in the main-polymerization is used in an amount of usually 1 mol to 1,000 mol, and particularly preferably 5 to 600 mol, per 1 mol of titanium atoms which the solid catalyst component (A) to be used in the main-polymerization contains.

The triether (C) is used in an amount of usually 0.1 mol to 2,000 mol, preferably 0.3 mol to 1,000 mol, and particularly preferably 0.5 mol to 800 mol, per 1 mol of titanium atoms which the solid catalyst component (A) to be used in the main-polymerization contains. In addition, it is used in an amount of usually 0.001 mol to 5 mol, preferably 0.005 mol to 3 mol, and particularly preferably 0.01 mol to 1 mol, per 1 mol of the organoaluminum compound (B) to be used in the main-polymerization.

The alkoxysilane compound (D) is used in an amount of usually 0.1 mol to 2,000 mol, preferably 0.3 mol to 1,000 mol, and particularly preferably 0.5 mol to 800 mol, per 1 mol of titanium atoms which the solid catalyst component (A) to be used in the main-polymerization contains. In addition, it is used in an amount of usually 0.001 mol to 5 mol, preferably 0.005 mol to 3 mol, and particularly preferably 0.01 mol to 1 mol, per 1 mol of the organoaluminum compound (B) to be used in the main-polymerization.

The main-polymerization is carried out at a temperature of usually −30° C. to 300° C., and preferably 20° C. to 180° C. The pressure of the main-polymerization is not particularly limited, but is usually an atmospheric pressure to 10 MPa, and preferably 200 kPa to 5 MPa, from an industrial and economical point of view. The main-polymerization can be carried out in a batchwise or continuous method. The main-polymerization may be a slurry or solution polymerization method using an inert hydrocarbon solvent such as propane, butane, isobutane, pentane, hexane, heptane and octane, a bulk polymerization method using as a medium an olefin which is liquid at a polymerization temperature, or a gas-phase polymerization method.

### <Olefin Polymerization>

An olefin to be used in the process for producing an olefin polymer according to the present invention may be ethylene or an α-olefin having 3 or more carbon atoms. Examples of the α-olefin include a linear monoolefin such as propylene, 1-butene, 1-pentene, 1-hexene, 1-heptene, 1-octene and 1-decene; a branched monoolefin such as 3-methyl-1-butene, 3-methyl-1-pentene and 4-methyl-1-pentene; a cyclic monoolefin such as vinylcyclohexane; and a combination of two or more thereof. Among them, it is preferred to homopolymerize propylene or to copolymerize a combination of olefins comprising ethylene or propylene as a main component. The combination of olefins may comprise a combination of two or more kinds of olefin, or a combination of an olefin and a compound having a polyunsaturated bond such as a conjugated diene and a non-conjugated diene.

Examples of the olefin polymer produced according to the present invention are an α-olefin polymer such as propylene homopolymer, 1-butene homopolymer, 1-pentene homopolymer and 1-hexene homopolymer; an ethylene copolymer such as ethylene-propylene copolymer ethylene-1-butene copolymer and ethylene-1-hexene copolymer; a propylene copolymer such as propylene-1-butene copolymer, propylene-1-hexene copolymer, ethylene-propylene-1-butene copolymer and ethylene-propylene-1-hexene copolymer.

Examples of the olefin polymer produced according to the present invention are a propylene-based block copolymer produced by a method comprising the following steps [1], [2] and [3]:

[1]: a step of bringing the olefin polymerization catalyst component (A), the organoaluminum compound (B), the triether (C) and optionally the alkoxysilane compound (D) into contact with one another to produce an olefin polymerization catalyst;

[2]: a step of homopolymerizing propylene or copolymerizing propylene and other olefin in the presence of the olefin polymerization catalyst obtained in the step [1] to produce a polymer component (I) containing structural units derived from propylene in an amount of 90% by weight or more based on the total weight of the polymer component (I); and

[3]: a step of copolymerizing propylene and other olefin in the presence of the polymer component (I) to produce a polymer component (II) containing structural units derived from propylene in an amount of 10 to 90% by weight based on the total weight of the polymer component (II).

The content of the structural units derived from propylene which the polymer component (I) produced in the step [2] contains is preferably 90% by weight or more, more preferably 95% by weight or more, based on the total weight of the polymer component (I), from a viewpoint of stiffness of the resultant propylene-based block copolymer. The polymer component (I) is particularly preferably propylene homopolymer.

Examples of the olefin other than propylene used in the steps [2] and [3] include ethylene and α-olefins having 4 to 10 carbon atoms such as 1-butene, 1-pentene, 1-hexene, 1-heptene, 1-octene, 1-nonene, 1-decene and 4-methyl-1-pentene.

The content of the structural units derived from propylene which the polymer component (II) produced in the step [3] contains is preferably 10 to 90% by weight, more preferably 30 to 70% by weight, based on the total weight of the polymer component (II), from a viewpoint of impact resistance of the resultant propylene-based block copolymer.

The amount of the polymer component (II) is preferably 10 to 50% by weight, more preferably 15 to 40% by weight, based on the total weight of the propylene-based polymer, from a viewpoint of a balance of impact resistance and stiffness of the resultant propylene-based block copolymer.

The steps [2] and [3] are carried out at a polymerization temperature of usually −30° C. to 300° C., preferably 20° C. to 180° C., and more preferably 50° C. to 95° C. The polymerization pressure is not particularly limited, and is usually an atmospheric pressure to 10 MPa, and preferably 0.2 MPa to 5 MPa, from an industrial and economical point of view. The polymerization can be carried out in a batchwise or continuous method. The polymerization method may be a slurry polymerization method using an inert hydrocarbon solvent such as propane, butane, isobutane, pentane, hexane, heptane and octane, a solution polymerization method using such an inert hydrocarbon solvent, a bulk polymerization method using as a medium an olefin which is liquid at a polymerization temperature, or a gas-phase polymerization method, for example. The step [3] is preferably carried out according to a gas-phase polymerization method, in order to produce the propylene-based block copolymer having a good shape.

In the step [3], propylene is fed in an amount of usually 0.1 to 60 NL/minute, preferably 0.1 to 20 NL/minute, and more preferably 1 to 10 NL/minute, from an industrial and economical point of view.

In the step [3], the olefin other than propylene is fed in an amount of usually 0.1 to 60 NL/minute, preferably 0.1 to 20 NL/minute, more preferably 0.5 to 10 NL/minute, and still more preferably 0.5 to 4 NL/minute, from an industrial and economical point of view.

In the steps [2] and [3], a chain-transfer agent such as hydrogen, and an alkylzinc such as dimethylzinc and diethylzinc may be used in order to adjust a molecular weight of the resultant polymer components (I) and (II).

In the present invention, the triether (C) and/or the alkoxysilane compound (D) may be added before the step [3] or during the step [3].

The triether (C) or the alkoxysilane compound (D) may be added in combination with an inert hydrocarbon solvent such as butane, hexane and heptane.

The triether (C) and the alkoxysilane compound (D) may be the same as those used in the step [1] or may be different from those used in the step [1].

Each of the triether (C) and the alkoxysilane compound (D) is used in an amount of usually 0.1 mol to 2000 mol, more preferably 0.3 mol to 1000 mol, and particularly preferably 0.5 mol to 800 mol, per 1 mol of titanium atoms which the solid catalyst component (A) to be used in the main-polymerization contains, and in an amount of usually 0.001 mol to 5 mol, preferably 0.005 mol to 3 mol, and particularly preferably 0.01 mol to 1 mol, per 1 mol of the organoaluminum compound (B) to be used, in order to carry out a stable polymerization reaction and to obtain an article produced from the resultant propylene-based block copolymer, which has good shape and high impact resistance.

### <Propylene Polymer>

According to the process for producing an olefin polymer of the present invention, a propylene polymer satisfying all of the following requirements (1) to (4) can be obtained:

(1) an intrinsic viscosity measured at 135° C. in tetralin is 1.0 dl/g or less;
(2) a ratio [molecular weight distribution (Mw/Mn)] of a weight average molecular weight (Mw) to a number average molecular weight (Mn) measured by gel permeation chromatography (GPC) is not less than 3.0 and not more than 4.0;
(3) a total amount of bonds resulting from 2,1-insetion reaction and 3,1-insertion reaction in the total structural units derived from propylene, measured by a ¹³C nuclear magnetic resonance spectrum, is 0.01 mol % or less;
(4) an amount of a constituent extracted by subjecting 1 g of a sheet having a thickness of 100 μm obtained by pressing the propylene polymer in 10 ml of tetrahydrofuran for 1 hour to an ultrasonic treatment is 1700 ppm or less.

The aforementioned propylene polymer satisfying the requirements (1) to (4) may be a propylene random copolymer having structural units derived from at least one comonomer selected from the group consisting of ethylene and α-olefins having 4 to 10 carbon atoms, in addition to the structural units derived from propylene. Examples of the α-olefins having 4 to 10 carbon atoms include 1-butene, 1-hexene, and 1-octene. The propylene polymer satisfying the requirements (1) to (4) is preferably a propylene homopolymer.

When the propylene polymer satisfying the requirements (1) to (4) is a propylene random copolymer, an amount of the structural units derived from the comonomer mentioned above is preferably not less than 0.01% by weight and less than 20% by weight, with the proviso that the weight percentage of the propylene polymer is 100% by weight.

The propylene polymer of the present invention has an intrinsic viscosity ([η]) of 1.0 dl/g or less, preferably not less than 0.5 dl/g and not more than 1.0 dl/g, and more preferably not less than 0.7 dl/g and not more than 1.0 dl/g, measured at 135° C. in tetralin. When the intrinsic viscosity ([η]) is grater than 1.0 dl/g, fluidity of the propylene polymer and a polypropylene resin composition containing the propylene polymer tends to be lower and processability thereof tends to deteriorate.

The propylene polymer of the present invention has a ratio [molecular weight distribution (Mw/Mn)] of a weight average molecular weight (Mw) to a number average molecular weight (Mn) of not less than 3.0 and not more than 4.0, measured by gel permeation chromatography (GPC). When the molecular weight distribution (Mw/Mn) of the propylene polymer is less than 3.0, fluidity of the propylene polymer tends to be lower and formability thereof tends to deteriorate, and when the molecular weight distribution (Mw/Mn) is greater than 4.0, fogging resistance of the propylene polymer and a polypropylene resin composition containing the propylene polymer tends to deteriorate.

The isotactic pentad fraction (sometimes referred to as “mmmm” fraction) of propylene polymer, measured by ¹³C-NMR is preferably 0.97 or more, more preferably 0.98 or more, from a viewpoint of a balance of tensile strength and impact resistance of the propylene polymer and a polypropylene resin composition containing the propylene polymer. The isotactic pentad fraction means a fraction of isotactic chains having pentad units in the molecular chains of crystalline polypropylene, in other words, a fraction of propylene monomer units at the center of a continuously meso-bonded chain consisting of five propylene monomer units. The isotactic pentad fraction can be measured by the method disclosed in Macromolecules No. 6, pages 925-926 (1973), authored by A. Zambelli, et al, i.e., measured by using ¹³C-NMR. However, assignment of absorption peaks of NMR is based on Macromolecules No. 8, pages 687-689 (1975), published afterwards. The theoretical upper limit of “mmmm” fraction is 1.00. In the propylene polymer, the more its isotactic pentad fraction comes close to 1, the higher stereogularity in a molecular structure of a higher crystallinity polymer the propylene polymer regarded as.

In the propylene polymer of the present invention, a total amount of bonds resulting from 2,1-insetion reaction and 3,1-insertion reaction in the total structural units derived from propylene, measured by a ¹³C nuclear magnetic resonance spectrum, is 0.01 mol % or less, preferably 0.008 mol % or less, and more preferably 0.005 mol % or less. When the total amount of the bonds is greater than 0.01 mol %, stiffness of an article of such the propylene polymer or a polypropylene resin composition containing the propylene polymer may be insufficient.

When a propylene monomer is polymerized, it is polymerized usually with 1,2-insertion, but is polymerized infrequently with 2,1-insertion or 1,3-insertion. The “total amount of bonds resulting from 2,1-insetion reaction and 1,3-insertion reaction in the total structural units derived from propylene” of the propylene polymer refers to a total proportion of a bonds resulting from 2,1-insertion reaction and 1,3-insertion reaction, which are present in the propylene polymer, measured by ¹³C-NMR according to a method described in POLYMER, 30, 1350 (1989), authored by Tsutsui, et al.

In the propylene polymer of the present invention, an amount of a constituent extracted by subjecting 1 g of a sheet having a thickness of 100 μm obtained by pressing the propylene polymer in 10 ml of tetrahydrofuran for 1 hour to an ultrasonic treatment is 1700 ppm or less. The amount of a constituent extracted refers to a value determined by subjecting a conical flask containing 10 ml of tetrahydrofuran and 1 g of a sheet having a thickness of 100 μm obtained by pressing the propylene polymer to an ultrasonic treatment in water for 1 hour at 20° C. using a desktop ultrasonic emitter, and then determining a content of a constituent extracted in tetrahydrofuran using GC/FID. When the amount of a constituent extracted under the above-mentioned extraction condition is greater than 1700 ppm, fogging resistance of the propylene polymer and a polypropylene resin composition containing the propylene polymer may deteriorate.

The present propylene polymer has a low content of volatile organic compounds (sometimes abbreviated to as VOC). The propylene polymer according to the present invention is suitable to use as an interior material for vehicles such as an automobile.

### <Polypropylene Resin Composition (1)>

The polypropylene resin composition according to the present invention contains a propylene polymer and an ethylene-α-olefin copolymer. The propylene polymer is a polymer selected from the group consisting of a propylene polymer produced by using the olefin polymerization catalyst according to the present invention and a propylene polymer satisfying the requirements (1) to (4). The propylene polymer satisfying the requirements (1) to (4) may be produced by using the olefin polymerization catalyst according to the present invention. The propylene polymer may be a propylene homopolymer, a propylene-based block copolymer, or a propylene random copolymer.

The ethylene-α-olefin copolymer is a copolymer obtained by polymerizing ethylene and propylene or α-olefin having 4 to 10 carbon atoms. Examples of the α-olefin having 4 to 10 carbon atoms include 1-butene, 1-hexene, and 1-octene. The α-olefin may be used alone or as a combination of two or more kinds thereof.

In the ethylene-α-olefin copolymer, the amount of structural units derived from propylene or the α-olefin is preferably 20 to 80% by weight, more preferably 20 to 60% by weight, still more preferably 30 to 60% by weight, with the proviso that the weight percentage of the ethylene-α-olefin copolymer is 100% by weight.

The aforementioned ethylene-α-olefin copolymer can be produced by using a known catalyst and a known polymerization method. Examples of the catalyst include an olefin polymerization catalyst formed by bringing a solid catalyst component into contact with an organoaluminum compound, and optionally an external electron donor compound such as the above-mentioned electron donor compound, a triether, and an alkoxysilane compound, a catalyst formed by bringing a cyclopentadienyl ring-containing transition metal compound of Group 4 of the periodic table into contact with an alkylaluminoxane, a catalyst formed by bringing a cyclopentadienyl ring-containing transition metal compound of Group 4 of the periodic table into contact with a compound which forms an ionic complex by reacting with the cyclopentadienyl ring-containing transition metal compound and an organoaluminum compound.

The content of the ethylene-α-olefin copolymer in the polypropylene resin composition is preferably 5 to 50% by weight, more preferably 5 to 45% by weight, still more preferably 10 to 40% by weight, with the proviso that the total weight of the proplylene polymer and the ethylene-α-olefin copolymer is 100% by weight. When the content of the ethylene-α-olefin copolymer is 5 to 50% by weight, a balance among the mechanical properties of the polypropylene resin composition tends to be excellent.

The polypropylene resin composition according to the present invention may be produced by, for example, the following method (1) or (2):

(1) a method of adding the propylene polymer and the ethylene-α-olefin copolymer to a mixing device at once, and then melt-kneading the mixture;

(2) a method of adding the propylene polymer and the ethylene-α-olefin copolymer to a mixing device in a sequential manner, and then melt-kneading the mixture.

The above-mentioned melt-kneading can be performed by using a conventional method and a conventional machine. Examples of the method include a method in which the propylene polymer, the ethylene-α-olefin copolymer and various additives are mixed by using a mixing device such as a henschel mixer, a ribbon blender, and a tumble mixer, and then are melt-kneaded; and a method in which the propylene polymer, the ethylene-α-olefin copolymer and various additives are fed, respectively, at a certain rate continuously by means of a metering feeder to obtain a uniform mixture, and then the mixture is melt-kneaded by using an extruder equipped with a single screw or two or more screws, a banbury mixture, a roll type kneading machine, or the like.

The melt-kneading is carried out at the temperature of preferably 180° C. to 350° C., more preferably 180° C. to 320° C., and still more preferably 180° C. to 300° C.

### <Polypropylene Resin Composition (2)>

In another embodiment of the present invention, the polypropylene resin composition comprises a propylene polymer, at least one compound selected from the group consisting of the following compound group (S) and a compound having a hydroxyphenyl group. Hereinafter, the propylene polymer in this embodiment is sometimes referred to as “component (E)”, the compound selected from the group consisting of the following compound group (S) is sometimes referred to as “component (F)” and the compound having a hydroxyphenyl group is sometimes referred to as “component (G)”.

### <Propylene Polymer of Component (E)>

The component (E) is a polymer selected from the group consisting of a propylene polymer produced by polymerizing propylene and optionally a monomer selected from the group consisting of ethylene and α-olefin having 4 or more carbon atoms using the olefin polymerization catalyst according to the present invention, and a propylene polymer satisfying the requirements (1) to (4). The propylene polymer satisfying the requirements (1) to (4) may be produced by using the olefin polymerization catalyst according to the present invention. The propylene polymer may be a propylene homopolymer, a propylene-based block copolymer, or a propylene random copolymer. Examples of the component (E) include a propylene polymer satisfying the requirements (1) to (4) and a propylene-based block copolymer produced by the aforementioned method comprising the steps [1], [2] and [3]. The component (E) may contain two or more propylene polymer.

### <Compound of Component (F)>

Component (F) is at least one compound selected from the following compound group (S).

Compound Group (S):

a compound represented by CₙHₙ₊₂(OH)ₙ wherein n is an integer of 4 or more; an alkoxylated compound defined as follows; a compound represented by the following formula (3); trehalose, sucrose, lactose, maltose, melezitose, stachyose, curdlan, glycogen, glucose and fructose;

Alkoxylated compound:
a compound in which at least one hydroxy group in a compound represented by formula (2):

CₘH₂ₘOₘ (2)
wherein m is an integer number of 3 or more, is alkoxylated with an alkyl group having 1 to 12 carbon atoms, the compound represented by formula (2) containing one aldehyde or ketone group and m-1 hydroxy groups;
Compound represented by formula (3):

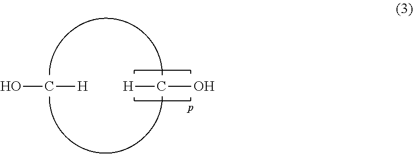

wherein p is an integer number of 2 or more.

Hereinafter, the compound represented by CₙHₙ₊₂(OH)ₙ is sometimes referred to as “compound (S1)”, the compound represented by the formula (2) is sometimes referred to as “compound (S2)” and the compound represented by the formula (3) is sometimes referred to as “compound (S3)”.

In CₙHₙ₊₂(OH)ₙ, n is an integer number of 4 or more, preferably an integer number of 5 to 8 and more preferably 6.

Examples of the compound (S1) include sugar alcohols having 4 or more carbon atoms. Examples of the sugar alcohols with n=4 include erythritol and threitol; examples of the sugar alcohols with n=5 include adonitol, arabinitol, and xylitol; examples of the sugar alcohols with n=6 include allitol, talitol, sorbitol, mannitol, iditol, and galactitol; examples of the sugar alcohols with n=7 include volemitol and perseitol; and examples of the sugar alcohols with n=8 include octitol.

The compound (S1) may be a D-isomer or an L-isomer, or may be a mixture of a D-isomer and an L-isomer. In addition, it may be optically active or optically inactive.

Compound (S1) is preferably a sugar alcohol having 6 carbon atoms.

The alkoxylated compound used in the present invention is a compound in which at least one hydroxy group of the compound (S2) is alkoxylated with an alkyl group having 1 to 12 carbon atoms, the compound (S2) being a compound containing in the molecule one aldehyde or ketone group and m-1 hydroxy groups.

In the formula (2), m is an integer number of 3 or more, preferably an integer number of 3 to 60 and more preferably 6 or 12.

The compound (S2) contains one aldehyde or ketone group in the molecule. The compound (S2) also contains m-1 hydroxy groups.

The compound (S2) is preferably a monosaccharide. Specific examples thereof include an aldehyde group-containing monosaccharide such as glycerose, erythrose, threose, ribose, lyxose, xylose, arabinose, aldohexose, allose, talose, gulose, glucose, altrose, mannose, galactose, idose, and octose; and a ketone group-containing monosaccharide such as ketotriose, dihydroxyacetone, ketotetrose, erythrulose, ketopentose, xylulose, ribulose, ketohexose, psicose, fructose, sorbose, and tagatose.

The compound (S2) may be an optically active compound such as a D-isomer or an L-isomer or may be an optically inactive compound such as a DL-isomer.

Among them, compound (S2) is preferably a hexose such as allose, talose, gulose, glucose, altrose, mannose, galactose, idose, psicose, fructose, sorbose, and tagatose, and particularly preferably glucose.

The alkoxylated compound is a compound in which at least one hydroxy group contained in the compound (S2) is alkoxylated with an alkyl group. The alkoxylated compound is preferably that containing at least one hydroxy group. An alkoxylated compound in which one of the hydroxy groups which the compound (S2) contains is alkoxylated and the other groups remain hydroxy groups is particularly preferable.

The number of carbon atoms of the alkyl group is from 1 to 12, preferably 1 or 2, and particularly preferably 1.

Preferred examples of the alkoxylated compound include compounds represented by formula (2-1):

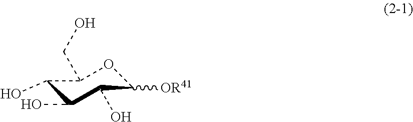

wherein R⁴¹ is an alkyl group having 1 to 12 carbon atoms and preferably 5 to 12 carbon atoms.

Examples of the compound represented by the formula (2-1) include methyl α-D-glucopyranoside, methyl β-D-glucopyranoside, ethyl α-D-glucopyranoside, ethyl β-D-glucopyranoside, n-propyl α-D-glucopyranoside, n-propyl β-D-glucopyranoside, n-butyl α-D-glucopyranoside, n-butyl β-D-glucopyranoside, n-pentyl α-D-glucopyranoside, n-pentyl β-D-glucopyranoside, n-hexyl α-D-glucopyranoside, n-hexyl β-D-glucopyranoside, n-heptyl α-D-glucopyranoside, n-heptyl β-D-glucopyranoside, n-octyl α-D-glucopyranoside, n-octyl β-D-glucopyranoside, n-nonyl α-D-glucopyranoside, n-nonyl β-D-glucopyranoside, n-decyl α-D-glucopyranoside, n-decyl β-glucopyranoside, n-undecyl α-D-glucopyranoside, n-undecyl β-D-glucopyranoside, n-dodecyl α-D-glucopyranoside, and n-dodecyl β-D-glucopyranoside.

The alkoxylated compound can be produced by using a method in which hydrogen chloride gas is passed through an alkyl alcohol solution of compound (S2) at −10° C. to room temperature, or a method in which a mixed solution of compound (S2), an alkyl alcohol and hydrochloric acid is alkoxylated by heating and refluxing, according to the description in Shin Jikken Kagaku Koza 14, Organic Compound Synthesis and Reactions V (Maruzen, published 20 Jul. 1978), p. 2426, for example.

The methyl α-D-glucopyranoside, n-octyl β-D-glucopyranoside, etc. are available from Tokyo Chemical Industry Co., Ltd.

In the formula (3), p is an integer number of 2 or more, preferably an integer number of 2 to 6 and more preferably 5.

Examples of the compound (S3) include 1,2,3-trihydroxycyclopropane, 1,2,3,4-tetrahydroxycyclopentane, 1,2,3,4,5-pentahydroxycyclopentane, 1,2,3,4,5,6-hexahydroxycyclohexane, 1,2,3,4,5,6,7-heptahydroxycycloheptane and 1,2,3,4,5,6,7,8-octahydroxycyclooctane.

Preferred examples of the compound (S3) include 1,2,3,4,5,6-hexahydroxycyclohexanes such as myo-inositol, epi-inositol, allo-inositol, muco-inositol, neo-inositol, chiro-inositol and scyllo-inositol. Particularly preferred is myo-inositol and scyllo-inositol, which are represented by the following formulae:

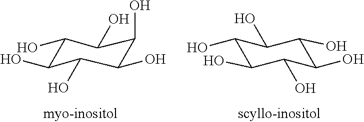 [SMILES: OC1C(O)C(O)C(O)C(O)C1O ; OC1C(O)C(O)C(O)C(O)C1O]

The polypropylene resin composition contains the component (F) in an amount of 0.01 to 0.5 parts by weight, preferably 0.01 to 0.25 parts by weight, per 100 parts by weight of the component (E). In this case, the polypropylene resin composition has a low content of VOC and is hard to become discolored.

### <Compound Having a Hydroxyphenyl Group of Component (G)>

The component (G) is a compound having a hydroxyphenyl group as a substituent. Examples thereof include 2,6-di-t-butyl-4-methylphenol, tetrakis[methylene-3(3′,5′-di-t-butyl-4-hydroxyphenyl) propionate]methane, octadecyl-3-(3,5-di-t-butyl-4-hydroxyphenyl)propionate, 3,9-bis[2-{3-(3-t-butyl-4-hydroxy-5-methylphenyl)propionyloxy}-1,1-dimethylethyl]-2,4,8,10-tetraoxaspiro[5.5]undecane, 1,3,5-tris 2[3(3,5-di-t-butyl-4-hydroxyphenyl) propionyloxy]ethylisocyanate, 1,3,5-trimethyl-2,4,6-tris(3,5-di-t-butyl-4-hydroxybenzyl)benzene, tris(3,5-di-t-butyl-4-hydroxybenzyl) isocyanurate, 1,3,5-tris(4-t-butyl-3-hydroxy-2,6-dimethylbenzyl) isocyanurate, pentaerythrityl-tetrakis[3-(3,5-di-t-butyl-4-hydroxyphenyl) propionate], triethyleneglycol-N-bis-3-(3-t-butyl-5-methyl-4-hydroxyphenyl)propionate, 1,6-hexanediolbis[3-(3,5-di-t-butyl-4-hydroxyphenyl)propionate], 2,2-thiobis-diethylenebis[3-(3,5-di-t-butyl-4-hydroxyphenyl) propionate], 2,2′-methylene-bis-(4-methyl-6-t-butylphenol), 2,2′-methylene-bis-(4-ethyl-6-t-butylphenol), 2,2′-methylene-bis-(4,6-di-t-butylphenol), 2,2′-ethylidene-bis-(4,6-di-t-butylphenol), 2,2′-butylidene-bis-(4-methyl-6-t-butylphenol), 4,4′-butylidenebis(3-methyl-6-t-butylphenol), 2-t-butyl-6-(3-t-butyl-2-hydroxy-5-methylbenzyl)-4-methylphenyl acrylate, 2,4-di-t-amyl-6-(1-(3,5-di-t-amyl-2-hydroxyphenyl)ethyl)phenyl acrylate, 2,4-di-t-pentyl-6-[1-(3,5-di-t-pentyl-2-hydroxyphenyl)ethyl]phenyl acrylate and 2-t-butyl-6-(3-t-butyl-2-hydroxy-5-methylbenzyl)-4-methylphenyl acrylate, 6-[3-(3-t-butyl-4-hydroxy-5-methylphenyl)propoxy]-2,4,8,10-tetra-t-butyldibenz[d,f][1,3,2]dioxaphosphepin, and tocopherol. Examples of the tocopherol include vitamin E which is α-tocopherol.

The component (G) is preferably a compound selected from the group consisting of a compound represented by the following formula (4) or (5).

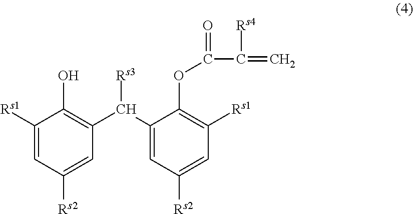

wherein R^{S1} and R^{S2} in formula (4) each independently are an alkyl group having 1 to 8 carbon atoms, an aryl group having 6 to 12 carbon atoms or an aralkyl group having 7 to 18 carbon atoms. R^{S3} is a hydrogen atom or an alkyl group having 1 to 3 carbon atoms and R^{S4} is a hydrogen atoms or a methyl group.

R^{S1} and R^{S2} in formula (4) each independently are an alkyl group having 1 to 8 carbon atoms, an aryl group having 6 to 12 carbon atoms or an aralkyl group having 7 to 18 carbon atoms. The two R^{S1} groups exist in formula (4), and they may be the same or different. The same applies to the R^{S2} groups.

The alkyl group having 1 to 8 carbon atoms may be a chain-like alkyl group or a cycloalkyl group. Preferred is a chain-like (linear or branched) alkyl group, and more preferred is a branched alkyl group. Examples of the alkyl group having 1 to 8 carbon atoms include a linear alkyl group having 1 to 8 carbon atoms (e.g., a methyl group, an ethyl group, a propyl group, a butyl group, a pentyl group that is also called an amyl group), a branched alkyl group having 3 to 8 carbon atoms (e.g., an isopropyl group, an isobutyl group, a sec-butyl group, a t-butyl group, a t-pentyl group, a 2-ethylhexyl group), a cycloalkyl group having 3 to 8 carbon atoms (e.g., a cyclopentyl group, a cyclohexyl group). Examples of the aryl group having 6 to 12 carbon atoms include a phenyl group, a 1-naphthyl group and a 2-naphthyl group. Examples of the aralkyl group having 7 to 18 carbon atoms include a benzyl group, a 1-phenylethyl group, a 2-phenylethyl group.

R^{S1} and R^{S2} in formula (4) each independently are preferably a branched alkyl group having 3 to 8 carbon atoms, more preferably an alkyl group that has 4 to 8 carbon atoms and that contains a tertiary carbon atom, still more preferably a t-butyl group and a t-pentyl group, and particularly preferably a t-pentyl group.

R^{S3} in formula (4) is a hydrogen atom or an alkyl group having 1 to 3 carbon atoms. The alkyl group having 1 to 3 carbon atoms may be a linear or branched alkyl group. Examples of the alkyl group having 1 to 3 carbon atoms include a methyl group, an ethyl group, a propyl group, and an isopropyl group. R^{S3} is preferably a hydrogen atom or a methyl group.

R^{S4} in formula (4) is a hydrogen atom or a methyl group. Preferred is a hydrogen atom.

Examples of the compound represented by the formula (4) include 2,4-di-t-butyl-6-[1-(3,5-di-t-butyl-2-hydroxyphenyl)ethyl]phenyl (meth)acrylate, 2-t-butyl-6-(3-t-butyl-2-hydroxy-5-methylbenzyl)-4-methylphenyl (meth)acrylate, 2,4-di-t-pentyl-6-[1-(3,5-di-t-pentyl-2-hydroxyphenyl)ethyl]phenyl (meth)acrylate, 2,4-di-t-butyl-6-(3,5-di-t-butyl-2-hydroxy-benzyl)phenyl (meth)acrylate, 2-t-butyl-6-(3-t-butyl-2-hydroxy-5-methylbenzyl)-4-ethylphenyl (meth)acrylate or 2-t-pentyl-6-(3-t-pentyl-2-hydroxy-5-methylbenzyl)-4-methyl phenyl (meth)acrylate. Here, “(meth)acrylate” means “acrylate and methacrylate”.

As the compound represented by the formula (4), 2,4-di-t-pentyl-6-[1-(3,5-di-t-pentyl-2-hydroxyphenyl)ethyl]phenyl acrylate and 2-t-butyl-6-(3-t-butyl-2-hydroxy-5-methylbenzyl)-4-methylphenyl acrylate are preferable. 2,4-di-t-pentyl-6-[1-(3,5-di-t-pentyl-2-hydroxyphenyl)ethyl]phenyl acrylate and 2-t-butyl-6-(3-t-butyl-2-hydroxy-5-methylbenzyl)-4-methylphenyl acrylate are available commercially under the trade names “Sumilizer® GS(F)” and “Sumilizer® GM”, respectively, from Sumitomo Chemical Co., Ltd.

As the compound represented by the formula (4), a commercially available product may be used, and also the compound produced by using any known method (e.g., a method disclosed in JP 2010-168545 A or JP 58-84835 A) may be used.

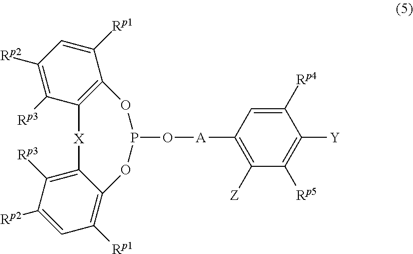

wherein R^{P1}, R^{P2}, R^{P4} and R^{P5} each independently are a hydrogen atom, an alkyl group having 1 to 8 carbon atoms, a cycloalkyl group having 5 to 8 carbon atoms, an alkyl cycloalkyl group having 6 to 12 carbon atoms, an aralkyl group having 7 to 12 carbon atoms or a phenyl group; R^{P3} groups each independently are a hydrogen atom or an alkyl group having 1 to 8 carbon atoms; X is a single bond, sulfur atom or a divalent group represented by formula (5-1):

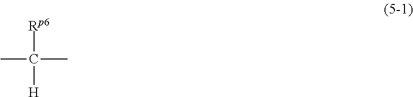

wherein R^{P6} is a hydrogen atom, an alkyl group having 1 to 8 carbon atoms or a cycloalkyl group having 5 to 8 carbon atoms;
   A is an alkylene group having 2 to 8 carbon atoms or a divalent group represented by formula (5-2):

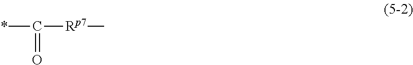

wherein R^{P7} is a single bond or an alkylene group having 1 to 8 carbon atoms, and * represents a binding site to an oxygen atom; and
   one of Y or Z is a hydroxy group, alkyl group having 1 to 8 carbon atoms, an alkoxy group having 1 to 8 carbon atoms or an aralkyloxy group having 7 to 12 carbon atoms and the other one is a hydrogen atom or an alkyl group having 1 to 8 carbon atoms.

As to R^{P1}, R^{P2}, R^{P4} and R^{P5} in formula (5), examples of the alkyl group having 1 to 8 carbon atoms include a methyl group, an ethyl group, an n-propyl group, an i-propyl group, an n-butyl group, an i-butyl group, a sec-butyl group, a t-butyl group, a t-pentyl group, an i-octyl group, a t-octyl group, and a 2-ethylhexyl group.

Examples of the cycloalkyl group having 5 to 8 carbon atoms include a cyclopentyl group, a cyclohexyl group, a cycloheptyl group, and a cyclooctyl group. Examples of the alkyl cycloalkyl group having 6 to 12 carbon atoms include a 1-methylcyclopentyl group, a 1-methylcyclohexyl group, a 1-methyl-4-1-propylcyclohexyl group. Examples of the aralkyl group having 7 to 12 carbon atoms include a benzyl group, an α-methylbenzyl group, an α,α-dimethylbenzyl group.

Preferably, each R^{P1}, R^{P2} and R^{P4} is independently an alkyl group having 1 to 8 carbon atoms, a cycloalkyl group having 5 to 8 carbon atoms or an alkyl cycloalkyl group having 6 to 12 carbon atoms. Each R^{P1} and R^{P4} is independently particularly preferably a t-alkyl group such as a t-butyl group, a t-pentyl group and a t-octyl group, a cyclohexyl group or 1-methylcyclohexyl group. Each RP2 groups is independently preferably an alkyl group having 1 to 5 carbon atoms such as a methyl group, an ethyl group, an n-propyl group, an i-propyl group, an n-butyl group, an i-butyl group, a sec-butyl group, a t-butyl group, and a t-pentyl group, and particularly preferably a methyl group, a t-butyl group or a t-pentyl group. RP5 is preferably an alkyl group such as a methyl group, an ethyl group, an n-propyl group, an i-propyl group, an n-butyl group, an i-butyl group, a sec-butyl group, a t-butyl group, and a t-pentyl group or a hydrogen atom, and more preferably a methyl group or a hydrogen atom.

As to R^{P3}, examples of the alkyl group having 1 to 8 carbon atoms include a methyl group, an ethyl group, an n-propyl group, an i-propyl group, an n-butyl group, an i-butyl group, a sec-butyl group, a t-butyl group, a t-pentyl group, an i-octyl group, a t-octyl group, and a 2-ethylhexyl group. Preferred is an alkyl group having 1 to 5 carbon atoms such as a methyl group, an ethyl group, an n-propyl group, an i-propyl group, an n-butyl group, an i-butyl group, a sec-butyl group, a t-butyl group and a t-pentyl group or a hydrogen atom, and particularly preferred is a methyl group or a hydrogen atom.

X is a single bond, a sulfur atom or a divalent group represented by the formula (5-1).

As to R^{P6} in formula (5-1), examples of the alkyl group having 1 to 8 carbon atoms include a methyl group, an ethyl group, an n-propyl group, an i-propyl group, an n-butyl group, an i-butyl group, a sec-butyl group, a t-butyl group, a t-pentyl group, an i-octyl group, a t-octyl group and a 2-ethylhexyl group. Examples of the cycloalkyl group having 5 to 8 carbon atoms include a cyclopentyl group, a cyclohexyl group, a cycloheptyl group and a cyclooctyl group. RP6 is preferably an alkyl group having 1 to 5 carbon atoms such as a methyl group, an ethyl group, an n-propyl group, an i-propyl group, an n-butyl group and an i-butyl group or a hydrogen atom.

X is preferably a single bond or a divalent group represented by the formula (5-1), and more preferably a single bond.

A is an alkylene group having 2 to 8 carbon atoms or a divalent group represented by the formula (5-2). A is preferably an alkylene group having 2 to 8 carbon atoms. Examples thereof include an ethylene group, a propylene group, a butylene group, a pentamethylene group, a hexamethylene group, an octamethylene group and a 2,2-dimethyl-1,3-propylene group. Preferred is a propylene group.

The divalent group represented by the formula (5-2) is bonded to an oxygen atom and a benzene nucleus. * represents a binding site to an oxygen atom.

Examples the alkylene group having 2 to 8 carbon atoms for R^{P7} include a methylene group, an ethylene group, a propylene group, a butylene group, a pentamethylene group, a hexamethylene group, an octamethylene group and a 2,2-dimethyl-1,3-propylene group. R^{P7} is preferably a single bond or an ethylene group.

One of Y or Z is a hydroxy group, an alkyl group having 1 to 8 carbon atoms, an alkoxy group having 1 to 8 carbon atoms or an aralkyloxy group having 7 to 12 carbon atoms, and the other one is a hydrogen atom or an alkyl group having 1 to 8 carbon atoms. Examples of the alkyl group having 1 to 8 carbon atoms include a methyl group, an ethyl group, an n-propyl group, an i-propyl group, an n-butyl group, an i-butyl group, a sec-butyl group, a t-butyl group, a t-pentyl group, an i-octyl group, a t-octyl group and a 2-ethylhexyl group. Examples of the alkoxy group having 1 to 8 carbon atoms include a methoxy group, an ethoxy group, an n-propoxy group, an i-propoxy group, an n-butoxy group, an i-butoxy group, a sec-butoxy group, a t-butoxy group, a t-pentyloxy group, an i-octyloxy group, a t-octyloxy group, a 2-ethylhexyloxy group. Examples of the aralkyloxy group having 7 to 12 carbon atoms include a benzyloxy group, an α-methylbenzyloxy group, and an α,α-dimethylbenzyloxy group.

The compound represented by the formula (5) is preferably a compound in which R^{P1} and R^{P4} are a t-alkyl group, a cyclohexyl group or a 1-methylcyclohexyl group, R^{P2} is an alkyl group having 1 to 5 carbon atoms, R^{P5} is a hydrogen atom or an alkyl group having 1 to 5 carbon atoms, R^{P3} is a hydrogen atom or an alkyl group having 1 to 5 carbon atoms, X is a single bond, and A is an alkylene group having 2 to 8 carbon atoms.

Examples of the compound represented by the formula (5) include 6-[3-(3-t-butyl-4-hydroxy-5-methylphenyl)propoxy]-2,4,8,10-tetra-t-butyldibenz[d,f][1,3,2]dioxaphosphepin, which is available commercially under the trade name “Sumilizer® GP” from Sumitomo Chemical Co., Ltd., 2,10-dimethyl-4,8-di-t-butyl-6-[3-(3,5-di-t-butyl-4-hydroxy phenyl)propoxy]-12H-dibenzo[d,g][1,3,2]dioxaphosphocin, 2,4,8,10-tetra-t-butyl-6-[3-(3,5-di-t-butyl-4-hydroxyphenyl) propoxy]dibenzo[d,f][1,3,2]dioxaphosphepin, 2,4,8,10-tetra-t-pentyl-6-[3-(3,5-di-t-butyl-4-hydroxyphenyl)propoxy]-12-methyl-12H-dibenzo[d,g][1,3,2]dioxaphosphocin, 2,10-dimethyl-4,8-di-t-butyl-6-[3-(3,5-di-t-butyl-4-hydroxy phenyl)propionyloxy]-12H-dibenzo[d,g][1,3,2]dioxaphosphocin, 2,4,8,10-tetra-t-pentyl-6-[3-(3,5-di-t-butyl-4-hydroxyphenyl)propionyloxy]-12-methyl-12H-dibenzo[d,g][1,3,2]dioxaphosphocin, 2,4,8,10-tetra-t-butyl-6-[3-(3,5-di-t-butyl-4-hydroxyphenyl) propionyloxy]-dibenzo[d,f][1,3,2]dioxaphosphepin, 2,10-dimethyl-4,8-di-t-butyl-6-(3,5-di-t-butyl-4-hydroxybenzoyloxy)-12H-dibenzo[d,g][1,3,2]dioxaphosphocin, 2,4,8,10-tetra-t-butyl-6-(3,5-di-t-butyl-4-hydroxybenzoyloxy]-12-methyl-12H-dibenzo[d,g][1,3,2]dioxaphosphocin, 2,10-dimethyl-4,8-di-t-butyl-6-[3-(3-methyl-4-hydroxy-5-t-butylphenyl)propoxy]-12H-dibenzo[d,g][1,3,2]dioxaphosphocin, 2,4,8,10-tetra-t-butyl-6-[3-(3,5-di-t-butyl-4-hydroxyphenyl) propoxy]-12H-dibenzo[d,g][1,3,2]dioxaphosphocin, 2,10-diethyl-4,8-di-t-butyl-6-[3-(3,5-di-t-butyl-4-hydroxyphenyl)propoxy]-12H-dibenzo[d,g][1,3,2]dioxaphosphocin and 2,4,8,10-tetra-t-butyl-6-[2,2-dimethyl-3-(3-t-butyl-4-hydroxy-5-methylphenyl)propoxy]-dibenzo[d,f][1,3,2]dioxaphosphepin. Preferred is 6-[3-(3-t-butyl-4-hydroxy-5-methylphenyl) propoxy]-2,4,8,10-tetra-t-butyldibenz[d,f][1,3,2]dioxaphosphepin.

The compound represented by the formula (5) can be produced by using any known method such as a method disclosed in JP 10-273494 A, for example.

When a compound selected from the group consisting of the compound represented by the formula (4) and the compound represented by the formula (5) is used as the component (G), it may be used in combination with the other compound having a hydroxyphenyl group.

The other compound having a hydroxyphenyl group is preferably a compound represented by the following formula (8):

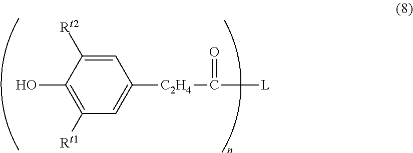

wherein R^{t1} and R^{t2} each independently are a hydrogen atom or an alkyl group having 1 to 6 carbon atoms, L is an n-valent alcohol residue having 1 to 24 carbon atoms and optionally having a heteroatom, n is an integer number of 1 to 4. Here, an alcohol residue refers to a group in which the hydrogen atom of the hydroxy group has been removed from an alcohol.

Hereinafter, the compound represented by the formula (8) is sometimes referred to as “component (G-2)”.

In the formula (8), R^{t1} and R^{t2} each independently are a hydrogen atom or an alkyl group having 1 to 6 carbon atoms. When n is 2 or more, the R^{t1} groups may be the same group or may be a different group from each other. The same applies to Rte groups. The alkyl group having 1 to 6 carbon atoms may be a chain-like alkyl group or a cycloalkyl group, and the chain-like alkyl group may be a linear or a branched alkyl group. Examples of the alkyl group having 1 to 6 carbon atoms include a linear alkyl group having 1 to 6 carbon atoms (e.g., a methyl group, an ethyl group, a propyl group, a butyl group, a pentyl group and hexyl group), a branched alkyl group having 3 to 6 carbon atoms (e.g., an isopropyl group, an isobutyl group, a t-butyl group, a t-pentyl group and t-hexyl group), and a cycloalkyl group having 3 to 6 carbon atoms (e.g., a cyclopentyl group and a cyclohexyl group). R^{t1} and R^{t2} each independently are preferably a linear alkyl group having 1 to 6 carbon atoms or a branched alkyl group having 3 to 6-carbon atoms, more preferably a methyl group or a t-butyl group. It is still more preferable that all of R^{t1} and R^{t2} groups are a t-butyl group.

In the formula (8), L is an n-valent alcohol residue having 1 to 24 carbon atoms and optionally having a heteroatom, and n is an integer number of 1 to 4. Examples of the heteroatom include an oxygen atom, a sulfur atom or a nitrogen atom. The carbon atoms which the n-valent alcohol residue having 1 to 24 carbon atoms contains may be substituted with the above-mentioned heteroatoms. That is, the n-valent alcohol residue having 1 to 24 carbon atoms may have —O—, —S— and —NR— wherein R is a hydrogen atom or other substituent (e.g., an alkyl group having 1 to 6 carbon atoms). The heteroatom is preferably an oxygen atom.

The n-valent (n is a number of 1 to 4) alcohol residue having 1 to 24 carbon atoms may be a chain-like or a cyclic group, or a combination thereof. The chain-like group may be a linear or a branched group.

Examples of a monovalent alcohol residue having 1 to 24 carbon atoms include a residue from methanol, ethanol, propanol, isopropanol, butanol, t-butanol, hexanol, octanol, decanol, dodecanol, tetradecanol, hexadecanol or octadecanol.

Examples of a divalent alcohol residue having 1 to 24 carbon atoms include a residue from ethylene glycol, 1,2-propanediol, 1,3-propanediol, 1,4-butanediol, 1,5-pentanediol, 1,6-hexanediol, 1,8-octanediol, 1,10-decanediol, 1,12-dodecanediol, 1,14-tetradecanediol, 1,16-hexadecanediol, diethylene glycol, triethylene glycol or 3,9-bis(1,1-dimethyl-2-hydroxyethyl)-2,4,8,10-tetraoxaspiro [5.5]undecane.

Examples of a trivalent alcohol residue having 1 to 24 carbon atoms include a residue from glycerol.

Examples of a tetravalent alcohol residue having 1 to 24 carbon atoms include a residue from erythritol or pentaerythritol.

Examples of the component (G-2) include esters of 3-(3,5-di-t-butyl-4-hydroxyphenyl)propionic acid, 3-(3-t-butyl-4-hydroxy-5-methylphenyl)propionic acid or 3-(3,5-dicyclohexyl-4-hydroxyphenyl)propionic acid with a monovalent or polyvalent alcohol. Example of the aforementioned monovalent or polyvalent alcohol include methanol, ethanol, octanol, octadecanol, ethylene glycol, 1,3-propanediol, 1,4-butanediol, 1,6-hexanediol, 1,9-nonanediol, neopentyl glycol, diethylene glycol, thioethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2,2,2]octane, 3,9-bis(1,1-dimethyl-2-hydroxyethyl)-2,4,8,10-tetraoxaspiro [5.5]undecane and a mixture thereof.

The component (G-2) is preferably octadecyl 3-(3,5-di-t-butyl-4-hydroxyphenyl)propionate, which is available commercially under the trade name “IRGANOX® 1076” from BASF, 3,9-bis[2-{3-(3-t-butyl-4-hydroxy-5-methylphenyl) propionyloxy}-1,1-dimethylethyl]-2,4,8,10-tetraoxaspiro[5.5 ]undecane, which is available commercially under the trade name “Sumilizer® GA-80” from Sumitomo Chemical Co., Ltd., and pentaerythritol tetrakis[3-(3,5-di-t-butyl-4-hydroxyphenyl)propionate], which is available commercially under the trade name “IRGANOX® 1010” from BASF.

Among them, 3,9-bis[2-{3-(3-t-butyl-4-hydroxy-5-methylphenyl) propionyloxy}-1,1-dimethylethyl]-2,4,8,10-tetraoxaspiro[5.5]undecane and pentaerythritol tetrakis[3-(3,5-di-t-butyl-4-hydroxyphenyl)propionate] are more preferable, and pentaerythritol tetrakis[3-(3,5-di-t-butyl-4-hydroxyphenyl)propionate] is still more preferable.

As the component (G-2), a commercially available product may be used, and also the compound produced by using any known method (e.g., a method disclosed in U.S. Pat. No. 3,644,482 or JP 59-25826 A) may be used.

The polypropylene resin composition according to the present invention contains the component (G) in an amount of 0.01 to 0.5 parts by weight, preferably 0.01 to 0.25 parts by weight, per 100 parts by weight of component (E). When the content of the component (G) is less than 0.01 part by weight per 100 parts by weight of the component (E), the polypropylene resin composition tends to deteriorate.

When two different compounds which have a hydroxyphenyl group are used as the component (G), the weight ratio of one compound to the other one may be within a range of 1:1 to 10:1.

The polypropylene resin composition according to the present invention may optionally contain the other resins than the propylene polymer (component (E)) or rubbers, other additives than the compound having a hydroxyphenyl group (component (G)), inorganic fillers and the like, insofar as the object of the present invention is not marred.

Examples of the other resins than the propylene polymer (component (E)) include an ethylene-α-olefin random copolymer (hereinafter, it is sometimes referred to as “component (H)”), ABS (acrylonitrile/butadiene/styrene copolymer) resin, AAS (special acrylic rubber/acrylonitrile/styrene copolymer)resin, ACS (acrylonitrile/chlorinated polyethylene/styrene copolymer) resin, polychloroprene, chlorinated rubber, polyvinyl chloride, polyvinylidene chloride, fluorine resin, polyacetal, polysulfone, polyetheretherketone, polyethersulfone.

Preferably, the aforementioned component (H) is an ethylene-α-olefin random copolymer having a melt flow rate of 5 g/10 minutes or less, measured under a load of 2.16 kgf at 190° C., according to JIS-K-7210 or an ethylene-α-olefin random copolymer having a melt flow rate of 10 g/10 minutes or more. Hereinafter, the former is sometimes referred to as “component (H-1)” and the latter is sometimes referred to as “component (H-2)”.

The melt flow rate of the component (H-1) is preferably 3 g/10 minutes or less and the melt flow rate of the component (H-2) is preferably 12 g/10 minutes or more.

An α-olefin used in the propylene polymer (component (E)), i.e., an α-olefin having 4 to 10 carbon atoms, may be used as the α-olefin used in the components (H-1) and (H-2). Specific examples thereof include an α-olefin having a ring structure, such as 1-butene, 1-pentene, 1-hexene, 4-methyl-1-pentene, 1-octene and 1-decene. Preferred are 1-butene, 1-hexene and 1-octene.

Specific examples of the components (H-1) and (H-2) include ethylene-1-butene copolymer, ethylene-1-hexene copolymer, ethylene-1-octene copolymer, ethylene-1-decene copolymer, ethylene-(3-methyl-1-butene) copolymer and a copolymer containing ethylene and a ring structure.

The components (H-1) and (H-2) contain structual units derived from α-olefin in an amount of preferably 1 to 49% by weight, more preferably 5 to 49% by weight, and still more preferably 10 to 49% by weight, respectively, with the proviso that the weight percentage of the component (H-1) or (H-2) is 100% by weight.

The components (H-1) and (H-2) preferably have a density of 0.85 to 0.89 g/cm³, more preferably 0.85 to 0.88 g/cm³, and still more preferably 0.855 to 0.875 g/cm³, respectively, in order to improve impact resistance of an article of the polypropylene resin composition.

The components (H-1) and (H-2) can be produced by using a polymerization catalyst.

Examples of the polymerization catalyst include a homogeneous catalyst system represented by a metallocene catalyst, and a Ziegler-Natta catalyst system.

Examples of the homogeneous catalyst system include a catalyst system comprising a cyclopentadienyl ring-containing transition metal compound of Group 4 of the periodic table and an alkylaluminoxane; a catalyst system comprising a cyclopentadienyl ring-containing transition metal compound of Group 4 of the periodic table, a compound which forms an ionic complex by reacting with the cyclopentadienyl ring-containing transition metal compound, and an organoaluminum compound; and a catalyst system obtained by supporting a catalyst component (e.g., a cyclopentadienyl ring-containing transition metal compound of Group 4 of the periodic table, a compound which forms an ionic complex by reacting with the cyclopentadienyl ring-containing transition metal compound, and an organoaluminum compound) on inorganic particles such as silica and clay mineral, and modifying the resultant supported material. Also, the polymerization catalyst may be a pre-polymerization catalyst system prepared by pre-polymerizing ethylene or an α-olefin in the presence of the above catalyst system.

Examples of the Ziegler-Natta catalyst system include a catalyst system in which a titanium-containing solid transition metal component is used in combination with an organometal component.

As the components (H-1) and (H-2), a commercially available product may be used. For example, ENGAGE® (Dow Chemical Japan Ltd.), TAFMER®, (Mitsui Chemicals, Inc.), NEO-ZEX® and ULT-ZEX® (Prime polymer Co., Ltd.), and EXCELLEN FX®, SUMIKATHENE®, and ESPRENE SPO® (Sumitomo Chemical Co., Ltd.) may be used.

Examples of the other additives than the component (G) include DV absorbers, antistatic agents, lubricants, nucleating agents, adhesives, antifog agents, and antiblocking agents.

The additives may be inorganic fillers. The inorganic fillers may be non-fibrous inorganic fillers (hereinafter, sometimes referred to as “component (J-1)”) or fibrous inorganic fillers (hereinafter, sometimes referred to as “component (J-2)”).

The component (J-1) means inorganic fillers having forms other than powder, flake, granule or fiber form. Specific examples thereof include talc, mica, calcium carbonate, barium sulfate, magnesium carbonate, clay, alumina, silica, calcium sulfate, silica sand, carbon black, titanium oxide, magnesium hydroxide, zeolite, molybdenum, diatomite, sericite, white sand, calcium hydroxide, calcium sulfite, sodium sulfate, bentonite and graphite. They may be used alone or in combination of two or more kinds thereof.

The component (J-1) may be used without being subjected to any preliminary treatment. Alternatively, they may be used after treatment of its surface with silane coupling agents, titanium coupling agents or surfactants, in order to improve interfacial adhesion with the propylene polymer (component (E)) and to improve dispersibility in the propylene polymer (component (E)). As the surfactants, for example, higher fatty acids, higher fatty esters, higher fatty amides, and salts of higher fatty acids may be used.

The average particle diameter of the component (J-1) is preferably 10 μl or less, and more preferably 5 μm or less. In the present invention, “average particle diameter” means a 50% equivalent particle diameter D50 which is determined from an integral distribution curve by the sub-sieve method, which is measured by suspending the component (J-1) in a dispersing medium, such as water or alcohol, by using a centrifugal sedimentation type particle size distribution analyzer.

The component (J-2) means inorganic fillers having a fiber form. Specific examples thereof include fibrous magnesiumoxysulfate, potassium titanate fiber, magnesium hydroxide fiber, aluminum borate fiber, calcium silicate fiber, calcium carbonate fiber, carbon fiber, glass fiber and metallic fiber. They may be used alone or in combination of two or more kinds thereof. Among them, fibrous magnesiumoxysulfate and calcium silicate fiber are preferable, and fibrous magnesiumoxysulfate is more preferable.

The component (J-2) may be used without being subjected to any preliminary treatment. Alternatively, they may be used after treatment of its surface with silane coupling agents or metal salts of higher fatty acid, in order to improve interfacial adhesion with the propylene polymer (component (E)) and to improve dispersibility in the propylene polymer (component (E)). As the metal salts of higher fatty acid, for example, calcium stearate, magnesium stearate and zinc stearate may be used.

The average fiber length of the component (J-2), determined by an electron microscope observation, is 3 μm or more, preferably 3 μm to 20 μm, and more preferably 7 μm to 15 μm. The aspect ratio is 10 or more, preferably 10 to 30, and still more preferably 12 to 25. In addition, the average diameter of the component (J-2), determined by an electron microscope observation, is preferably 0.2 μm to 1.5 μm, and more preferably 0.3 μm to 1.0 μm.

The polypropylene resin composition can be used as an article by melt-kneading the propylene polymer of component (E), the compound of component (F) and the compound having a hydroxyphenyl group of component (G), and then molding the resultant mixture.

The above-mentioned melt-kneading can be performed by using a conventional method and a conventional machine. Examples of the method include a method in which the propylene polymer of component (E), the compound of component (F) and the compound having a hydroxyphenyl group of component (G) are mixed by using a mixing device such as a henschel mixer, a ribbon blender, and a tumble mixer, and then are melt-kneaded; and a method in which the propylene polymer, the ethylene-α-olefin copolymer and various additives are fed, respectively, at a certain rate continuously by means of a metering feeder to obtain a uniform mixture, and then the mixture is melt-kneaded by using an extruder equipped with a single screw or two or more screws, a banbury mixture, a roll type kneading machine, or the like.

The melt-kneading is carried out at a temperature of preferably 180° C. or more, more preferably 180° C. to 300° C., and still more preferably 180° C. to 250° C.

The article obtained from the resin composition according to the present invention is preferably that produced by using an injection molding method. Examples of the injection molding method are a conventional injection molding method, an injection foam molding method, a supercritical injection foam molding method, an ultrahigh speed injection molding method, an injection compression molding method, a gas-assist injection molding method, a sandwich molding method, a sandwich foam molding method, and an insert-outsert molding method.

After molding and cooling the resin composition, an article comprising the polypropylene resin composition according to the present invention can be obtained. Examples of the article according to the present invention are containers, container lids, packaging materials, writing materials, toys, convenience goods, furniture materials, fibers, agricultural films, automobile components, home electrical components, medical materials and building materials.

The article comprising the polypropylene resin composition according to the present invention is preferably used as a material which coexists with people in an enclosed space, since the molded article of the present invention is that having a low content of VOC. Preferred examples of the automobile components are interior components and headlamp components. Preferred examples of the building materials are residential inner wall materials and wallpapers. Preferred examples of the furniture materials are components of closets and storage containers. Preferred examples of the home electrical components are components of display for personal computer and TV, OA equipment components, and housing components such as components of air conditioners, washing machines and air cleaner components. Preferred examples of the agricultural films are films of greenhouses and tunnels. Preferred examples of the fibers are fibers for clothes, carpets and sofas.

### EXAMPLES

Hereinafter, the present invention will be described in more detail by way of Examples, but the present invention is not limited thereto.

### (1) Identification of Compound

The identification of the compound was performed by means of ¹H-NMR. ¹H-NMR spectra were obtained by using a nuclear magnetic resonator (JNM-AL400: manufactured by JEOL Ltd.) under the following condition. The chemical shift value was based on hydrogen of tetramethylsilane.

Measurement solvent: CDCl₃

Measurement temperature: room temperature

### (2) Yield of Product

The yield of the objective products were determined by using a gas chromatograph (GC-2010: manufactured by Shimadzu Corporation) under the following condition.

Measurement column: DB-1 (manufactured by Aglient Technologies inc),
Length: 30 m, inside diameter: 0.25 mm,
film thickness: 0.25 μm

Measurement temperature: 100° C. to 300° C. (10° C./minute),
kept at 300° C. for 10 minutes
   (3) Intrinsic Viscosity ([η]: dl/g)

Intrinsic viscosity of the obtained polymer was determined as follows: 100 mg of the produced polymer was dissolved in 50 ml of tetralin at 135° C. to obtain a measuring sample, and dropping velocity of the sample was measured by using Ubbellohde viscometer placed in a hot-water bath in which its temperature was kept at 135° C., and then the intrinsic viscosity was determined on the basis of the velocity.

(4) Isotactic Pentad Fraction ([mmmm])

Isotactic pentad fraction was determined based on ¹³C-NMR spectrum, as a proportion of the peak area attributed to methyl carbon of mmmm pentad at 21.6 to 22.02 ppm [I (mmmm)] to the peak area attributed to methyl carbon at 19.4 to 22.2 ppm [I (CH₃)].

### (Measurement Condition)

Device: AVANCE 600 10 mm CryoProbe manufactured by Bruker

Measurement solvent: mixture of 1,2-dichlorobenzene/l, 2-dichlorobenzene-d₄ (volume ratio: 75/25)

Measurement temperature: 130° C.

Measurement method: proton-decoupling method

Pulse width: 45°

Pulse repeating time: four seconds

Basis of chemical shift value: tetramethylsilane

### (5) Amount of Soluble Component in Xylene (CXS: % by Weight)

The weight percentage of the amount of soluble parts in cooled xylene at 20° C. in the polymer was defined as CXS (% by weight in unit). The smaller the value of CXS, the higher the amorphous polymer content in the polymer, and it shows that the polymer has a high stereoregularity.

### (6) Molecular Weight and Molecular Weight Distribution

The molecular weight was measured by gel permeation chromatography (GPC) as follows. The analytical curve was created by using standard polystyrenes. The molecular weight distribution was evaluated by a ratio (Mw/Mn) of weight average molecular weight (Mw) to average molecular weight (Mn).

Apparatus: Model 150C manufactured by Milliporewaters

Column: TSK-GEL GMH6-HT 7.5 Φmm×300 mm

Measurement temperature: 140° C.

Solvent: orthodichlorobenzene

Measured concentration: 5 mg/5 ml

### (7) Analysis of Solid Samples Such as Solid Catalyst Component

The content of titanium atoms was determined as follows: a solid sample was decomposed with diluted sulfuric acid, and an aqueous hydrogen peroxide solution was added thereto; and the characteristic absorption of the obtained liquid sample at 410 nm was measured with a double beam spectrophotometer, U-2001 model manufactured by Hitach, Ltd. and the content of titanium atoms was determined from an analytical curve which had been separately created.

The alkoxy group content was determined as follows: a solid sample was decomposed with water, and an amount of alcohol corresponding to the content of the alkoxy group in the obtained liquid sample was determined with a gas chromatography internal standard method, and was then converted into the content of the alkoxy group.

The content of carboxylate ester was determined as follows: a solid catalyst component was decomposed with water, and then was extracted from the obtained liquid sample with a saturated hydrocarbon solvent to obtain a component soluble in the solvent, and the content of the carboxylate ester in the extraction liquid was determined with a gas chromatography internal standard method.

### (8) Fogging Test

A sample was weighed. The fogging test of the sample was performed under the following condition. After the fogging test, the sample was weighed. The amount of VOC volatilized from the propylene polymer and the polypropylene resin was calculated by measuring a weight of reduction of the sample before and after the test.

### (Measurement Condition)

Measurement device: Suga testing equipment window screen fogging tester, Model WF-2

Heating condition: 120° C.

Cooling condition: 25° C.

Time: 20 hours

Sample amount: 5 g

### Reference Example 1

### Synthesis of 1-tert-butoxy-2,2-bis(methoxymethyl)-3-methyl butane

### (1) Synthesis of diethyl 2-isopropyl-2-methoxymethylmalonate

Isopropyl diethyl malonate (25 g, 124 mmol) was dissolved in dry N,N-dimethylformamide (65 mL). Another flask was charged with 65 mL of N,N-dimethylformamide, and NaH (55% by weight, 9.09 g, 208 mmol) was dispersed therein. The above solution of isopropyl diethyl malonate was dropped into the dispersion liquid at 0° C. After completion of the dropping, the mixture was stirred at room temperature for 1 hour. Then, the mixture was cooled to 0° C., and chloromethyl methyl ether (14.0 mL, 185 mmol) was dropped thereto. After completion of the dropping, the mixture was stirred at room temperature for 4 hours. The reaction solution was washed with water, and then the reactant was extracted therefrom with diethylether. The obtained ether extract was dried with anhydrous sodium sulfate, and was filtrated. After that, the solvent was distilled off, and distilled under reduced pressure (boiling point: 100 to 101° C./0.60 kPa) to obtain 25 g of diethyl 2-isopropyl-2-methoxymethylmalonate (yield: 73, purity: 99% (GC area percentage)). ¹H-NMR (400 MHz, CDCl₃) δ 1.00 (d, 6H), 1.26 (t, 6H), 2.51 (sep, 1H), 3.32 (s, 3H), 3.79 (s, 2H), 4.21 (q, 4H).

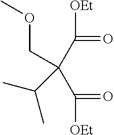 [SMILES: CCOC(=O)C(COC)(C(=O)OCC)C(C)C]

### (2) Synthesis of 2-hydroxymethyl-2-methoxymethyl-3-methyl-1-butanol

The obtained diethyl 2-isopropyl-2-methoxymethylmalonate (4.00 g, 16.2 mmol) was dissolved in dry tetrahydrofuran (14 mL). Another flask was charged with 14 mL of tetrahydrofuran, and lithium aluminum hydride (1.36 g, 35.7 mmol) was dispersed therein. The above solution of diethyl 2-isopropyl-2-methoxymethylmalonate was dropped into the dispersion liquid at 0° C. After completion of the dropping, the mixture was stirred at room temperature for 1 hour, and then aqueous sodium hydroxide was dropped into the reaction solution. After that, the obtained solution was neutralized with 1 mol/L of sulfuric acid, and then the reactant was extracted therefrom with diethylether. The obtained ether extract was dried with anhydrous sodium sulfate, and was filtrated. Then, the solvent was distilled off to obtain 2.51 g of 2-hydroxymethyl-2-methoxymethyl-3-methyl-1-butanol (yield: 95%, purity: 100% (GC area percentage)). ¹H-NMR (400 MHz, CDCl₃) δ 0.89 (s, 6H), 1.84 (sep, 1H), 2.69 (br, 2H), 3.35 (s, 3H), 3.45 (s, 2H), 3.69 (dd, 2H), 3.81 (dd, 2H).

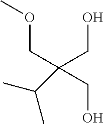

### (3) Synthesis of 5-isopropyl-5-methoxymethyl-2,2-dimethyl-1,3-dioxane

A 30 mL flask equipped with a stirrer was charged with 2-hydroxymethyl-2-methoxymethyl-3-methyl-1-butanol (1.20 g, 7.40 mmol), 2,2-dimethoxypropane (1.09 mL, 8.88 mmol), 0.14 g of p-toluenesulfonic acid and 6 mL of N,N-dimethylformamide, and then the mixture was stirred at room temperature for 3 hours. The obtained reaction mixture was neutralized with aqueous sodium hydrogen carbonate, and then the reactant was extracted therefrom with diethylether. The obtained ether extract was dried with anhydrous sodium sulfate, and was filtrated. Then, the solvent was distilled off to obtain 1.31 g of 5-isopropyl-5-methoxymethyl-2,2-dimethyl-1,3-dioxane (yield: 82%, purity: 94% (GC area percentage)).

¹H-NMR (400 MHz, CDCl³) δ 0.89 (d, 6H), 1.39 (s, 3H), 1.40 (s, 3H), 1.76 (sep, 1H), 3.34 (s, 3H), 3.47 (s, 2H), 3.63-3.74 (m, 4H).

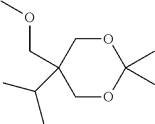

### (4) Synthesis of 2-tert-butoxymethyl-2-methoxymethyl-3-methyl-1-butanol

A flask equipped with a stirrer was charged with the obtained 5-isopropyl-5-methoxymethyl-2,2-dimethyl-1,3-dioxane (0.951 g, 6.43 mmol) and 7 mL of anhydrous toluene as a solvent, and then diethylether solution of MeMgI (3M, 4.28 mL, 12.9 mmol) was dropped thereto at room temperature. After completion of the dropping, 4 mL of the solvent was distilled off under a pressure of 500 kPa, at 40° C., the reaction solution was stirred for 3 hours at 100° C. Aqueous ammonium chloride was added to the reaction solution, and then the reactant was extracted therefrom with diethylether. The obtained ether extract was dried with anhydrous sodium sulfate, and was filtrated. Then, the solvent was distilled off to obtain 0.861 g of 2-tert-butoxymethyl-2-methoxymethyl-3-methyl-1-butanol (yield: 63%, purity: 96% (GC area percentage)).

¹H-NMR (400 MHz, CDCl₃) δ 0.89 (d, 3H), 0.90 (d, 3H), 1.19 (s, 9H), 1.93 (sep, 1H), 3.32 (s, 3H), 3.33 (dd, 1H), 3.41 (s, 2H), 3.46 (dd, 2H), 3.66 (m, 2H).

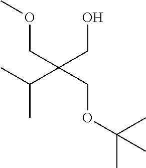

### (5) Synthesis of 1-tert-butoxy-2,2-bis(methoxymethyl)-3-methyl butane

The obtained 2-tert-butoxymethyl-2-methoxymethyl-3-methyl-1-butanol

(0.800 g, 3.66 mmol) was dissolved in dry THF (4.5 mL). Another flask was charged with 4.5 mL of THF, and NaH (55% by weight, 0.240 g, 5.50 mmol) was dispersed therein. The above solution of 2-tert-butoxymethyl-2-methoxymethyl-3-methyl-1-butanol was dropped into the dispersion liquid at 0° C. After completion of the dropping, the mixture was stirred at room temperature for 1 hour. And then, the mixture was cooled to 0° C., and methyl iodide (0.46 mL, 7.33 mmol) was dropped into the mixture. After completion of the dropping, the mixture was stirred at room temperature for 1.5 hours. The reaction solution was washed with water, and then the reactant was extracted therefrom with diethylether. The obtained ether extract was dried with anhydrous sodium sulfate, and was filtrated. After that, the solvent was distilled off, and distilled under reduced pressure (boiling point: 85 to 86° C./1.0 kPa) to obtain 0.365 g of 1-tert-butoxy-2,2-bis(methoxymethyl)-3-methylbutane (yield: 45%, purity: 99% (GC area percentage)).

¹H-NMR (400 MHz, CDCl₃) δ 0.94 (d, 6H), 1.14 (s, 9H), 1.78 (seq, 1H), 3.24 (s, 2H), 3.31 (s, 4H), 3.34 (s, 6H).

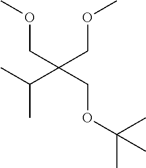 [SMILES: COCC(COC)(COC(C)(C)C)C(C)C]

### Reference Example 2

### Synthesis of 1-cyclohexyloxy-2,2-bis(methoxymethyl)-3-methyl butane

### (1) Synthesis of 3-isopropyl-3-methoxymethyl-1,5-dioxaspiro[5.5]undecane

A 30 mL flask equipped with a stirrer was charged with 2-hydroxymethyl-2-methoxymethyl-3-methyl-1-butanol (0.50 g, 3.08 mmol) produced in the Reference Example 1 (2), cyclohexanone (0.37 mL, 3.39 mmol), 0.059 g of p-toluenesulfonic acid, and 2.6 mL of N,N-dimethylformamide, and then the mixture was stirred for 3 hours at room temperature. The obtained reaction mixture was neutralized with aqueous sodium hydrogen carbonate, and then the reactant was extracted therefrom with diethylether. The obtained ether extract was dried with anhydrous sodium sulfate, and was filtrated. Then, the solvent was distilled off to obtain 0.68 g of 3-isopropyl-3-methoxymethyl-1,5-dioxaspiro[5.5]undecane (yield: 87%, purity: 96% (GC area percentage)).

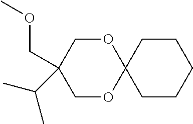 [SMILES: COCC1(C(C)C)COC2(CCCCC2)OC1]

### (2) Synthesis of 2-cyclohexyloxymethyl-2-methoxymethyl-3-methyl-1-butanol

A flask equipped with a stirrer was charged with LiAlH₄ (0.099 g, 2.48 mmol), AlCl₃ (0.116 g, 0.86 mmol) and 2 mL of anhydrous diethylether, and the mixture was stirred at room temperature for 30 minutes. Then, 2 mL of anhydrous diethylether solution of the obtained 3-isopropyl-3-methoxymethyl-1,5-dioxaspiro[5.5]undecane (0.300 g, 1.24 mmol) was dropped, and the mixture was refluxed for 8 hours. Aqueous sodium hydroxide, water and sodium sulfate were added to the reaction solution, and then the obtained solution was filtrated over celite. After that, the solvent was distilled off to obtain 0.269 g of 2-cyclohexyloxymethyl-2-methoxymethyl-3-methyl-1-butanol (yield: 89%, purity: 99% (GC area percentage)).

¹H-NMR (400 MHz, CDCl₃) δ 0.88 (d, 3H), 0.89 (d, 3H), 1.26 (m, 5H), 1.50 (m, 1H), 1.69 (m, 2H), 1.84 (m, 2H), 1.93 (sep, 1H), 3.22 (m, 1H), 3.32 (s, 3H), 3.43 (s, 2H), 3.50 (dd, 1H), 3.54 (dd, 1H), 3.68 (m, 3H).

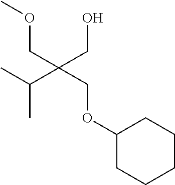 [SMILES: COCC(CO)(COC1CCCCC1)C(C)C]

### (3) Synthesis of 1-cyclohexyloxy-2,2-bis(methoxymethyl)-3-methylbutane

The obtained 2-cyclohexyloxymethyl-2-methoxymethyl-3-methyl-1-butanol (0.250 g, 1.02 mmol) was dissolved in dry THF (2 mL). Another flask was charged with 2 mL of THF, and NaH (55% by weight, 0.067 g, 1.53 mmol) was dispersed therein. The above solution of 2-cyclohexyloxymethyl-2-methoxymethyl-3-methyl-1-butanol was dropped into the dispersion liquid at 0° C. After completion of the dropping, the mixture was stirred at 35° C. for 2 hours. And then, the mixture was cooled to 0° C., and methyl iodide (0.13 mL, 2.05 mmol) was dropped into the mixture. After completion of the dropping, the mixture was stirred at 35° C. for 1.5 hours. The reaction solution was washed with water, and then the reactant was extracted therefrom with diethylether. The obtained ether extract was dried with anhydrous sodium sulfate, and was filtrated. After that, the solvent was distilled off, and the residue was purified with silica gel column chromatography (solvent: hexane/ethyl acetate=100/4) to obtain 0.131 g of 1-cyclohexyloxy-2,2-bis(methoxymethyl)-3-methylbutane (yield: 49%, purity: 99% (GC area percentage)) ¹H-NMR (400 MHz, CDCl₃) δ 0.92 (d, 6H), 1.24-1.33 (m, 6H), 1.66-1.71 (m, 2H), 1.71 (m, 2H), 1.79 (seq, 1H), 3.15 (m, 1H), 3.30 (s, 6H), 3.32 (s, 4H), 3.34 (s, 2H).

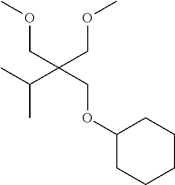 [SMILES: COCC(COC)(COC1CCCCC1)C(C)C]

### Reference Example 3

### Synthesis of 1-tert-butoxy-2-cyclohexyl-3-methoxy-2-methoxymethylpropane

### (1) Synthesis of Cyclohexyl Diethyl Malonate

Diethyl malonate (37.8 mL, 250 mmol) and sodium ethoxide (17.0 g, 250 mmol) were dissolved in dry ethanol (71 mL), and was stirred for 30 minutes. Then, 7 mL of ethanol solution of bromocyclohexane (30.6 mL, 250 mmol) was dropped thereto. After completion of the dropping, the mixture was stirred for 5 days under reflux. The reaction solution was washed with water, and then the reactant was extracted therefrom with diethylether. The obtained ether extract was dried with anhydrous sodium sulfate, and was filtrated. After that, the solvent was distilled off, and distilled under reduced pressure (boiling point: 140 to 142° C./0.7 kPa) to obtain 9.75 g of cyclohexyl diethyl malonate (yield: 16%, purity: 99% (GC area percentage)).

¹H-NMR (400 MHz, CDCl₃) δ 1.05 (m, 2H), 1.16 (m, 1H), 1.28 (t, 6H), 1.29 (m, 3H), 1.72 (br, 4H), 2.10 (m, 1H), 3.14 (d, 1H), 4.19 (q, 4H).

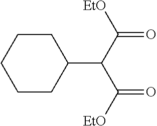 [SMILES: CCOC(=O)C(C(=O)OCC)C1CCCCC1]

### (2) Synthesis of diethyl 2-cyclohexyl-2-methoxymethylmalonate

Cyclohexyl diethyl malonate (7.00 g, 28.9 mmol) was dissolved in dry N,N-dimethylformamide (19 mL). Another flask was charged with 19 mL of N,N-dimethylformamide, and NaH (55% by weight, 1.89 g, 43.3 mmol) was dispersed therein. The above solution of cyclohexyl diethyl malonate was dropped into the dispersion liquid at 0° C. After completion of the dropping, the mixture was stirred at room temperature for 1 hour. Then, the mixture was cooled to 0° C., and chloromethyl methyl ether (3.26 mL, 43.3 mmol) was dropped thereto. After completion of the dropping, the mixture was stirred at room temperature for 3 hours. The reaction solution was washed with water, and then the reactant was extracted therefrom with diethylether. The obtained ether extract was dried with anhydrous sodium sulfate, and was filtrated. After that, the solvent was distilled off to obtain 8.68 g of diethyl 2-cyclohexyl-2-methoxymethylmalonate (yield: 74%, purity: 87% (GC area percentage)). ¹H-NMR (400 MHz, CDCl₃) δ 1.09 (m, 3H), 1.28 (t, 6H), 1.29 (m, 3H), 1.77 (br, 4H), 2.16 (m, 1H), 3.28 (s, 3H), 4.19 (q, 2H), 4.20 (q, 2H).

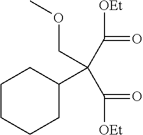 [SMILES: CCOC(=O)C(COC)(C(=O)OCC)C1CCCCC1]

### (3) Synthesis of 2-cyclohexyl-2-methoxymethyl-1,3-propanediol

The obtained diethyl 2-cyclohexyl-2-methoxymethylmalonate (8.00 g, 24.4 mmol, purity 87%) was dissolved in dry tetrahydrofuran (22 mL). Another flask was charged with the dry tetrahydrofuran (22 mL), and lithium aluminum hydride (1.80 g, 47.5 mmol) was dispersed therein. The above solution of diethyl 2-cyclohexyl-2-methoxymethylmalonate was dropped into the dispersion liquid at 0° C. After completion of the dropping, the mixture was stirred at room temperature for 1 hour. Then, an aqueous sodium hydroxide, water and sodium sulfate were dropped into the reaction solution, and then the obtained solution was filtrated over celite. After that, the solvent was distilled off, and the residue was purified with silica gel column chromatography (solvent: hexane/ethyl acetate/triethylamine=100/100/1) to obtain 8.68 g of 2-cyclohexyl-2-methoxymethyl-1,3-propanediol (yield: 64%, purity: 99% (GC area percentage)). ¹H-NMR (400 MHz, CDCl₃) δ 1.01 (m, 2H), 1.12 (m, 1H), 1.19 (m, 2H), 1.27 (m, 1H), 1.48 (m, 1H), 1.70 (br, 4H), 2.63 (br, 2H), 3.34 (s, 3H), 3.45 (s, 2H), 3.69 (d, 2H), 3.80 (d, 2H).

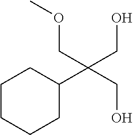

### (4) Synthesis of 5-cyclohexyl-5-methoxymethyl-2,2-dimethyl-1,3-dioxane

A 100 mL flask equipped with a stirrer was charged with 2-cyclohexyl-2-methoxymethyl-1,3-propanediol (3.12 g, 15.4 mmol), 2,2-dimethoxy propane (2.27 mL, 18.5 mmol), 0.29 g of p-toluenesulfonic acid and 18 mL of tetrahydrofuran, and then the mixture was stirred at room temperature for 1 hour. The obtained reaction mixture was neutralized with aqueous sodium hydrogen carbonate, and then the reactant was extracted therefrom with diethylether. The obtained ether extract was dried with anhydrous sodium sulfate, and was filtrated. Then, the solvent was distilled off to obtain 3.13 g of 5-cyclohexyl-5-methoxy methyl-2,2-dimethyl-1,3-dioxane (yield: 83%, purity: 99% (GC area percentage)).

¹H-NMR (400 MHz, CDCl₃) δ 1.09 (m, 2H), 1.15 (m, 2H), 1.39 (m, 1H), 1.38 (s, 3H), 1.40 (s, 3H), 1.65 (br, 3H), 1.75 (br, 2H), 3.34 (s, 3H), 3.45 (s, 2H), 3.63 (d, 2H), 3.74 (d, 2H).

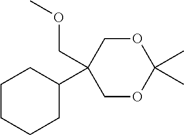 [SMILES: COCC1(C2CCCCC2)COC(C)(C)OC1]

### (5) Synthesis of 3-tert-butoxy-2-cyclohexyl-2-methoxymethyl-1-propanol

A flask equipped with a stirrer was charged with the obtained 5-cyclohexyl-5-methoxymethyl-2,2-dimethyl-1,3-dioxane (3.00 g, 12.4 mmol) and 17 mL of anhydrous toluene as a solvent, and then diethylether solution of MeMgI (3M, 6.19 mL, 18.6 mmol) was dropped thereto at room temperature. After completion of the dropping, 6 mL of the solvent was distilled off under a pressure of 500 kPa, at 40° C., the reaction solution was stirred for 1 hour at 100° C. Aqueous ammonium chloride was added to the reaction solution, and then the reactant was extracted therefrom with diethylether. The obtained ether extract was dried with anhydrous sodium sulfate, and was filtrated. Then, the solvent was distilled off to obtain 3.18 g of 3-tert-butoxy-2-cyclohexyl-2-methoxymethyl-1-propanol (yield: 98%, purity: 99% (GC area percentage)).

¹H-NMR (400 MHz, CDCl₃) δ 1.05 (m, 2H), 1.14 (m, 1H), 1.17 (s, 9H), 1.19 (m, 2H), 1.54 (m, 1H), 1.67 (br, 2H), 1.73 (br, 3H), 3.31 (s, 3H), 3.34 (dd, 1H), 3.41 (s, 2H), 3.45 (dd, 2H), 3.61 (dd, 1H), 3.69 (dd, 1H).

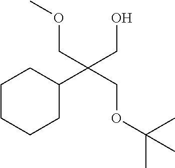 [SMILES: COCC(CO)(COC(C)(C)C)C1CCCCC1]

### (6) Synthesis of 1-tert-butoxy-2-cyclohexyl-3-methoxy-2-methoxymethylpropane

The obtained 3-tert-butoxy-2-cyclohexyl-2-methoxymethyl-1-propanol (3.08 g, 11.9 mmol) was dissolved in dry THF (13 mL). Another flask was charged with 13 mL of THF, and NaH (55% by weight, 0.68 g, 15.5 mmol) was dispersed therein. The above solution of 3-tert-butoxy-2-cyclohexyl-2-methoxymethyl-1-propanol was dropped into the dispersion liquid at 0° C. After completion of the dropping, the mixture was stirred at room temperature for 1 hour. Then, the mixture was cooled to 0° C., and methyl iodide (1.5 mL, 23.8 mmol) was dropped thereto. After completion of the dropping, the mixture was stirred at 35° C. for 1 hour. The reaction solution was washed with water, and then the reactant was extracted therefrom with diethylether. The obtained ether extract was dried with anhydrous sodium sulfate, and was filtrated. After that, the solvent was distilled off, and distilled under reduced pressure (boiling point: 137 to 139° C./0.7 kPa) to obtain 2.14 g of 1-tert-butoxy-2-cyclohexyl-3-methoxy-2-methoxymethyl propane (yield: 65%, purity: 99% (GC area percentage)). ¹H-NMR (400 MHz, CDCl₃) δ 1.14 (s, 9H), 1.19 (m, 5H), 1.41 (m, 1H), 1.63 (m, 1H), 1.71 (m, 4H), 3.23 (s, 2H), 3.29 (s, 6H), 3.30 (s, 2H), 3.31 (s, 2H).

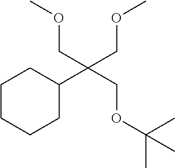 [SMILES: COCC(COC)(COC(C)(C)C)C1CCCCC1]

### Reference Example 4

### Synthesis of 2-cyclohexyl-2-cyclohexyloxymethyl-1,3-dimethoxypropane

### (1) Synthesis of 3-cyclohexyl-3-methoxymethyl-1,5-dioxaspiro[5.5]undecane

A 30 mL flask equipped with a stirrer was charged with 2-cyclohexyl-2-methoxymethyl-1,3-propanediol (1.00 g, 6.16 mmol) produced in the Reference Example 3 (3), and cyclohexanone (0.70 mL, 6.78 mmol), 0.12 g of p-toluenesulfonic acid and 5.0 mL of tetrahydrofuran, and then the mixture was stirred at room temperature for 2 hours. The obtained reaction mixture was neutralized with aqueous sodium hydrogen carbonate, and then the reactant was extracted therefrom with diethylether. The obtained ether extract was dried with anhydrous sodium sulfate, and was filtrated. Then, the solvent was distilled off to obtain 0.68 g of 3-cyclohexyl-3-methoxymethyl-1,5-dioxaspiro[5.5]undecane (yield: 99%, purity: 100% (GC area percentage)).

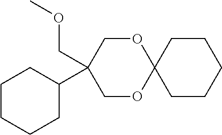 [SMILES: COCC1(C2CCCCC2)COC2(CCCCC2)OC1]

### (2) Synthesis of 2-cyclohexyl-3-cyclohexyloxy-2-methoxymethyl-1-propanol

A flask equipped with a stirrer was charged with LiAlH₄ (0.313 g, 8.25 mmol), AlCl₃ (0.369 g, 2.76 mmol) and 14 mL of anhydrous diethylether, and then the mixture was stirred at room temperature for 30 minutes. Then, 2 mL of anhydrous diethylether solution of the obtained 3-cyclohexyl-3-methoxymethyl-1,5-dioxaspiro[5.5]undecane (1.00 g, 4.13 mmol) was dropped, and the mixture was refluxed for 15 hours. Aqueous sodium hydroxide, water and sodium sulfate were added to the reaction solution, and then the obtained solution was filtrated over celite. After that, the solvent was distilled off, and the residue was purified with silica gel column chromatography (a solvent: hexane/ethyl acetate/triethylamine=100/20/1) to obtain 0.915 g of 2-cyclohexyl-3-cyclohexyloxy-2-methoxymethyl-1-propanol (yield: 91%, purity: 99% (GC area percentage)).

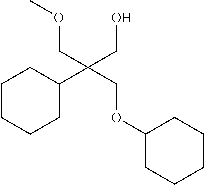 [SMILES: COCC(CO)(COC1CCCCC1)C1CCCCC1]

### (3) Synthesis of 2-cyclohexyl-2-cyclohexyloxymethyl-1,3-dimethoxypropane

The obtained 2-cyclohexyl-3-cyclohexyloxy-2-methoxymethyl-1-propanol (0.900 g, 3.16 mmol) was dissolved in dry THF (8 mL). Another flask was charged with 8 mL of THF, and NaH (55% by weight, 0.152 g, 6.33 mmol) was dispersed therein. The above solution of 2-cyclohexyl-3-cyclohexyloxy-2-methoxymethyl-1-propanol was dropped into the dispersion liquid at 0° C. After completion of the dropping, the mixture was stirred at room temperature for 1 hour. Then, the mixture was cooled to 0° C., and methyl iodide (0.66 mL, 9.49 mmol) was dropped thereto. After completion of the dropping, the mixture was stirred at 35° C. for 1 hour. The reaction solution was washed with water, and then the reactant was extracted therefrom with diethylether. The obtained ether extract was dried with anhydrous sodium sulfate, and was filtrated. After that, the solvent was distilled off, and the residue was purified with silica gel column chromatography (a solvent: hexane/ethyl acetate=10/1) to obtain 0.782 g of 2-cyclohexyl-2-cyclohexyloxymethyl-1,3-dimethoxypropane (yield: 81%, purity: 98% (GC area percentage)). ¹H-NMR (400 MHz, CDCl₃) δ 1.22 (m, 10H), 1.43 (m, 2H), 1.71 (br, 8H), 1.77 (m, 1H), 3.13 (m, 1H), 3.29 (s, 6H), 3.32 (s, 4H), 3.33 (s, 2H).

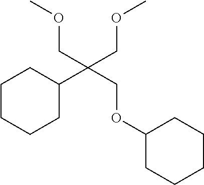 [SMILES: COCC(COC)(COC1CCCCC1)C1CCCCC1]

### Reference Example 5

### Synthesis of 2-cyclohexyl-2-cyclododecyloxymethyl-1,3-dimethoxypropane

### (1) Synthesis of 3-cyclohexyl-3-methoxymethyl-1,5-dioxaspiro[5.11]heptadecane

A 30 MmL flask equipped with a stirrer was charged with 2-cyclohexyl-2-methoxymethyl-1,3-propanediol (1.00 g, 4.94 mmol) produced in Reference Example 3 (3), cyclododecanone (1.08 g, 5.93 mmol), 0.12 g of p-toluenesulfonic acid and 6.0 mL of tetrahydrofuran, and then the mixture was stirred at room temperature for 7 hours. The obtained reaction mixture was neutralized with aqueous sodium hydrogen carbonate, and then the reactant was extracted therefrom with diethylether. The obtained ether extract was dried with anhydrous sodium sulfate, and was filtrated. Then, the solvent was distilled off to obtain 1.73 g of 3-cyclohexyl-3-methoxymethyl-1,5-dioxaspiro[5.11]heptadecane (yield: 47%, purity: 49% (GC area percentage)).

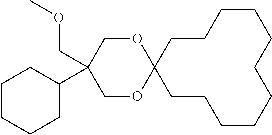 [SMILES: COCC1(C2CCCCC2)COC2(CCCCCCCCCCC2)OC1]

### (2) Synthesis of 2-cyclohexyl-3-cyclododecyloxy-2-methoxymethyl-1-propanol

A flask equipped with a stirrer was charged with LiAlH₄ (0.746 g, 19.6 mmol), AlCl₃ (0.871 g, 6.53 mmol) and 19 mL of anhydrous diethylether, and then the mixture was stirred at room temperature for 30 minutes. Then, 19 mL of anhydrous diethylether solution of the obtained 3-cyclohexyl-3-methoxymethyl-1,5-dioxaspiro[5.11]heptadecane (1.00 g, 4.13 mmol) was dropped, and the mixture was refluxed for 3 hours. Aqueous sodium hydroxide, water and sodium sulfate were added to the reaction solution, and then the obtained solution was filtrated over celite. After that, the solvent was distilled off, and the residue was purified with silica gel column chromatography (a solvent: hexane/ethyl acetate/triethylamine=100/5/1) to obtain 0.451 g of 2-cyclohexyl-3-cyclododecyloxy-2-methoxymethyl-1-propanol (yield: 53%, purity: 99% (GC area percentage)).

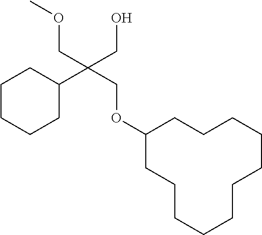 [SMILES: COCC(CO)(COC1CCCCCCCCCCC1)C1CCCCC1]

### (3) Synthesis of 2-cyclohexyl-2-cyclododecyloxymethyl-1,3-dimethoxypropane

The obtained 2-cyclohexyl-3-cyclododecyloxy-2-methoxymethyl-1-propanol (0.450 g, 1.22 mmol) was dissolved in dry THF (2 mL). Another flask was charged with 2 mL of THF, and NaH (55% by weight, 0.107 g, 2.44 mmol) was dispersed therein. The above solution of 2-cyclohexyl-3-cyclododecyloxy-2-methoxymethyl-1-propanol was dropped into the dispersion liquid at 0° C. After completion of the dropping, the mixture was stirred at 35° C. for 1 hour. Then, the mixture was cooled to 0° C., and methyl iodide (0.23 mL, 3.66 mmol) was dropped thereto. After completion of the dropping, the mixture was stirred at 35° C. for 1 hour. The reaction solution was washed with water, and then the reactant was extracted therefrom with diethylether. The obtained ether extract was dried with anhydrous sodium sulfate, and was filtrated. After that, the solvent was distilled off, and the residue was purified with silica gel column chromatography (a solvent: hexane/ethyl acetate=10/1) to obtain 0.443 g of 2-cyclohexyl-2-cyclododecyloxymethyl-1,3-dimethoxypropane (yield: 94%, purity: 99% (GC area percentage)). ¹H-NMR (400 MHz, CDCl₃) δ 1.16 (m, 6H), 1.35 (br, 18H), 1.41 (m, 4H), 1.53 (m, 2H), 1.62 (m, 1H), 1.70 (br, 4H), 3.13 (m, 1H), 3.29 (s, 6H), 3.31 (s, 6H).

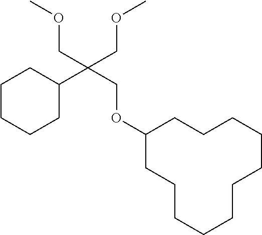 [SMILES: COCC(COC)(COC1CCCCCCCCCCC1)C1CCCCC1]

### Reference Example 6

### Synthesis of 1-tert-butoxy-2,2-bis(methoxymethyl)-3,3-dimethylbutane

### (1) Synthesis of diethyl 2-tert-butyl-2-methoxymethylmalonate

Tert-butyl diethyl malonate (10.0 g, 46.2 mmol) was dissolved in dry N,N-dimethylformamide (26 mL). Another flask was charged with 26 mL of N,N-dimethylformamide, and NaH (55% by weight, 4.03 g, 92.4 mmol) was dispersed therein. The above solution of tert-butyl diethyl malonate was dropped into the dispersion liquid at 0° C. After completion of the dropping, the mixture was stirred at room temperature for 1 hour. Then, the mixture was cooled to 0° C., and chloromethyl methyl ether (5.22 mL, 69.4 mmol) was dropped thereto. After completion of the dropping, the mixture was stirred at room temperature for 4 hours. The reaction solution was washed with water, and the reactant was extracted therefrom with diethylether. The obtained ether extract was dried with anhydrous sodium sulfate, and was filtrated. After that, the solvent was distilled off, and distilled under reduced pressure (boiling point: 100 to 101° C./0.60 kPa) to obtain 9.52 g of diethyl 2-tert-butyl-2-methoxymethylmalonate (yield: 74%, purity: 93% (GC area percentage)). ¹H-NMR (400 MHz, CDCl₃) δ 1.14 (t, 9H), 1.27 (t, 6H), 3.31 (s, 3H), 3.84 (s, 2H), 4.20 (q, 4H).

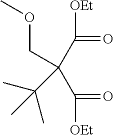 [SMILES: CCOC(=O)C(COC)(C(=O)OCC)C(C)(C)C]

### (2) Synthesis of 2-hydroxymethyl-2-methoxymethyl-3,3-dimethyl-1-butanol

The obtained diethyl

2-tert-butyl-2-methoxymethylmalonate (9.00 g, 34.6 mmol) was dissolved in dry diethylether (32 mL). Another flask was charged with 32 mL of dried diethylether, and lithium aluminum hydride (2.62 g, 69.1 mmol) was dispersed therein. The above solution of diethyl 2-tert-butyl-2-methoxymethylmalonate was dropped into the dispersion liquid at 0° C. After completion of the dropping, the mixture was stirred at room temperature for 1 hour. Aqueous sodium hydroxide, water and sodium sulfate were added to the reaction solution, and then the obtained solution was filtrated over celite. After that, the solvent was distilled off to obtain 5.81 g of 2-hydroxymethyl-2-methoxymethyl-3,3-dimethyl-1-butanol (yield: 91%, purity: 95% (GC area percentage))). ¹H-NMR (400 MHz, CDCl₃) δ 0.90 (s, 9H), 3.03 (dd, 2H), 3.37 (s, 3H), 3.48 (s, 2H), 3.77-3.90 (m, 4H).

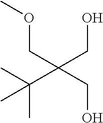

### (3) Synthesis of 5-tert-butyl-5-methoxymethyl-2,2-dimethyl-1,3-dioxane

A 100 mL flask equipped with a stirrer was charged with 2-hydroxymethyl-2-methoxymethyl-3,3-1-butanol (4.50 g, 25.5 mmol), 2,2-dimethoxypropane (3.75 mL, 30.6 mmol), 0.49 g of p-toluenesulfonic acid and 24 mL of N,N-dimethylformamide, and then the mixture was stirred at room temperature for 2 hours. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 4.79 g of 5-tert-butyl-5-methoxymethyl-2,2-dimethyl-1,3-dioxane (yield: 82%, purity: 95% (GC area percentage)).

¹H-NMR (400 MHz, CDCl₃) δ 0.93 (s, 9H), 1.36 (s, 3H), 1.39 (s, 3H), 3.32 (s, 3H), 3.50 (d, 2H), 3.52 (s, 2H), 3.81 (d, 2H).

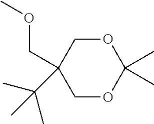

### (4) Synthesis of 2-tert-butoxymethyl-2-methoxymethyl-3,3-dimethyl-1-butanol

A flask equipped with a stirrer was charged with the obtained 5-tert-butyl-5-methoxymethyl-2,2-dimethyl-1,3-dioxane (4.50 g, 20.8 mmol) and 26 mL of anhydrous toluene as a solvent, and then diethylether solution of MeMgI (3M, 10.48 mL, 31.2 mmol) was dropped thereto at room temperature. After completion of the dropping, 4 mL of the solvent was distilled off under a pressure of 500 kPa at 40° C., the reaction solution was stirred for 1 hour at 100° C. Aqueous ammonium chloride was added to the reaction solution, and the reactant was extracted therefrom with diethylether. The obtained ether extract was dried with anhydrous sodium sulfate, and was filtrated. Then, the solvent was distilled off, and the residue was purified with silica gel column chromatography (a solvent: hexane/ethyl acetate=⅕)) to obtain 3.56 g of 2-tert-butoxymethyl-2-methoxymethyl-3,3-dimethyl-1-butanol (yield: 73%, purity: 99% (GC area percentage)).

¹H-NMR (400 MHz, CDCl₃) δ 0.93 (s, 9H), 1.20 (s, 9H), 3.31 (s, 3H), 3.33 (dd, 1H), 3.52 (ddd, 2H), 3.54 (s, 2H), 3.64 (dd, 1H), 3.71 (dd, 1H).

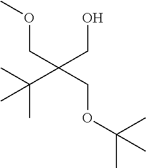 [SMILES: COCC(CO)(COC(C)(C)C)C(C)(C)C]

### (5) Synthesis of 1-tert-butoxy-2,2-bis(methoxymethyl)-3,3-dimethyl butane

The obtained 2-tert-butoxymethyl-2-methoxymethyl-3,3-dimethyl-1-butanol (3.00 g, 12.9 mmol) was dissolved in dry THF (13 mL). Another flask was charged with 13 mL of THF, and NaH (55% by weight, 0.85 g, 19.4 mmol) was dispersed therein. The above solution of 2-tert-butoxymethyl-2-methoxymethyl-3,3-dimethyl-1-butanol was dropped into the dispersion liquid at 0° C. After completion of the dropping, the mixture was stirred at room temperature for 1 hour. And then, the mixture was cooled to 0° C., and methyl iodide (1.6 mL, 25.8 mmol) was dropped thereto. After completion of the dropping, the mixture was stirred at 35° C. for 1 hour. The reaction solution was washed with water, and the reactant was extracted therefrom with diethylether. The obtained ether extract was dried with anhydrous sodium sulfate, and was filtrated. After that, the solvent was distilled off, and distilled under reduced pressure (boiling point: 85 to 86° C./1.0 kPa) to obtain 1.98 g of 1-tert-butoxy-2,2-bis(methoxymethyl)-3,3-dimethylbutane (yield: 62%, purity: 99% (GC area percentage)). ¹H-NMR (400 MHz, CDCl₃) δ 1.00 (s, 9H), 1.14 (s, 9H), 3.27 (s, 6H), 3.36 (s, 2H), 3.38 (s, 2H), 3.39 (s, 2H).

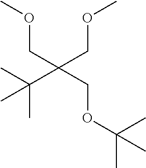 [SMILES: COCC(COC)(COC(C)(C)C)C(C)(C)C]

### Reference Example 7

### Synthesis of 1-cyclohexyloxy-2,2-bis(methoxymethyl)-3,3-dimethylbutane

### (1) Synthesis of 3-tert-butyl-3-methoxymethyl-1,5-dioxaspiro[5.5]undecane

A 100 mL flask equipped with a stirrer was charged with 2-hydroxymethyl-2-methoxymethyl-3,3-dimethyl-1-butanol (2.00 g, 11.4 mmol) produced in the Reference Example 6 (2), cyclohexanone (1.23 mL, 11.9 mmol), 0.42 g of p-toluenesulfonic acid and 11 mL of tetrahydrofuran, and then the mixture was stirred at 50° C. for 3 hours. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 2.89 g of 3-tert-butyl-3-methoxymethyl-1,5-dioxaspiro[5.5]undecane (yield: 94%, purity: 95% (GC area percentage)).

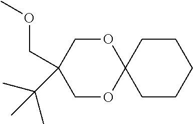 [SMILES: COCC1(C(C)(C)C)COC2(CCCCC2)OC1]

### (2) Synthesis of 2-cyclohexyloxymethyl-2-methoxymethyl-3,3-dimethyl-1-butanol

A flask equipped with a stirrer was charged with LiAlH₄ (0.355 g, 9.36 mmol), AlCl₃ (0.412 g, 3.14 mmol) and 17 mL of anhydrous diethylether, and then the mixture was stirred at room temperature for 30 minutes. Then, 2 mL of anhydrous diethylether solution of the obtained 3-tert-butyl-3-methoxymethyl-1,5-dioxaspiro[5.5]undecane (1.20 g, 4.68 mmol) was dropped, and the mixture was refluxed for 19 hours. Aqueous sodium hydroxide, water and sodium sulfate were added to the reaction solution, and then the obtained solution was filtrated over celite. After that, the solvent was distilled off, and the residue was purified with silica gel column chromatography (a solvent: hexane/ethyl acetate/triethylamine=100/20/1) to obtain 0.601 g of 2-cyclohexyloxymethyl-2-methoxymethyl-3,3-dimethyl-1-butano 1 (yield: 50%, purity: 99% (GC area percentage)).

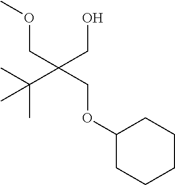 [SMILES: COCC(CO)(COC1CCCCC1)C(C)(C)C]

### (3) Synthesis of 1-cyclohexyloxy-2,2-bis(methoxymethyl)-3,3-dimethylbutane

The obtained 2-cyclohexyloxymethyl-2-methoxymethyl-3,3-dimethyl-1-butano 1 (0.600 g, 2.32 mmol) was dissolved in dry THF (5 mL). Another flask was charged with 5 mL of THF, and NaH (55% by weight, 0.203 g, 4.64 mmol) was dispersed therein. The above solution of 2-cyclohexyloxymethyl-2-methoxymethyl-3,3-dimethyl-1-butanol was dropped into the dispersion liquid at 0° C. After completion of the dropping, the mixture was stirred at room temperature for 1 hour. And then, the mixture was cooled to 0° C., and methyl iodide (0.4 mL, 6.97 mmol) was dropped thereto. After completion of the dropping, the mixture was stirred at 35° C. for 1 hour. The reaction solution was washed with water, and the reactant was extracted therefrom with diethylether. The obtained ether extract was dried with anhydrous sodium sulfate, and was filtrated. After that, the solvent was distilled off, and the residue was purified with silica gel column chromatography (a solvent: hexane/ethyl acetate/triethylamine ˜100/10/1) to obtain 0.522 g of 1-cyclohexyloxy-2,2-bis(methoxymethyl)-3,3-dimethylbutane (yield: 82%, purity: 99% (GC area percentage)). ¹H-NMR (400 MHz, CDCl₃) δ 1.00 (s, 9H), 1.27 (br, 5H), 1.35 (br, 1H), 1.68 (br, 2H), 1.78 (br, 2H), 3.15 (m, 1H), 3.27 (s, 6H), 3.400 (s, 2H), 3.403 (s, 2H), 3.44 (s, 2H).

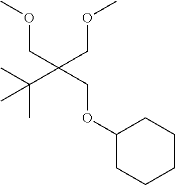 [SMILES: COCC(COC)(COC1CCCCC1)C(C)(C)C]

### Reference Example 8

### Synthesis of 2,2-bis(methoxymethyl)-3,3-dimethyl-1-(1-methylcyclohexyl) oxybutane

### (1) Synthesis of 2-methoxymethyl-3,3-dimethyl-2-(1-methylcyclohexyloxymethyl)-1-butanol

A flask equipped with a stirrer was charged with the obtained 3-tert-butyl-3-methoxymethyl-1,5-dioxaspiro[5.5]undecane (1.00 g, 3.90 mmol) obtained in the Reference Example 7 (1) and 6 mL of anhydrous toluene as a solvent, and then diethylether solution of MeMgI (3M, 1.95 mL, 5.85 mmol) was dropped thereto at room temperature. After completion of the dropping, 2 mL of the solvent was distilled off under a pressure of 500 kPa at 40° C., the reaction solution was stirred for 1 hour at 100° C. Aqueous ammonium chloride was added to the reaction solution, and the reactant was extracted therefrom with diethylether. The obtained ether extract was dried with anhydrous sodium sulfate, and was filtrated. Then, the solvent was distilled off to obtain 1.12 g of 2-methoxymethyl-3,3-dimethyl-2-(1-methylcyclohexyloxymethyl)-1-butanol (yield: 99%, purity: 98% (GC area percentage)).

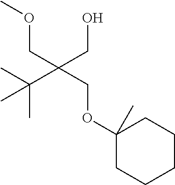 [SMILES: COCC(CO)(COC1(C)CCCCC1)C(C)(C)C]

### (2) Synthesis of 2,2-bis(methoxymethyl)-3,3-dimethyl-1-(1-methylcyclohexyl)oxybutane

The obtained 2-methoxymethyl-3,3-dimethyl-2-(1-methylcyclohexyloxymethyl)-1-butanol (1.00 g, 3.67 mmol) was dissolved in dry THF (8 mL). Another flask was charged with 8 mL of THF, and NaH (55% by weight, 0.240 g, 5.51 mmol) was dispersed therein. The above solution of 2-methoxymethyl-3,3-dimethyl-2-(1-methylcyclohexyloxymethyl)-1-butanol was dropped into the dispersion liquid at 0° C. After completion of the dropping, the mixture was stirred at room temperature for 1 hour. And then, the mixture was cooled to 0° C., andmethyl iodide (0.46 mL, 7.34 mmol) was dropped thereto. After completion of the dropping, the mixture was stirred at 35° C. for 1 hour. The reaction solution was washed with water, and the reactant was extracted therefrom with diethylether. The obtained ether extract was dried with anhydrous sodium sulfate, and was filtrated. After that, the solvent was distilled off and the residue was purified with silica gel column (a solvent: hexane/ethyl acetate=10/1) to obtain 0.89 g of 2,2-bis(methoxymethyl)-3,3-dimethyl-1-(1-methylcyclohexyl) oxybutane (yield: 80%, purity: 97% (GC area percentage)).

¹H-NMR (400 MHz, CDCl₃) δ 1.02 (s, 9H), 1.16 (s, 3H), 1.27 (br, 3H), 1.39 (br, 2H), 1.51 (br, 3H), 1.72 (br, 2H), 3.27 (s, 6H), 3.32 (s, 2H), 3.40 (s, 4H).

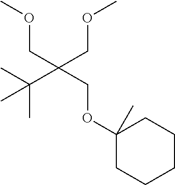 [SMILES: COCC(COC)(COC1(C)CCCCC1)C(C)(C)C]

### Reference Example 9

### Synthesis of 2,2-bis(methoxymethyl)-3,3-dimethyl-1-thexyloxybutane

### (1) Synthesis of 5-tert-butyl-2-isopropyl-5-methoxymethyl-2-methyl-1,3-dioxane

A 30 mL flask equipped with a stirrer was charged with 2-hydroxymethyl-2-methoxymethyl-3,3-dimethyl-1-butanol (1.00 g, 5.67 mmol) produced in Reference Example 6 (2), 3-methyl-2-butanone (2.7 mL, 24.9 mmol), 1.25 g of molecular sieve 3A, and 0.22 g of p-toluenesulfonic acid as a catalyst and 6 mL of tetrahydrofuran as a solvent, and then the mixture was stirred for 2 hours at room temperature. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 1.39 g of 5-tert-butyl-2-isopropyl-5-methoxymethyl-2-methyl-1,3-dioxane (yield: 93%, purity: 93% (GC area percentage)).

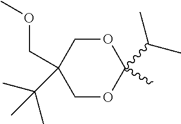

### (2) Synthesis of 2-methoxymethyl-3,3-dimethyl-2-thexyloxymethyl-1-butanol

A flask equipped with a stirrer was charged with the obtained 5-tert-butyl-2-isopropyl-5-methoxymethyl-2-methyl-1,3-dioxane (1.00 g, 4.09 mmol) and 6 mL of anhydrous toluene as a solvent, and then diethylether solution of MeMgI (3M, 2.05 mL, 6.14 mmol) was dropped thereto at room temperature. After completion of the dropping, 2 mL of the solvent was distilled off under a pressure of 500 kPa, at 40° C., the reaction solution was stirred for 1 hour at 100° C. Aqueous ammonium chloride was added to the reaction solution, and the reactant was extracted therefrom with diethylether. The obtained ether extract was dried with anhydrous sodium sulfate, and was filtrated. Then, the solvent was distilled off and the residue was purified with silica gel column (a solvent: hexane/ethyl acetate/triethylamine=100/20/1) to obtain 0.822 g of 2-methoxymethyl-3,3-dimethyl-2-thexyloxymethyl-1-butanol (yield: 75%, purity: 97% (GC area percentage)).

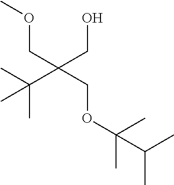 [SMILES: COCC(CO)(COC(C)(C)C(C)C)C(C)(C)C]

### (3) Synthesis of 2,2-bis(methoxymethyl)-3,3-dimethyl-1-thexyloxybutane

The obtained

2-methoxymethyl-3,3-dimethyl-2-thexyloxymethyl-1-butanol (0.780 g, 3.00 mmol) was dissolved in dry THF (7 mL). Another flask was charged with 7 mL of THF, and NaH (55% by weight, 0.196 g, 4.49 mmol) was dispersed therein. The above solution of 2-methoxymethyl-3,3-dimethyl-2-thexyloxymethyl-1-butanol was dropped into the dispersion liquid at 0° C. After completion of the dropping, the mixture was stirred at room temperature for 1 hour. And then, the mixture was cooled to 0° C., and methyl iodide (0.37 mL, 5.99 mmol) was dropped thereto. After completion of the dropping, the mixture was stirred at 35° C. for 1 hour. The reaction solution was washed with water, and the reactant was extracted therefrom with diethylether. The obtained ether extract was dried with anhydrous sodium sulfate, and was filtrated. After that, the solvent was distilled off and the residue was purified with silica gel column (a solvent: hexane/ethyl acetate/triethylamine=100/10/1) to obtain 0.658 g of 2,2-bis(methoxymethyl)-3,3-dimethyl-1-thexyloxybutane (yield: 80%, purity: 99% (GC area percentage))). ¹H-NMR (400 MHz, CDCl₃) δ 0.87 (d, 6H), 1.05 (s, 6H), 1.72 (sep, 1H), 3.26 (s, 6H), 3.35 (s, 2H), 3.38 (s, 4H).

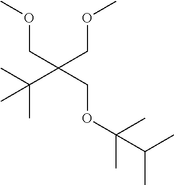 [SMILES: COCC(COC)(COC(C)(C)C(C)C)C(C)(C)C]

### Reference Example 10

### Synthesis of 1-tert-butoxy-2,2-bis(methoxymethyl)-3,3,4-trimethylpentane

### (1) Synthesis of Thexyl Diethyl Malonate

A flask equipped with a stirrer was charged with isopropylidene diethyl malonate (18.0 g, 89.9 mmol), copper (I) iodide (1.71 g, 8.99 mmol), trimethylsilyl chloride (13.7 mL, 108 mmol), 245 mL of dry tetrahydrofuran. Then, the mixture was cooled to −10° C., isopropyl magnesium chloride-lithium chloride complex (83.0 mL, 1.30M, 108 mmol) was dropped thereto. After completion of the dropping, the mixture was stirred at −10° C. for 2 hours. The reaction solution was washed with water, and the reactant was extracted therefrom with diethylether. The obtained ether extract was dried with anhydrous sodium sulfate, and was filtrated. After that, the solvent was distilled off, and distilled under reduced pressure (boiling point: 125 to 127° C./0.71 kPa) to obtain 17.1 g of thexyl diethyl malonate (yield: 73%, purity: 94% (GC area percentage)). ¹H-NMR (400 MHz, CDCl₃) δ 0.87 (d, 6H), 1.04 (s, 6H), 1.26 (t, 6H), 1.83 (sep, 1H), 3.51 (s, 1H), 4.17 (q, 4H).

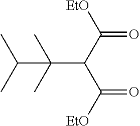 [SMILES: CCOC(=O)C(C(=O)OCC)C(C)(C)C(C)C]

### (2) Synthesis of diethyl 2-methoxymethyl-2-thexylmalonate

Thexyl diethyl malonate (11.9 g, 45.8 mmol, purity: 92%) was dissolved in dry N,N-dimethylformamide (30 mL). Another flask was charged with 30 mL of N,N-dimethylformamide, and NaH (55% by weight, 4.00 g, 91.7 mmol) was dispersed therein. The above solution of thexyl diethyl malonate was dropped into the dispersion liquid at 0° C. After completion of the dropping, the mixture was stirred at room temperature for 1 hour. Then, the mixture was cooled to 0° C., and chloromethyl methyl ether (6.90 mL, 91.7 mmol) was dropped thereto. After completion of the dropping, the mixture was stirred at room temperature for 4 hours. The reaction solution was washed with water, and the reactant was extracted therefrom with diethylether. The obtained ether extract was dried with anhydrous sodium sulfate, and was filtrated. After that, the solvent was distilled off, and distilled under reduced pressure (boiling point: 158 to 161° C./0.7 kPa) to obtain 11.7 g of diethyl 2-methoxymethyl-2-thexylmalonate (yield: 53%, purity: 60% (GC area percentage)) ¹H-NMR (400 MHz, CDCl₃) δ 0.84 (d, 6H), 1.10 (s, 6H), 1.28 (t, 6H), 2.01 (sep, 1H), 3.16 (s, 3H), 3.91 (s, 2H), 4.20 (q, 4H).

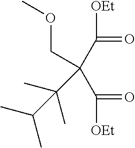 [SMILES: CCOC(=O)C(COC)(C(=O)OCC)C(C)(C)C(C)C]

### (3) Synthesis of 2-hydroxymethyl-2-methoxymethyl-3,3,4-trimethyl-1-pentanol

The obtained diethyl 2-methoxymethyl-2-thexylmalonate (7.30 g, 25.3 mmol, purity 60%) was dissolved in dry tetrahydrofuran (20 mL). Another flask was charged with 20 mL of tetrahydrofuran, and lithium aluminum hydride (1.63 g, 43.0 mmol) was dispersed therein. The above solution of diethyl 2-methoxymethyl-2-thexylmalonate was dropped into the dispersion liquid at 0° C. After completion of the dropping, the mixture was stirred at room temperature for 1 hour. Aqueous sodium hydroxide, water and sodium sulfate were added to the reaction solution, and then the obtained solution was filtrated over celite. After that, the solvent was distilled off and the residue was purified with silica gel column (a solvent: hexane/ethyl acetate=1/1) to obtain 2-hydroxymethyl-2-methoxymethyl-3,3,4-trimethyl-1-pentanol (yield: 75%, purity: 98% (GC areapercentage)). ¹H-NMR (400 MHz, CDCl₃) δ 0.81 (s, 6H), 0.90 (d, 6H), 1.80 (sep, 1H), 3.02 (br, 2H), 3.35 (s, 3H), 3.54 (s, 2H), 3.89 (dd, 2H).

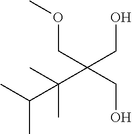

### (4) Synthesis of 5-methoxymethyl-2,2-dimethyl-5-thexyl-1,3-dioxane

A 30 mL flask equipped with a stirrer was charged with the obtained 2-hydroxymethyl-2-methoxymethyl-3,3,4-trimethyl-1-pentanol (1.50 g, 7.34 mmol, purity 98%), 2,2-dimethoxypropane (1.08 mL, 8.81 mmol), 0.14 g of p-toluenesulfonic acid, and 8 mL of tetrahydrofuran, and then the mixture was stirred at room temperature for 3 hours. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 1.58 g of 5-methoxymethyl-2,2-dimethyl-5-thexyl-1,3-dioxane (yield: 86%, purity: 96% (GC area percentage)).

¹H-NMR (400 MHz, CDCl₃) δ 0.86 (s, 6H), 0.88 (d, 6H), 1.34 (s, 3H), 1.39 (s, 3H), 1.86 (sep, 1H), 3.31 (s, 3H), 3.53 (d, 2H), 3.60 (s, 2H), 3.86 (d, 2H).

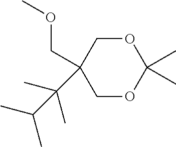 [SMILES: COCC1(C(C)(C)C(C)C)COC(C)(C)OC1]

### (5) Synthesis of 2-tert-butoxymethyl-2-methoxymethyl-3,3,4-trimethyl-1-pentanol

A flask equipped with a stirrer was charged with the obtained 5-methoxymethyl-2,2-dimethyl-5-thexyl-1,3-dioxane (1.75 g, 7.16 mmol, purity 96%) and 7 mL of anhydrous toluene as a solvent, and then diethylether solution of MeMgI (3M, 3.58 mL, 10.7 mmol) was dropped thereto at room temperature. After completion of the dropping, 4 mL of the solvent was distilled off under a pressure of 500 kPa, at 40° C., the reaction solution was stirred for 1 hour at 100° C. Aqueous ammonium chloride was added to the reaction solution, and the reactant was extracted therefrom with diethylether. The obtained ether extract was dried with anhydrous sodium sulfate, and was filtrated. Then, the solvent was distilled off to obtain 1.56 g of 2-tert-butoxymethyl-2-methoxymethyl-3,3,4-trimethyl-1-pentanol (yield: 85%, purity: 97% of (GC area percentage)).

¹H-NMR (400 MHz, CDCl₃) δ 0.84 (s, 6H), 0.88 (d, 3H), 0.90 (d, 3H), 1.20 (s, 9H), 1.96 (sep, 1H), 3.30 (s, 3H), 3.44 (dd, 1H), 3.55 (dd, 2H), 3.61 (dd, 2H), 3.69 (dd, 1H), 3.78 (dd, 1H).

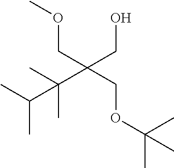 [SMILES: COCC(CO)(COC(C)(C)C)C(C)(C)C(C)C]

### (6) Synthesis of 1-tert-butoxy-2,2-bis(methoxymethyl)-3,3,4-trimethylpentane

The obtained 2-tert-butoxymethyl-2-methoxymethyl-3,3,4-trimethyl-1-penta nol (1.31 g, 5.04 mmol) was dissolved in dry THF (5.5 mL). Another flask was charged with 5.5 mL of THF, and NaH (55% by weight, 0.29 g, 6.56 mmol) was dispersed therein. The above solution of 1-tert-butoxymethyl-2-methoxymethyl-3,3,4-trimethyl-1-penta nol was dropped into the dispersion liquid at 0° C. After completion of the dropping, the mixture was stirred at 35° C. for 1 hour. Then, the mixture was cooled to 0° C., and methyl iodide (0.63 mL, 10.1 mmol) was dropped thereto. After completion of the dropping, the mixture was stirred at 35° C. for 1.5 hours. The reaction solution was washed with water, and the reactant was extracted therefrom with diethylether. The obtained ether extract was dried with anhydrous sodium sulfate, and was filtrated. After that, the solvent was distilled off, and distilled under reduced pressure (boiling point: 135 to 137° C./0.75 kPa) to obtain 0.76 g of 1-tert-butoxy-2,2-bis(methoxymethyl)-3,3,4-trimethyl pentane (yield: 55%, purity: 99% (GC area percentage))). ¹H-NMR (400 MHz, CDCl₃) δ 0.87 (d, 6H), 0.90 (s, 6H), 1.14 (s, 9H), 2.16 (seq, 1H), 3.22 (s, 6H), 3.40 (s, 2H), 3.43 (s, 4H).

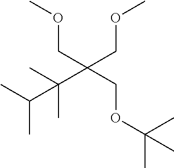 [SMILES: COCC(COC)(COC(C)(C)C)C(C)(C)C(C)C]

### Reference Example 11

### Synthesis of 2-cyclobutoxymethyl-2-cyclohexyl-1,3-dimethoxypropane

### (1) Synthesis of 3-cyclohexyl-3-methoxymethyl-1,5-dioxaspiro[3.5]nonane

A 30 mL flask equipped with a stirrer was charged with 2-cyclohexyl-2-methoxymethyl-1,3-propanediol (0.800 g, 3.95 mmol) produced in Reference Example 3 (3), cyclobutanone (0.421 g, 5.93 mmol), 0.0752 g of p-toluenesulfonic acid and 4.5 mL of tetrahydrofuran, and then the mixture was stirred at room temperature for 7 hours. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 0.785 g of 3-cyclohexyl-3-methoxymethyl-1,5-dioxaspiro[3.5]nonane (yield: 78%, purity: 92% of (GC area percentage)).

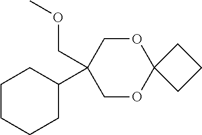 [SMILES: COCC1(C2CCCCC2)COC2(CCC2)OC1]

### (2) Synthesis of 3-cyclobutoxy-2-cyclohexyl-2-methoxymethyl-1-propanol

A flask equipped with a stirrer was charged with LiAlH₄ (0.368 g, 9.66 mmol), AlCl₃ (0.430 g, 3.22 mmol) and 14 mL of anhydrous diethylether, and then the mixture was stirred at room temperature for 30 minutes. Then, 19 mL of anhydrous diethylether solution of the obtained 3-cyclohexyl-3-methoxymethyl-1,5-dioxaspiro[3.5]nonane (0.780 g, 2.51 mmol) was dropped, and the mixture was refluxed for 6 hours. Aqueous sodium hydroxide, water and sodium sulfate were added to the reaction solution, and then the obtained solution was filtrated over celite. After that, the solvent was distilled off, and the residue was purified with silica gel column chromatography (a solvent: hexane/ethyl acetate/triethylamine=100/5/1) to obtain 0.451 g of 3-cyclobutoxy-2-cyclohexyl-2-methoxymethyl-1-propanol (yield: 58%, purity: 99% (GC area percentage)).

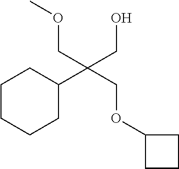 [SMILES: COCC(CO)(COC1CCC1)C1CCCCC1]

### (3) Synthesis of 2-cyclobutoxymethyl-2-cyclohexyl-1,3-dimethoxypropane

The obtained 3-cyclobutoxy-2-cyclohexyl-2-methoxymethyl-1-propanol (0.450 g, 1.76 mmol) was dissolved in dry THF (2 mL). Another flask was charged with 2 mL of THF, and NaH (55% by weight, 0.0842 g, 3.51 mmol) was dispersed therein. The above solution of 3-cyclobutoxy-2-cyclohexyl-2-methoxymethyl-1-propanol was dropped into the dispersion liquid at 0° C. After completion of the dropping, the mixture was stirred at 35° C. for 1 hour. Then, the mixture was cooled to 0° C., and methyl iodide (0.23 mL, 3.66 mmol) was dropped thereto. After completion of the dropping, the mixture was stirred at 35° C. for 1 hour. The reaction solution was washed with water, and the reactant was extracted therefrom with diethylether. The obtained ether extract was dried with anhydrous sodium sulfate, and was filtrated. After that, the solvent was distilled off, and the residue was purified with silica gel column chromatography (a solvent: hexane/ethyl acetate=10/1) to obtain 0.421 g of 2-cyclobutoxymethyl-2-cyclohexyl-1,3-dimethoxypropane (yield: 89%, purity: 99% (GC area percentage))). ¹H-NMR (400 MHz, CDCl₃) δ 1.16 (m, 5H), 1.45 (m, 2H), 1.64 (m, 2H), 1.70 (br, 4H), 1.86 (m, 2H), 2.16 (m, 2H), 3.21 (s, 2H), 3.29 (s, 6H), 3.31 (s, 4H), 3.82 (m, 1H).

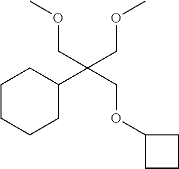 [SMILES: COCC(COC)(COC1CCC1)C1CCCCC1]

### Reference Example 12

### Synthesis of 2-(2-adamantyloxymethyl)-2-cyclohexyl-1,3-dimethoxypropane

### (1) Synthesis of spiro[(5-cyclohexyl-5-methoxymethyl-1,3-dioxane)-2,2′-tricyclo[3.3.1.1^{3,7}]decane]

A 30 mL flask equipped with a stirrer was charged with 2-cyclohexyl-2-methoxymethyl-1,3-propanediol (0.800 g, 3.95 mmol) produced in Reference Example 3 (3), 2-adamantanone (0.650 g, 5.93 mmol), 0.15 g of p-toluenesulfonic acid and 5. OmL of tetrahydrofuran, and then the mixture was stirred at room temperature for 2 hours. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 1.53 g of spiro[(5-cyclohexyl-5-methoxymethyl-1,3-dioxane)-2,2′-tricyclo[3.3.1.1^{3,7}]decane] (yield: 95%, purity: 82% (GC area percentage)).

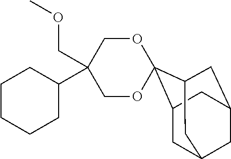 [SMILES: COCC1(C2CCCCC2)COC2(OC1)C1CC3CC(C1)CC2C3]

### Synthesis of 3-(2-adamantyloxy)-2-cyclohexyl-2-methoxymethyl-1-propanol

A flask equipped with a stirrer was charged with LiAlH₄ (0.900 g, 23.7 mmol), AlCl₃ (1.05 g, 7.88 mmol) and 19 mL of anhydrous diethylether, and then the mixture was stirred at room temperature for 30 minutes. Then, 19 mL of anhydrous diethylether solution of the obtained spiro[(5-cyclohexyl-5-methoxymethyl-1,3-dioxane)-2,2′-tricyclo[3.3.1.1^{3,7}]decane] (1.32 g, 3.95 mmol) was dropped, and the mixture was refluxed for 75 hours. Aqueous sodium hydroxide, water and sodium sulfate were added to the reaction solution, and then the obtained solution was filtrated over celite. After that, the solvent was distilled off, and the residue was purified with silica gel column chromatography (a solvent: hexane/ethyl acetate/triethylamine=100/5/1) to obtain 0.609 g of 3-(2-adamantyloxy)-2-cyclohexyl-2-methoxymethyl-1-propanol (yield: 45%, purity: 97% (GC area percentage)).

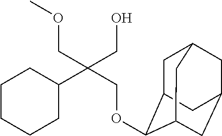 [SMILES: COCC(CO)(COC1C2CC3CC(C2)CC1C3)C1CCCCC1]

### (3) Synthesis of 2-(2-adamantyloxymethyl)-2-cyclohexyl-1,3-dimethoxypropane

The obtained 3-(2-adamantyloxy)-2-cyclohexyl-2-methoxymethyl-1-propanol (0.590 g, 1.75 mmol) was dissolved in dry THF (2.5 mL). Another flask was charged with 2.5 mL of THF, and NaH (55% by weight, 0.0842 g, 3.51 mmol) was dispersed therein. The above solution of 3-(2-adamantyloxy)-2-cyclohexyl-2-methoxymethyl-1-propanol was dropped into the dispersion liquid at 0° C. After completion of the dropping, the mixture was stirred at 35° C. for 1 hour. Then, the mixture was cooled to 0° C., and methyl iodide (0.33 mL, 5.26 mmol) was dropped thereto. After completion of the dropping, the mixture was stirred at 35° C. for 1 hour. The reaction solution was washed with water, and the reactant was extracted therefrom with diethylether. The obtained ether extract was dried with anhydrous sodium sulfate, and was filtrated. After that, the solvent was distilled off, and the residue was purified with silica gel column chromatography (a solvent: hexane/ethyl acetate=10/1) to obtain 0.592 g of 2-(2-adamantyloxymethyl)-2-cyclohexyl-1,3-dimethoxypropane (yield: 91%, purity: 98% (GC area percentage))). ¹H-NMR (400 MHz, CDCl₃) δ 1.20 (m, 5H), 1.45 (br, 3H), 1.63 (br, 3H), 1.75 (br, 6H), 1.79 (br, 4H), 2.01 (br, 4H), 3.29 (s, 6H), 3.32 (s, 2H), 3.35 (s, 4H), 3.74 (m, 1H).

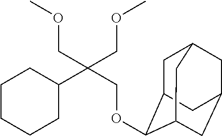 [SMILES: COCC(COC)(COC1C2CC3CC(C2)CC1C3)C1CCCCC1]

### Comparative Reference Example 1

### Synthesis of 1-methoxy-2,2-bis(methoxymethyl)butane

Trimethylolpropane (20.0 g, 145 mmol) was dissolved in dry THF (123 mL). Another flask was charged with 123 mL of THF, and NaH (60% by weight, 19.7 g, 491 mmol) was dispersed therein. The above solution of trimethylolpropane was dropped into the dispersion liquid at 0° C. After completion of the dropping, the mixture was stirred at room temperature for 1 hour. Then, the mixture was cooled to 0° C., and methyl iodide (41.8 mL, 671 mmol) was dropped thereto. After completion of the dropping, the mixture was stirred at 25° C. for 3 hours. The reaction solution was washed with water, and the reactant was extracted therefrom with diethylether. The obtained ether extract was dried with anhydrous sodium sulfate, and was filtrated. After that, the solvent was distilled off and distilled under reduced pressure (boiling point: 74 to 75° C./0.67 kPa) to obtain 20.3 g of 1-methoxy-2,2-bis(methoxymethyl)butane (yield: 77%, purity: 100% (GC area percentage)). ¹H-NMR (400 MHz, CDCl₃) δ 0.85 (t, 3H), 1.39 (q, 2H), 3.24 (s, 6H), 3.32 (s, 9H).

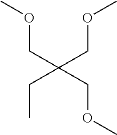

### Comparative Reference Example 2

### Synthesis of 1-(tert-butoxy)-2,2-bis(methoxymethyl)butane

### (1) Synthesis of 5-ethyl-5-hydroxymethyl-2,2-dimethyl-1,3-dioxane

A flask equipped with a stirrer was charged with trimethylolpropane (100 g, 745 mmol), 2,2-dimethoxypropane (110 mL, 894 mmol), 28 g of p-toluenesulfonic acid and 450 mL of N,N-dimethylformamide 450 mL, and the mixture was stirred at 25° C. for 2 hours. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 122 g of 5-ethyl-5-hydroxymethyl-2,2-dimethyl-1,3-dioxane (yield: 95%, purity: 98% (GC area percentage)).

¹H-NMR (400 MHz, CDCl₃) δ 0.85 (t, 3H), 1.31 (q, 2H), 1.40 (s, 3H), 1.43 (s, 3H). 1.97 (t, 3H), 3.67 (m, 4H), 3.74 (d, 2H).

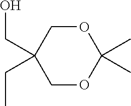

### (2) Synthesis of 5-ethyl-5-methoxymethyl-2,2-dimethyl-1,3-dioxane

The obtained 5-ethyl-5-hydroxymethyl-2,2-dimethyl-1,3-dioxane (40 g, 230 mmol) was dissolved in dry N,N-dimethylformamide (168 mL). Another 1 L four-necked flask was charged with 30 mL of dimethylformamide, and NaH (55% by weight, 11.5 g, 264 mmol) was dispersed therein. The above solution of 2,5-dimethyl-5-hydroxymethyl-1,3-dioxane was dropped into the dispersion liquid at 0° C. After completion of the dropping, the mixture was stirred at room temperature for 1 hour. Then, the mixture was cooled to 0° C., and methyl iodide (18.6 mL, 298 mmol) was dropped thereto. After completion of the dropping, the mixture was stirred at 20° C. for 3 hours. The reaction solution was washed with water, and the reactant was extracted therefrom with diethylether. The obtained ether extract was dried with anhydrous sodium sulfate, and was filtrated. Then, the solvent was distilled off to obtain 40 g of 5-ethyl-5-methoxymethyl-2,2-dimethyl-1,3-dioxane (yield: 87%, purity: 94% (GC area percentage)).

¹H-NMR (400 MHz, CDCl₃) δ 0.83 (t, 3H), 1.35 (q, 2H), 1.40 (d, 3H), 1.41 (d, 3H), 3.35 (s, 3H), 3.41 (s, 2H), 3.59 (d, 2H), 3.69 (d, 2H).

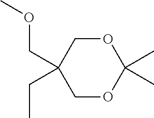

### (3) Synthesis of 2-(tert-butoxymethyl)-2-methoxymethyl-1-butanol

A flask equipped with a stirrer was charged with the obtained 5-ethyl-5-methoxymethyl-2,2-dimethyl-1,3-dioxane (34 g, 180 mmol) and 450 mL of anhydrous toluene as a solvent, and then diethylether solution of MeMgI (3M, 90 mL, 271 mmol, 1.5 equivalents) was dropped thereto at 0° C. After completion of the dropping, the reaction solution was stirred for 3 hours at 80° C. Aqueous ammonium chloride was added to the reaction solution, and the reactant was extracted therefrom with diethylether. The obtained ether extract was dried with anhydrous sodium sulfate, and was filtrated. Then, the solvent was distilled off to obtain 29 g of 2-(tert-butoxymethyl)-2-methoxymethyl-1-butanol (yield: 75%, purity: 94% (GC area percentage)).

¹H-NMR (400 MHz, CDCl₃) δ 0.84 (t, 3H), 1.18 (s, 9H), 1.34 (q, 1H), 1.35 (q, 1H), 3.34 (s, 3H), 3.35-3.60 (m, 6H).

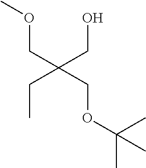

### (4) Synthesis of 1-(tert-butoxy)-2,2-bis(methoxymethyl)butane

The obtained 2-(tert-butoxymethyl)-2-methoxymethyl-1-butanol (30 g, 145 mmol) was dissolved in dry THF (400 mL). Another 1 L four-necked flask was charged with 200 mL of THF, and NaH (55% by weight, 5.2 g, 217 mmol) was dispersed therein. The above solution of 2-(tert-butoxymethyl)-2-methoxymethyl-1-butanol was dropped into the dispersion liquid at 0° C. After completion of the dropping, the mixture was stirred at room temperature for 1 hour. Then, the mixture was cooled to 0° C., and methyl iodide (36 mL, 579 mmol) was dropped thereto. After completion of the dropping, the mixture was stirred at 40° C. for 3 hours. The reaction solution was washed with water, and the reactant was extracted therefrom with diethylether. The obtained ether extract was dried with anhydrous sodium sulfate, and was filtrated. Then, the solvent was distilled off and distilled under reduced pressure (boiling point: 74 to 75° C./0.67 kPa) to obtain 25 g of 1-(tert-butoxy)-2,2-bis(methoxymethyl)butane (yield: 79%, purity: 94% (GC area percentage)).

¹H-NMR (400 MHz, CDCl₃) δ 0.84 (t, 3H), 1.14 (s, 9H), 1.37 (q, 2H), 3.17 (s, 2H), 3.24 (s, 4H), 3.31 (s, 6H).

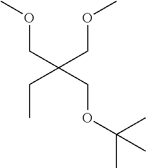

### Comparative Reference Example 3

### Synthesis of 1-tert-butoxy-2,2-bis(methoxymethyl)-4-methyl pentane

### (1) Synthesis of diethyl 2-isobutyl-2-methoxymethylmalonate

Isobutyl diethyl malonate (25 g, 116 mmol) was dissolved in dry N,N-dimethylformamide (65 mL). Another flask was charged with 65 mL of N,N-dimethylformamide, and NaH (55% by weight, 7.57 g, 173 mmol) was dispersed therein. The above solution of isobutyl diethyl malonate was dropped into the dispersion liquid at 0° C. After completion of the dropping, the mixture was stirred at room temperature for 1 hour. Then, the mixture was cooled to 0° C., and chloromethyl methyl ether (13.1 mL, 173 mmol) was dropped thereto. After completion of the dropping, the mixture was stirred at room temperature for 4 hours. The reaction solution was washed with water, and the reactant was extracted therefrom with diethylether. The obtained ether extract was dried with anhydrous sodium sulfate, and was filtrated. After that, the solvent was distilled off, and distilled under reduced pressure (boiling point: 105 to 106° C./0.60 kPa) to obtain 26.4 g of diethyl 2-isobutyl-2-methoxymethylmalonate (yield: 88%, purity: 100% (GC area percentage)).

¹H-NMR (400 MHz, CDCl₃) δ 0.89 (d, 2H), 1.25 (t, 6H), 1.64 (sep-t, 1H), 1.96 (d, 2H), 3.31 (s, 3H), 3.81 (s, 2H), 4.18 (q, 2H), 4.19 (q, 2H).

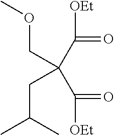 [SMILES: CCOC(=O)C(COC)(CC(C)C)C(=O)OCC]

### (2) Synthesis of 2-hydroxymethyl-2-methoxymethyl-4-methyl-1-pentanol

The obtained diethyl 2-isobutyl-2-methoxymethylmalonate (13 g, 49.9 mmol) was dissolved in dry tetrahydrofuran (46 mL). Another flask was charged with 46 mL of tetrahydrofuran, and lithium aluminum hydride (4.17 g, 110 mmol) was dispersed therein. The above solution of diethyl 2-isobutyl-2-methoxymethylmalonate was dropped into the dispersion liquid at 0° C. After completion of the dropping, the mixture was stirred at room temperature for 1 hour, and then aqueous sodium hydroxide was dropped into the reaction solution. After that, the obtained solution was neutralized with 1 mol/L of sulfuric acid, and the reactant was extracted therefrom with diethylether. The obtained ether extract was dried with anhydrous sodium sulfate, and was filtrated. Then, the solvent was distilled off to obtain 8.70 g of 2-hydroxymethyl-2-methoxymethyl-4-methyl-1-pentanol (yield: 99%, purity: 100% (GC area percentage)).

¹H-NMR (400 MHz, CDCl₃) δ 0.92 (d, 6H), 1.23 (d, 2H), 1.70 (sep-t, 1H), 3.17 (br, 2H), 3.34 (s, 3H), 3.43 (s, 2H), 3.61 (dd, 2H), 3.72 (dd, 2H).

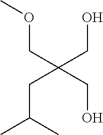

### (3) Synthesis of 5-isobutyl-5-methoxymethyl-2,2-dimethyl-1,3-dioxane

A 100 mL flask equipped with a stirrer was charged with the obtained 2-hydroxymethyl-2-methoxymethyl-4-methyl-1-pentanol (5.00 g, 28.3 mmol), 2,2-dimethoxypropane (4.97 mL, 40.6 mmol), 0.74 g of p-toluenesulfonic acid and 26 mL of N,N-dimethylformamide, and then the mixture was stirred at room temperature for 4 hours. The obtained reaction mixture was neutralized with aqueous sodium hydrogen carbonate, and the reactant was extracted therefrom with diethylether. The obtained ether extract was dried with anhydrous sodium sulfate, and was filtrated. Then, the solvent was distilled off to obtain 6.14 g of 5-isobutyl-5-methoxymethyl-2,2-dimethyl-1,3-dioxane (yield: 100%, purity: 100% (GC area percentage)).

¹H-NMR (400 MHz, CDCl₃) δ 0.90 (d, 6H), 1.16 (d, 2H), 1.39 (s, 3H), 1.42 (s, 3H), 1.71 (sep-t, 1H), 3.35 (s, 3H), 3.49 (s, 2H), 3.60-3.71 (m, 4H).

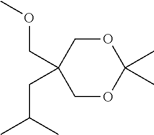

### (4) Synthesis of 2-tert-butoxymethyl-2-methoxymethyl-4-methyl-1-pentanol

A flask equipped with a stirrer was charged with the obtained 5-isobutyl-5-methoxymethyl-2,2-dimethyl-1,3-dioxane (4.2 g, 19.4 mmol) and 24 mL of anhydrous toluene as a solvent, and then diethylether solution of MeMgI (3M, 12.9 mL, 38.8 mmol, 1.5 equivalents) was dropped thereto at room temperature. After completion of the dropping, 11 mL of the solvent was distilled off under a pressure of 500 kPa at 40° C., the reaction solution was stirred for 1 hour at 100° C. Aqueous ammonium chloride was added to the reaction solution, and the reactant was extracted therefrom with diethylether. The obtained ether extract was dried with anhydrous sodium sulfate, and was filtrated. After that, the solvent was distilled off, and the residue was purified with silica gel column chromatography (a solvent: n-hexane/ethyl acetate=5/1) to obtain 2.31 g of 2-tert-butoxymethyl-2-methoxymethyl-4-methyl-1-pentanol (yield: 51%, purity: 99% (GC area percentage)).

¹H-NMR (400 MHz, CDCl₃) δ 0.905 (d, 3H), 0.908 (d, 3H), 1.18 (s, 9H), 1.21 (d, 2H), 1.70 (qq, 1H), 3.33 (s, 3H), 3.34 (dd, 1H), 3.40 (d, 2H), 3.43 (dd, 2H), 3.61 (d, 2H).

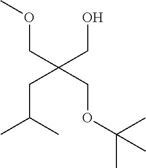 [SMILES: COCC(CO)(COC(C)(C)C)CC(C)C]

### (5) Synthesis of 1-tert-butoxy-2,2-bis(methoxymethyl)-4-methylpentane

The obtained 2-tert-butoxymethyl-2-methoxymethyl-4-methyl-1-pentanol (1.86 g, 8.00 mmol) was dissolved in dry THF (7.5 mL). Another flask was charged with 7.5 mL of THF, and NaH (55% by weight, 0.524 g, 12.0 mmol) was dispersed therein. The above solution of 2-tert-butoxymethyl-2-methoxymethyl-4-methyl-1-pentanol was dropped into the dispersion liquid at 0° C. After completion of the dropping, the mixture was stirred at room temperature for 1 hour. Then, the mixture was cooled to 0° C., and methyl iodide (1.0 mL, 16 mmol) was dropped thereto. After completion of the dropping, the mixture was stirred at 40° C. for 3 hours. The reaction solution was washed with water, and the reactant was extracted therefrom with diethylether. The obtained ether extract was dried with anhydrous sodium sulfate, and was filtrated. Then, the solvent was distilled off and distilled under reduced pressure (boiling point: 105 to 106° C./1.0 kPa) to obtain 1.10 g of 1-tert-butoxy-2,2-bis(methoxymethyl)-4-methylpentane (yield: 55%, purity: 99% (GC area percentage)).

¹H-NMR (400 MHz, CDCl₃) δ 0.91 (d, 6H), 1.13 (s, 9H), 1.27 (d, 4H), 1.75 (sep-t, 2H), 3.19 (s, 2H), 3.25 (s, 4H), 3.30 (s, 6H).

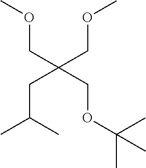 [SMILES: COCC(COC)(COC(C)(C)C)CC(C)C]

### Comparative Reference Example 4

### Synthesis of 1-methoxy-2,2-bis(methoxymethyl)-3-methylbutane

2-hydroxymethyl-2-methoxymethyl-3-methyl-1-butanol (2.00 g, 12.3 mmol) produced in Reference Example 1 (2) was dissolved in dry THF (13 mL). Another flask was charged with 13 mL of THF, and NaH (55% by weight, 1.61 g, 37.0 mmol) was dispersed therein. The above solution of 2-hydroxymethyl-2-methoxymethyl-3-methyl-1-butanol trimethylolpropane was dropped into the dispersion liquid at 0° C. After completion of the dropping, the mixture was stirred at room temperature for 1 hour. Then, the mixture was cooled to 0° C., and methyl iodide (3.1 mL, 49.3 mmol) was dropped thereto. After completion of the dropping, the mixture was stirred at room temperature for 1 hour. The reaction solution was washed with water, and the reactant was extracted therefrom with diethylether. The obtained ether extract was dried with anhydrous sodium sulfate, and was filtrated. Then, the solvent was distilled off and distilled under reduced pressure (boiling point: 74 to 75° C./1.0 kPa) to obtain 1.09 g of 1-methoxy-2,2-bis(methoxymethyl)-3-methylbutane (yield: 46%, purity: 99% (GC area percentage)).

¹H-NMR (400 MHz, CDCl₃) δ 0.93 (d, 6H), 1.80 (sep, 1H), 3.28 (s, 6H), 3.32 (s, 9H).

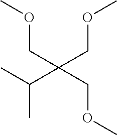

### Comparative Reference Example 5

### Synthesis of 1-methoxy-2,2-bis(methoxymethyl)-3,3-dimethylbutane

2-hydroxymethyl-2-methoxymethyl-3-methyl-1-butanol (0.500 g, 2.84 mmol) produced in Reference Example 6 (2) was dissolved in dry THF (2 mL). Another flask was charged with 2 mL of THF, and NaH (55% by weight, 0.204 g, 8.51 mmol) was dispersed therein. The above solution of 2-hydroxymethyl-2-methoxymethyl-3-methyl-1-butanol was dropped into the dispersion liquid at 0° C. After completion of the dropping, the mixture was stirred at room temperature for 1 hour. Then, the mixture was cooled to 0° C., and methyl iodide (0.71 mL, 11.4 mmol) was dropped thereto. After completion of the dropping, the mixture was stirred at room temperature for 1 hour. The reaction solution was washed with water, and the reactant was extracted therefrom with diethylether. The obtained ether extract was dried with anhydrous sodium sulfate, and was filtrated. Then, the solvent was distilled off and distilled under reduced pressure (boiling point: 75 to 77° C./1.00 kPa) to obtain 0.32 g of 1-methoxy-2,2-bis(methoxymethyl)-3,3-methylbutane (yield: 54%, purity: 98% (GC area percentage)).

¹H-NMR (400 MHz, CDCl₃) δ 0.99 (s, 9H), 3.28 (s, 9H), 3.39 (s, 6H).

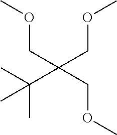

### Example 1

### (1) Synthesis of Solid Catalyst Component (A-1)

After a reactor equipped with a stirrer was purged with a nitrogen gas, 800 L of hexane, 6.8 kg of diisobutyl phthalate, 350 kg of tetraethoxysilane and 38.8 kg of tetrabutoxytitanium were added to the reactor, and then the mixture was stirred. 900 L of dibutylether solution of butyl magnesium chloride (concentration: 2.1 mol/L) was dropped into the mixture over 5 hours while maintaining the temperature in the reactor at 7° C. After completion of the dropping, the mixture was stirred for 1 hour at 20° C., and then was filtered. The obtained solid was washed three times with 1100 L of toluene. After that, toluene was added thereto so that the total volume of the slurry could be 625 L. Subsequently, the obtained slurry was heated to 70° C. and was stirred for 1 hour at the same temperature, and then was cooled to room temperature to obtain a slurry of the solid substance.

A portion of the obtained slurry was dried under a reduced pressure to obtain a dried solid substance. The composition of the dried solid substance was analyzed. The solid substance contained 2.1% by weight of titanium atom, 38.9% by weight of ethoxy group and 3.4% by weight of butoxy group (the weight percentage of the dried solid substance was 100% by weight).

After a 100 ml flask equipped with a stirrer, a dropping funnel and a thermometer was purged with a nitrogen gas, the slurry of the solid substance which had been obtained in the above-mentioned step was added in the flask so that the amount of the dried solid substance could be 8 g. After that, a supernatant solution was removed from the slurry so that the total volume of the slurry could be 26.5 mL. Then, a mixture of titanium tetrachloride (16 ml) and dibutyl ether (0.8 ml) was added to the slurry at 40° C., additionally a mixture of phthaloyl chloride (2.0 mL) and toluene (2.0 mL) was dropped thereto over 5 minutes. After completion of the dropping, the reaction mixture was stirred for 4 hours at 115° C. Subsequently, the obtained mixture was separated into a solid and a liquid at the same temperature to obtain a solid component.

The solid component was washed three times with 40 mL of toluene at 115° C. After that, toluene was added to the washed solid component so that the total volume of the slurry could be 26.5 mL. Then, a mixture of dibutyl ether (0.8 mL), diisobutyl phthalate (0.45 mL) and titanium tetrachloride (6.4 mL) was added thereto, and the obtained slurry was stirred for 1 hour at 105° C. Subsequently, the obtained mixture was separated into a solid and a liquid at the same temperature to obtain a solid component.

The solid component was washed twice with 40 mL of toluene at 105° C. After that, toluene was added to the washed solid component so that the total volume of the slurry could be 26.5 mL, and its temperature was adjusted to 105° C. Then, a mixture of dibutyl ether (0.8 mL) and titanium tetrachloride (6.4 mL) was added thereto, and the obtained slurry was stirred for 1 hour at 105° C. Subsequently, the obtained mixture was separated into a solid and a liquid at the same temperature to obtain a solid component.

The solid component was washed twice with 40 mL of toluene at 105° C. After that, toluene was added to the washed solid component so that the total volume of the slurry could be 26.5 mL, and its temperature was adjusted to 105° C. Then, a mixture of dibutyl ether (0.8 mL) and titanium tetrachloride (6.4 mL) was added thereto, and the obtained slurry was stirred for 1 hour at 105° C. Subsequently, the obtained mixture was separated into a solid and a liquid at the same temperature to obtain a solid component.

The solid component was washed six times with 40 mL of toluene at 105° C., and further washed three times with 40 mL of hexane at room temperature. The obtained solid was dried under a reduced pressure to obtain a solid catalyst component (A-1).

The obtained solid catalyst component (A-1) contained 1.6% by weight of titanium atom, 0.05% by weight of ethoxy group, 0.15% by weight of butoxy group, 7.6% by weight of diethyl phthalate, 0.8% by weight of n-butyl ethyl phthalate and 2.5% by weight of diisobutyl phthalate (the weight percentage of the solid catalyst component was 100% by weight).

### (2) Polymerization of Propylene

An autoclave equipped with a stirrer, which has a 3 L of inner volume, was completely dried and was purged with an argon gas and was cooled. Subsequently, the autoclave was evacuated to be in vacuum. A mixture obtained by bringing 2.6 mmol of triethyl aluminum (component (B)) and 0.26 mmol of 1-tert-butoxy-2,2-bis(methoxymethyl)-3-methylbutane (component (C)) produced in Reference Example 1 into contact with one another was brought into contact with 7.45 mg of the solid catalyst component (component (A-1)) produced in the above-mentioned (1), in this order, in heptane in the glass charger.

The mixture obtained by bringing components (A-1) to (C) into contact with one another was added to the autoclave at once. Subsequently, 780 g of liquid propylene was added to the autoclave, and also hydrogen was charged thereto until the partial pressure reached 0.20 MPa. The temperature of the autoclave was elevated to 80° C.

After 1 hour from the start of the polymerization, gas was purged from the autoclave to complete the polymerization, and then the obtained polymer was dried under a reduced pressure for 1 hour at 60° C. to obtain 267 g of polymer powder. As to the polymer, PP/cat was 35,800 (g-Polymer/g-Catalyst component (A-1)), CXS was 0.8 (% by weight), the intrinsic viscosity [η] was 1.02 (dL/g), and [mmmm] was 0.974. The polymerization condition and result thereof were shown in Table 1.

### Example 2

Polymerization was performed in the same manner as in Example 1 except that the component (A-1) was used in an amount of 4.39 mg and 1-cyclohexyloxy-2,2-bis(methoxymethyl)-3-methylbutane produced in Reference Example 2 was used as the component (C). The result was shown in Table 1.

### Example 3

Polymerization was performed in the same manner as in Example 1 except that the component (A-1) was used in an amount of 6.10 mg and 1-tert-butoxy-2-cyclohexyl-3-methoxy-2-methoxymethylpropane produced in Reference Example 3 was used as the component (C).

The result was shown in Table 1.

### Example 4

Polymerization was performed in the same manner as in Example 1 except that the component (A-1) was used in an amount of 7.84 mg and 2-cyclohexyl-2-cyclohexyloxymethyl-1,3-dimethoxypropane produced in Reference Example 4 was used as the component (C). The result was shown in Table 1.

### Example 5

Polymerization was performed in the same manner as in Example 1 except that the component (A-1) was used in an amount of 8.33 mg and 2-cyclohexyl-2-cyclododecyloxymethyl-1,3-dimethoxypropane produced in Reference Example 5 was used as the component (C). The result was shown in Table 1.

### Example 6

Polymerization was performed in the same manner as in Example 1 except that the component (A-1) was used in an amount of 8.55 mg and 1-tert-butoxy-2,2-bis(methoxymethyl)-3,3-dimethylbutane produced in Reference Example 6 was used as the component (C). The result was shown in Table 1.

### Example 7

An autoclave equipped with a stirrer, which has a 3 L of inner volume, was completely dried and was purged with an argon gas and was cooled. Subsequently, the autoclave was evacuated to be in vacuum. A mixture obtained by bringing 2.6 mmol of triethyl aluminum (component (B)) and 0.13 mmol of 1-tert-butoxy-2,2-bis(methoxymethyl)-3,3-dimethylbutane (component (C)) produced in Reference Example 6 and 0.26 mmol of cyclohexylethyl dimethoxysilane (component (D)) into contact with one another was brought into contact with 8.15 mg of the solid catalyst component (component (A-1)) produced in Example 1 (1), in this order, in heptane in the glass charger.

The mixture obtained by bringing components (A-1) to (D) into contact with one another was added to the autoclave at once. Subsequently, 780 g of liquid propylene was added to the autoclave, and also hydrogen was charged thereto until the partial pressure reached 0.20 MPa. The temperature of the autoclave was elevated to 80° C.

After 1 hour from the start of the polymerization, gas was purged from the autoclave to complete the polymerization, and then the obtained polymer was dried under a reduced pressure for 1 hour at 60° C. to obtain 205 g of polymer powder. As to the polymer, PP/cat was 25,200 (g-Polymer/g-Catalyst component (A-1)), CXS was 0.4 (% by weight), the intrinsic viscosity [η] was 1.30 (dL/g), and [mmmm] was 0.987. A polymerization condition and result thereof were shown in Table 1.

### Example 8

Polymerization was performed in the same manner as in Example 1 except that the component (A-1) was used in an amount of 6.05 mg and 1-cyclohexyloxy-2,2-bis(methoxymethyl)-3,3-dimethylbutane produced in Reference Example 7 was used as the component (C). The result was shown in Table 1.

### Example 9

Polymerization was performed in the same manner as in Example 1 except that the component (A-1) was used in an amount of 7.44 mg and 2,2-bis(methoxymethyl)-3,3-dimethyl-1-(1-methylcyclohexyl) oxybutane produced in Reference Example 8 was used as the component (C). The result was shown in Table 1.

### Example 10

Polymerization was performed in the same manner as in Example 1 except that the component (A-1) was used in an amount of 7.87 mg and 2,2-bis(methoxymethyl)-3,3-dimethyl-1-thexyloxybutane produced in Reference Example 9 was used as the component (C). The result was shown in Table 1.

### Example 11

Polymerization was performed in the same manner as in Example 1 except that the component (A-1) was used in an amount of 3.98 mg and 1-tert-butoxy-2,2-bis(methoxymethyl)-3,3,4-trimethylpentane produced in Reference Example 10 was used as the component (C). The result was shown in Table 1.

### Example 12

### (1) Synthesis of Solid Catalyst Component (A-2)

After a 300 ml flask equipped with a stirrer, a dropping funnel and a thermometer was purged with a nitrogen gas, 10.31 g of spherical diethoxymagnesium and 83 mL of toluene were added to the flask. After that, 20.6 mL of titanium tetrachloride was added thereto at room temperature, and then the temperature was elevated to 80° C. 4.12 mL of diisobutyl phthalate was added thereto, and the mixture was stirred for 1 hour at 110° C. Subsequently, the obtained mixture was separated into a solid and a liquid, and then the solid was washed three times with 103 mL of toluene at 100° C. After that, 83 mL of toluene was added to the washed solid. 20.6 mL of titanium tetrachloride was added thereto, and then the mixture was stirred for 1 hour at 110° C. Then, the obtained mixture was separated into a solid and a liquid, and the solid was washed three times with 103 mL of toluene at 100° C., and further washed three times with 103 mL of hexane at room temperature. The obtained solid was dried under a reduced pressure to obtain 10.81 g of solid catalyst component (A-2) for olefin polymerization.

The solid catalyst component contained 2.1% by weight of titanium atom, 0.35% by weight of ethoxy group and 14.1% by weight of diethyl phthalate (the weight percentage of the solid catalyst component was 100% by weight).

### (2) Polymerization of Propylene

An autoclave equipped with a stirrer, which has a 3 L of inner volume, was completely dried and was purged with an argon gas and was cooled. Subsequently, the autoclave was evacuated to be in vacuum. A mixture obtained by bringing 2.6 mmol of triethyl aluminum (component (B)) and 0.26 mmol of 1-tert-butoxy-2,2-bis(methoxymethyl)-3,3-dimethylbutane (component (C)) produced in Reference Example 6 into contact with one another was brought into contact with 6.50 mg of the solid catalyst component (component (A-2)) produced in Example 12 (1), in this order, in heptane in the glass charger.

The mixture obtained by bringing components (A-2) to (C) into contact with one another was added to the autoclave at once. Subsequently, 780 g of liquid propylene was added to the autoclave, and also hydrogen was charged thereto until the partial pressure reached 0.20 MPa. The temperature of the autoclave was elevated to 80° C.

After 1 hour from the start of the polymerization, gas was purged from the autoclave to complete the polymerization, and then the obtained polymer was dried under a reduced pressure for 1 hour at 60° C. to obtain 249 g of polymer powder. As to the polymer, PP/cat was 38,300 (g-Polymer/g-Catalyst component (A-2)), CXS was 0.9 (% by weight), the intrinsic viscosity [η] was 0.95 (dL/g), and [mmmm] was 0.977. A polymerization condition and result thereof were shown in Table 1.

### Example 13

### (1) Synthesis of Solid Catalyst Component (A-3)

After a 300 ml flask equipped with a stirrer, a dropping funnel and a thermometer was purged with a nitrogen gas, 5.12 g of spherical diethoxymagnesium and 41 mL of toluene were added to the flask. After that, 10.2 mL of titanium tetrachloride was added thereto at room temperature, and then the temperature was elevated to 80° C. 2.05 mL of ethyl 2-tert-butyl-3-ethoxypropionate was added thereto, and the mixture was stirred for 1 hour at 110° C. Subsequently, the obtained mixture was separated into a solid and a liquid, and then the solid was washed three times with 51 mL of toluene at 100° C. After that, 41 mL of toluene was added to the washed solid. 10.2 mL of titanium tetrachloride was added thereto, and then the mixture was stirred for 1 hour at 110° C. Then, the obtained mixture was separated into a solid and a liquid, and the solid was washed three times with 51 mL of toluene at 100° C., and further washed three times with 51 mL of hexane at room temperature. The obtained solid was dried under a reduced pressure to obtain 5.12 g of a solid catalyst component (A-3) for olefin polymerization.

The solid catalyst component contained 2.1% by weight of titanium atom, 0.47% by weight of ethoxy group and 12.2% by weight of ethyl 2-tert-butyl-3-ethoxypropionate (the weight percentage of the solid catalyst component was 100% by weight).

### (2) Polymerization of Propylene

Polymerization was performed in the same manner as in Example 12 except that the solid catalyst component (A-3) produced in Example 13 (1) was used in an amount of 6.62 mg. The result was shown in Table 1.

### Example 14

### (1) Synthesis of Solid Catalyst Component (A-4)

After a 300 ml flask equipped with a stirrer, a dropping funnel and a thermometer was purged with a nitrogen gas, 5.12 g of spherical diethoxymagnesium and 41 mL of toluene were added to the flask. After that, 10.2 mL of titanium tetrachloride was added thereto at room temperature, and then the temperature was elevated to 80° C. 1.54 mL of 2-isobutyl-2-isopropyl-1,3-dimethoxypropane was added thereto, and the mixture was stirred for 1 hour at 110° C. Subsequently, the obtained mixture was separated into a solid and a liquid, and then the solid was washed three times with 51 mL of toluene at 100° C. After that, 41 mL of toluene was added to the washed solid. 10.2 mL of titanium tetrachloride was added thereto, and then the mixture was stirred for 1 hour at 110° C. Then, the obtained mixture was separated into a solid and a liquid, and the solid was washed three times with 51 mL of toluene at 100° C., and further washed three times with 51 mL of hexane at room temperature. The obtained solid was dried under a reduced pressure to obtain 5.75 g of solid catalyst component (A-4) for olefin polymerization.

The solid catalyst component contained 2.9% by weight of titanium atom, 0.88% by weight of ethoxy group and 17.5% by weight of 2-isobutyl-2-isopropyl-1,3-dimethoxypropane (the weight percentage of the solid catalyst component was 100% by weight).

### (2) Polymerization of Propylene

Polymerization was performed in the same manner as in Example 12 except that the solid catalyst component (A-4) produced in Reference Example 14 (1) was used in an amount of 7.86 mg. The result was shown in Table 1.

### Example 15

Polymerization was performed in the same manner as in Example 1 except that the component (A-1) was used in an amount of 6.60 mg and 2-cyclobutoxymethyl-2-cyclohexyl-1,3-dimethoxypropane produced in Reference Example 11 was used as the component (C). The result was shown in Table 1.

### Example 16

Polymerization was performed in the same manner as in Example 1 except that the component (A-1) was used in an amount of 10.90 mg and 2-(2-adamantyloxymethyl)-2-cyclohexyl-1,3-dimethoxypropane produced in Reference Example 12 was used as the component (C). The result was shown in Table 1.

### Comparative Example 1

Polymerization was performed in the same manner as in Example 1 except that the component (A-1) was used in an amount of 12.00 mg and 1-methoxy-2,2-bis(methoxymethyl)butane produced in Comparative Reference Example 1 was used as the component (C). The result was shown in Table 1.

### Comparative Example 2

Polymerization was performed in the same manner as in Example 1 except that the component (A-1) was used in an amount of 8.39 mg and 1-(tert-butoxy)-2,2-bis(methoxymethyl)butane produced in Comparative Reference Example 2 was used as the component (C). The result was shown in Table 1.

### Comparative Example 3

Polymerization was performed in the same manner as in Example 7 except that the component (A-1) was used in an amount of 8.10 mg and 1-methoxy-2,2-bis(methoxymethyl) butane produced in Comparative Reference Example 1 was used as the component (C). The result was shown in Table 1.

### Comparative Example 4

Polymerization was performed in the same manner as in Example 1 except that the component (A-1) was used in an amount of 6.63 mg and 1-tert-butoxy-2,2-bis(methoxymethyl)-4-methylpentane produced in Comparative Reference Example 3 was used as the component (C). The result was shown in Table 1.

### Comparative Example 5

Polymerization was performed in the same manner as in Example 1 except that the component (A-1) was used in an amount of 7.38 mg and 1-methoxy-2,2-bis(methoxymethyl)-3-methylbutane produced in Comparative Reference Example 4 was used as the component (C). The result was shown in Table 1.

### Comparative Example 6

Polymerization was performed in the same manner as in Example 1 except that the component (A-1) was used in an amount of 10.57 mg and 1-methoxy-2,2-bis(methoxymethyl)-3,3-dimethylbutane produced in Comparative Reference Example 5 was used as the component (C). The result was shown in Table 1.

### Comparative Example 7

Polymerization was performed in the same manner as in Example 12 except that the component (A-2) was used in an amount of 14.89 mg and 1-methoxy-2,2-bis(methoxymethyl)butane produced in Comparative Reference Example 1 was used as the component (C). The result was shown in Table 1.

### Comparative Example 8

Polymerization was performed in the same manner as in Example 12 except that the component (A-2) was used in an amount of 6.59 mg and 1-(tert-butoxy)-2,2-bis(methoxymethyl) butane produced in Comparative Reference Example 2 was used as the component (C). The result was shown in Table 1.

### Comparative Example 9

Polymerization was performed in the same manner as in Example 14 except that the component (A-4) was used in an amount of 9.76 mg and 1-(tert-butoxy)-2,2-bis(methoxymethyl)butane produced in Comparative Reference Example 2 was used as the component (C). The result was shown in Table 1.

TABLE 1

| | Solid catalyst | Triether | (C) used | Alkoxysilane compound | (D)Used | Polymerization | CXS | | [η] | M_{w} | |
|---|---|---|---|---|---|---|---|---|---|---|---|
| | component(A) | compound(C) | amount(mmol) | (D) | amount(mmol) | activity(g-PP/g-cat) | (wt %) | [mmmm] | (dL/g) | (10⁵g/mol) | M_{w}/Mₙ |
| Example 1 | (A-1) | 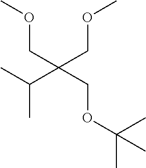 [SMILES: COCC(COC)(COC(C)(C)C)C(C)C] | 0.26 | — | — | 35,800 | 0.8 | 0.974 | 1.02 | 1.30 | 4.7 |
| Example 2 | (A-1) | 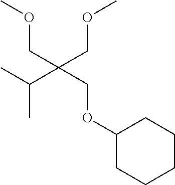 [SMILES: COCC(COC)(COC1CCCCC1)C(C)C] | 0.26 | — | — | 10,800 | 1.0 | 0.970 | 1.04 | 1.35 | 3.3 |
| Example 3 | (A-1) | 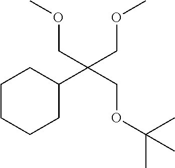 [SMILES: COCC(COC)(COC(C)(C)C)C1CCCCC1] | 0.26 | — | — | 38,300 | 0.7 | 0.976 | 1.31 | 1.87 | 3.8 |
| Example 4 | (A-1) | 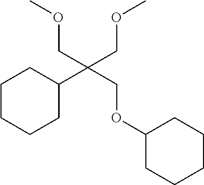 [SMILES: COCC(COC)(COC1CCCCC1)C1CCCCC1] | 0.26 | — | — | 19,700 | 1.1 | 0.968 | 1.18 | 1.65 | 3.2 |
| Example 5 | (A-1) | 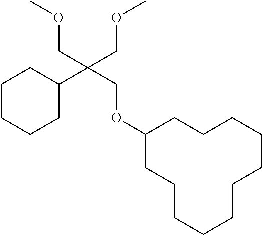 [SMILES: COCC(COC)(COC1CCCCCCCCCCC1)C1CCCCC1] | 0.26 | — | — | 25,600 | 1.0 | 0.969 | 1.17 | 1.52 | 3.5 |
| Example 6 | (A-1) | 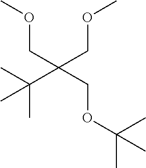 [SMILES: COCC(COC)(COC(C)(C)C)C(C)(C)C] | 0.26 | — | — | 34,000 | 0.6 | 0.983 | 1.07 | 1.62 | 4.9 |
| Example 7 | (A-1) | 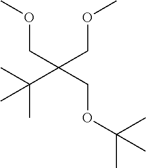 [SMILES: COCC(COC)(COC(C)(C)C)C(C)(C)C] | 0.13 | 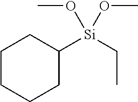 | 0.26 | 25,200 | 0.4 | 0.987 | 1.30 | 1.73 | 5.0 |
| Example 8 | (A-1) | 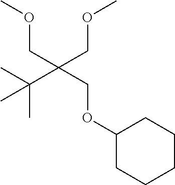 [SMILES: COCC(COC)(COC1CCCCC1)C(C)(C)C] | 0.26 | — | — | 12,200 | 1.1 | 0.969 | 1.15 | 1.57 | 4.5 |
| Example 9 | (A-1) | 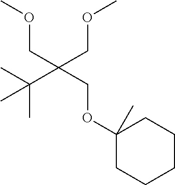 [SMILES: COCC(COC)(COC1(C)CCCCC1)C(C)(C)C] | 0.26 | — | — | 25,300 | 0.7 | 0.980 | 1.11 | 1.44 | 4.9 |
| Example 10 | (A-1) | 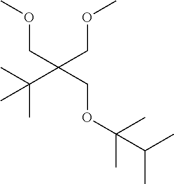 [SMILES: COCC(COC)(COC(C)(C)C(C)C)C(C)(C)C] | 0.26 | — | — | 20,700 | 1.0 | 0.975 | 1.11 | 1.46 | 4.4 |
| Example 11 | (A-1) | 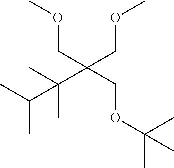 [SMILES: COCC(COC)(COC(C)(C)C)C(C)(C)C(C)C] | 0.26 | — | — | 25,900 | 0.8 | 0.979 | 1.21 | 1.68 | 4.4 |
| Example 12 | (A-2) | 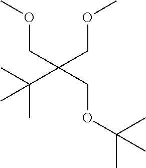 [SMILES: COCC(COC)(COC(C)(C)C)C(C)(C)C] | 0.26 | — | — | 38,300 | 0.9 | 0.977 | 0.95 | 1.29 | 5.2 |
| Example 13 | (A-3) | 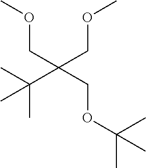 [SMILES: COCC(COC)(COC(C)(C)C)C(C)(C)C] | 0.26 | — | — | 21,300 | 0.9 | 0.975 | 1.01 | 1.31 | 5.4 |
| Example 14 | (A-4) | 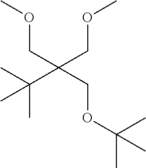 [SMILES: COCC(COC)(COC(C)(C)C)C(C)(C)C] | 0.26 | — | — | 15,500 | 0.8 | 0.979 | 0.90 | 1.15 | 4.7 |
| Example 15 | (A-1) | 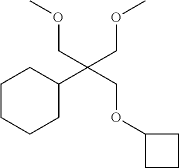 [SMILES: COCC(COC)(COC1CCC1)C1CCCCC1] | 0.26 | — | — | 15,500 | 1.1 | 0.966 | 1.09 | 1.38 | 4.3 |
| Example 16 | (A-1) | 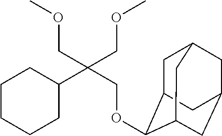 [SMILES: COCC(COC)(COC1C2CC3CC(C2)CC1C3)C1CCCCC1] | 0.26 | — | — | 17,500 | 0.8 | 0.973 | 1.08 | 1.32 | 4.0 |
| Comparative Example 1 | (A-1) | 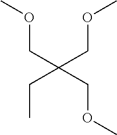 | 0.26 | — | — | 1,380 | 3.2 | 0.930 | 0.97 | 1.23 | 4.8 |
| Comparative Example 2 | (A-1) | 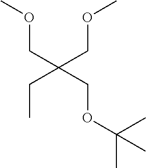 | 0.26 | — | — | 19.800 | 1.5 | 0.947 | 0.87 | 1.02 | 3.8 |
| Comparative Example 3 | (A-1) | 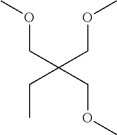 | 0.13 | 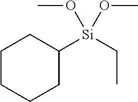 | 0.26 | 4,820 | 1.0 | 0.972 | 1.25 | 1.91 | 6.3 |
| Comparative Example 4 | (A-1) | 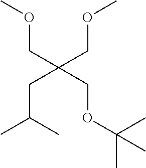 [SMILES: COCC(COC)(COC(C)(C)C)CC(C)C] | 0.26 | — | — | 37,100 | 1.2 | 0.955 | 0.96 | 1.18 | 4.3 |
| Comparative Example 5 | (A-1) | 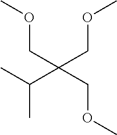 | 0.26 | — | — | 1,930 | 2.8 | 0.941 | 1.03 | 1.33 | 5.8 |
| Comparative Example 6 | (A-1) | 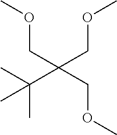 | 0.26 | — | — | 1,540 | 2.7 | 0.939 | 1.11 | 1.53 | 4.9 |
| Comparative Example 7 | (A-2) | 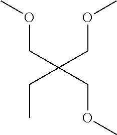 | 0.26 | — | — | 3,880 | 6.1 | 0.899 | 0.86 | 1.02 | 4.9 |
| Comparative Example 8 | (A-2) | 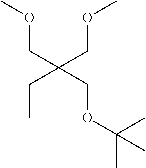 | 0.26 | — | — | 29.600 | 1.9 | 0.941 | 0.89 | 1.08 | 4.5 |
| Comparative Example 9 | (A-4) | 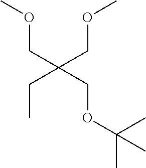 | 0.26 | — | — | 9,000 | 0.8 | 0.975 | 0.88 | 1.10 | 3.9 |

Solid catalyst (A-1): Synthesis method is described in Example 1
Solid catalyst (A-2): Synthesis method is described in Example 12
Solid catalyst (A-3): Synthesis method is described in Example 13
Solid catalyst (A-4): Synthesis method is described in Example 14

### Example 17

### (1) Polymerization of Propylene

An autoclave equipped with a stirrer was completely dried under a reduced pressure, purged with an argon gas and cooled.

Subsequently, the autoclave was vacuated. After 4.4 mmol of triethyl aluminum and 0.44 mmol of 2-cyclohexyl-2-cyclohexyloxymethyl-1,3-dimethoxypropane produced in Reference Example 4 and 11.1 mg of the solid catalyst component (A-1) produced in Example 1 were brought into contact with one another in heptane in the glass charger, the mixture was added to the autoclave at once. Subsequently, 780 g of liquid propylene was added to the autoclave, and also hydrogen was charged thereto until the pressure reached 1.0 MPa. The temperature of the autoclave was elevated to 80° C. to start the polymerization of propylene. After 60 minutes from the start of the polymerization, an unreacted propylene was purged to complete the polymerization. 115.5 g of propylene polymer (17) was obtained, and its intrinsic viscosity [η] was 0.84 (dL/g).

### (2) Production of Polypropylene Resin Composition

To 20 g of the propylene polymer (17) produced in Example 17 (1) was added 0.02 g of 2,4-di-t-pentyl-6-[1-(3,5-di-t-pentyl-2-hydroxyphenyl)ethyl]phenyl acrylate (Sumilizer® GS manufactured by Sumitomo Chemical Co., Ltd), and then they were mixed. The obtained mixture was kneaded for 5 minutes at 190° C. by means of a test roll apparatus HR-20F model, manufactured by Nisshin Kagaku Inc. (roll size: 75 φ×200 Lmm, roll rotational, back roll 17 rpm, front roll 14 rpm, front-back ratio 1:1.2, using roll heating cartridge heater 200V, 1.5 kw×2, drive electricity, 200V, 0.75 kw), and then the obtained blend was cut to obtain the pellets of the polypropylene resin composition (17).

For the obtained pellets of the polypropylene resin composition (17), the content of extracted component with tetrahydrofuran was measured and the fogging test was performed. The result was shown in Table 2.

### Comparative Example 10

### (1) Polymerization of Propylene

The procedure of Example 17 (1) was repeated except that 0.44 mmol of cyclohexyl-ethyl-dimethoxysilane was used instead of 0.44 mmol of 2-cyclohexyl-2-cyclohexyloxymethyl-1,3-dimethoxypropane, thereby obtaining 289.5 g of propylene polymer (C10). The intrinsic viscosity [η] of the propylene polymer (C10) was 0.78 (dL/g).

### (2) Production of Polypropylene Resin Composition

The procedure of Example 17 (2) was repeated except that 20 g of propylene polymer (C10) produced in Comparative Example 10 (1) was used instead of propylene polymer (17), thereby obtaining the pellets of the propylene polymer (C10). For the obtained pellets of the propylene polymer (C10), the content of extracted component with tetrahydrofuran was measured and the fogging test was performed. The result was shown in Table 2.

TABLE 2

| | | | | Proportion | | | | |
|---|---|---|---|---|---|---|---|---|
| | | | | of | Molecular | | Content of extracted | Fogging test/ |
| | | | Isotactic | different | weight | | component | sample |
| | | Polymerization | pentad | bonds | distribution | η | with THF | weight loss |
| | | catalyst component | fraction | (mol %) | Mw/Mn | (dl/g) | (ppm) | (mg) |
| Example 17 | Propylene polymer(17) | 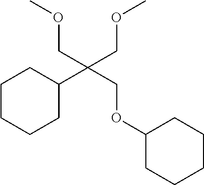 [SMILES: COCC(COC)(COC1CCCCC1)C1CCCCC1] | 0.9693 | 0.005> | 3.2 | 0.84 | 1300 | 16.2 |
| Com- parative Example 10 | Propylene polymer(C10) | 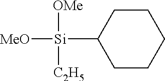 [SMILES: CC[Si](OC)(OC)C1CCCCC1] | 0.9842 | 0.005> | 5.3 | 0.78 | 2800 | 20.8 |

Proportion of different bonds in Table 2 means a total amount of bonds resulting from 2,1-insetion reaction and 3,1-insertion reaction in the total structural units derived from propylene measured by a ¹³C nuclear magnetic resonance spectrum.

It is confirmed that the composition obtained in Example 17 satisfying the requirements of the present invention has a low VOC content since the sample weight loss according to the fogging test is small. On the other hand, it is confirmed that the composition obtained in Comparative Example 10 which does not satisfy the requirements of the present invention has a high VOC content since the sample weight loss is high.

### Example 18

### (1) Polymerization of Propylene

An autoclave equipped with a stirrer was completely dried under a reduced pressure and was purged with an argon gas and was cooled. Subsequently, the autoclave was evacuated to be in vacuum. After 4.4 mmol of triethyl aluminum and 0.44 mmol of 1-tert-butoxy-2,2-bis(methoxymethyl)-3,3-dimethylbutane produced in Reference Example 6 and 11.1 mg of the solid catalyst component (A-1) produced in Example 1 were brought into contact with one another in heptane in the glass charger, the mixture was added to the autoclave at once. Subsequently, 780 g of liquid propylene was added to the autoclave, and also hydrogen was charged thereto until the pressure reached 1.0 MPa. The temperature of the autoclave was elevated to 80° C. to start the polymerization of propylene. After 60 minutes from the start of the polymerization, an unreacted propylene was purged to complete the polymerization. 265 g of propylene polymer (18) was obtained, and its intrinsic viscosity [η] was 0.80 (dL/g).

### (2) Production of Polypropylene Resin Composition

To 20 g of the propylene polymer (18) produced in Example 18 (1) were added 0.02 g of 2,4-di-t-pentyl-6-[1-(3,5-di-t-pentyl-2-hydroxyphenyl)ethyl]phenyl acrylate (Sumilizer® GS manufactured by Sumitomo Chemical Co., Ltd), 0.01 g of trehalose (D-(+)-trehalose dihydrate manufactured by TOKYO KASEI KOGYO CO., LTD.) and 0.01 g of pentaerythritol tetrakis[3-(3,5-di-tert-butyl-4-hydroxyphenyl]propionate (Irganox 1010 manufactured by BASF), and then they was mixed. The obtained mixture was kneaded for 5 minutes at 190° C. by means of a test roll apparatus HR-20F model, manufactured by Nisshin Kagaku Inc. (roll size: 75 φ×200 Lmm, roll rotational, back roll 17 rpm, front roll 14 rpm, front-back ratio 1:1.2, using roll heating cartridge heater 200V, 1.5 kw×2, drive electricity, 200V, 0.75 kw), and then the obtained blend was cut to obtain the pellets of the polypropylene resin composition (18). The result of the fogging test for the pellets of the polypropylene resin composition (18) was shown in Table 3.

### Example 19

### (1) Polymerization of Propylene

The procedure of Example 18 (1) was repeated except that a hydrogen was charged until the pressure reached 0.8 MPa, thereby obtaining 206.2 g of propylene polymer (19). The intrinsic viscosity [η] of the propylene polymer (19) was 1.34 (dL/g).

### (2) Production of Polypropylene Resin Composition

To 20 g of the propylene polymer (19) produced in Example 19 (1) were added 0.02 g of 2,4-di-t-pentyl-6-[1-(3,5-di-t-pentyl-2-hydroxyphenyl)ethyl]phenyl acrylate (Sumilizer® GS manufactured by Sumitomo Chemical Co., Ltd) and 0.01 g of trehalose (D-(+)-trehalose dihydrate manufactured by TOKYO KASEI KOGYO CO., LTD.), and then they was mixed. The obtained mixture was kneaded for 5 minutes at 190° C. by means of a test roll apparatus HR-20F model, manufactured by Nisshin Kagaku Inc. (roll size: 75 φ×200 Lmm, roll rotational, back roll 17 rpm, front roll 14 rpm, front-back ratio 1:1.2, using roll heating cartridge heater 200V, 1.5 kw×2, drive electricity, 200V, 0.75 kw), and then the obtained blend was cut to obtain the pellets of the polypropylene resin composition (19). The result of the fogging test for the pellets of the polypropylene resin composition (19) was shown in Table 3.

### Example 20

The procedure of Example 18 (2) was repeated except that 20 g of the propylene polymer (19) produced in Example 19 (1) was used, thereby obtaining the pellets of the polypropylene resin composition (20). The result of the fogging test for the pellets of the polypropylene resin composition (20) was shown in Table 3.

### Comparative Example 11

The pellets of the polypropylene resin composition (C11) was obtained in the same manner as in Example 18 (2) except that 0.02 g of 2,4-di-t-pentyl-6-[1-(3,5-di-t-pentyl-2-hydroxyphenyl)ethyl]phenyl acrylate (Sumilizer® GS manufactured by Sumitomo Chemical Co., Ltd) was used relative to 20 g of the propylene polymer (18) produced in Example 18 (1). The result of the fogging test for the pellets of the polypropylene resin composition (C11) was shown in Table 3.

### Comparative Example 12

The procedure of Comparative Example 11 was repeated except that 20 g of the propylene polymer (19) produced in Example 19 (1) was used, thereby obtaining the pellets of the polypropylene resin composition (C12). The result of the fogging test for the pellets of the polypropylene resin composition (C12) was shown in Table 3.

### Comparative Example 13

### (1) Polymerization of Propylene

The procedure of Example 18 (1) was repeated except that 0.44 mmol of ethyl-cyclohexyl-dimethoxysilane was used instead of 1-tert-butoxy-2,2-bis(methoxymethyl)-3,3-dimethylbutane, as the component (C) thereby obtaining 289.5 g of propylene polymer (C13). The intrinsic viscosity [η] of the propylene polymer (C13) was 0.78 (dL/g).

### (2) Production of Polypropylene Resin Composition

The procedure of Example 19 (2) was repeated except that 20 g of the propylene polymer (C13) produced in Comparative Example 13 (1) was used, thereby obtaining the pellets of the polypropylene resin composition (C13). The result of the fogging test for the pellets of the polypropylene resin composition (C13) was shown in Table 3.

TABLE 3

| | | | | | Result of fogging test |
|---|---|---|---|---|---|
| | Composition | | | | Amount of component |
| | | Trehalose | Sumilizer GS | Irganox 1010 | which adheres to glass |
| | Propylene polymer | (wt %) | (wt %) | (wt %) | (mg) |
| Example18 | Propylene polymer (18) | 0.05 | 0.1 | 0.05 | 4.8 |
| Example19 | Propylene polymer (19) | 0.05 | 0.1 | — | 2.5 |
| Example20 | Propylene polymer (20) | 0.05 | 0.1 | 0.05 | 1.6 |
| Comparative | Propylene polymer (C11) | — | 0.1 | — | 6.4 |
| Example11 | | | | | |
| Comparative | Propylene polymer (C12) | — | 0.1 | — | 5.0 |
| Example12 | | | | | |
| Comparative | Propylene polymer (C13) | 0.05 | 0.1 | — | 14.3 |
| Example13 | | | | | |

It is confirmed that the amount of VOC volatilized from the polypropylene resin composition is small in Examples 18 to 20 satisfying the requirements of the present invention, since the amount of the component which adheres to the glass surface according to the fogging test is small. On the other hand, it is confirmed that the effect of reducing the amount of VOC volatilized from the polypropylene resin composition is insufficient in Comparative Examples 11 to 13 which does not satisfy the requirements of the present invention.

1. An olefin polymerization catalyst obtainable by bringing the following components (A), (B) and (C) into contact with one another:
(A) a solid catalyst component for olefin polymerization comprising a titanium atom, a magnesium atom and a halogen atom;
(B) an organoaluminum compound;
(C) a triether represented by formula (I): 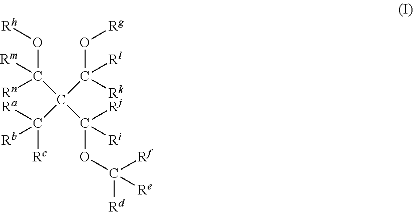
wherein R^{a} is a hydrogen atom or a hydrocarbyl group having 1 to 20 carbon atoms and optionally having a substituent, R^{b} and R^{c} each independently are a hydrocarbyl group having 1 to 20 carbon atoms and optionally having a substituent, R^{d} and R^{e} each independently are a hydrogen atom or a hydrocarbyl group having 1 to 20 carbon atoms and optionally having a substituent, R^{f} is a hydrocarbyl group having 1 to 20 carbon atoms and optionally having a substituent, R^{g} and R^{h} each independently are a hydrocarbyl group having 1 to 5 carbon atoms and optionally having a substituent, Rⁱ, R^{j}, R^{k}, R^{l}, R^{m} and Rⁿ each independently are a hydrogen atom or a hydrocarbyl group having 1 to 5 carbon atoms and optionally having a substituent.

2. An olefin polymerization catalyst obtainable by bringing the following components (A), (B), (C) and (D) into contact with one another:
(A) a solid catalyst component for olefin polymerization comprising a titanium atom, a magnesium atom and a halogen atom;
(B) an organoaluminum compound;
(C) a triether represented by formula (I): 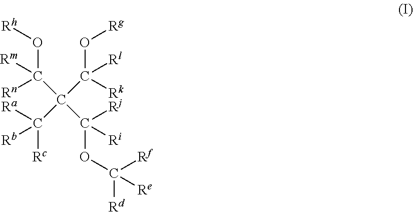
wherein R^{a} is a hydrogen atom or a hydrocarbyl group having 1 to 20 carbon atoms and optionally having a substituent, R^{b} and R^{c} each independently are a hydrocarbyl group having 1 to 20 carbon atoms and optionally having a substituent, R^{d} and R^{e} each independently are a hydrogen atom or a hydrocarbyl group having 1 to 20 carbon atoms and optionally having a substituent, R^{f} is a hydrocarbyl group having 1 to 20 carbon atoms and optionally having a substituent, R^{g} and R^{h} each independently are a hydrocarbyl group having 1 to 5 carbon atoms and optionally having a substituent, Rⁱ, R^{j}, R^{k}, R^{l}, R^{m} and Rⁿ each independently are a hydrogen atom or a hydrocarbyl group having 1 to 5 carbon atoms and optionally having a substituent;
(D) an alkoxysilane compound.

3. The olefin polymerization catalyst according to claim 1,
wherein R^{e} in formula (I) is a hydrocarbyl group having 1 to 20 carbon atoms.

4. The olefin polymerization catalyst according to claim 1, wherein R^{g} and R^{h} in formula (I) each independently are a linear alkyl group having 1 to 5 carbon atoms.

5. The olefin polymerization catalyst according to claim 1, wherein each Rⁱ, R^{j}, R^{k}, R^{l}, R^{m} and Rⁿ is a hydrogen atom.

6. The olefin polymerization catalyst according to claim 1, wherein the solid catalyst component (A) for olefin polymerization is obtained by bringing a solid component (a) comprising a titanium atom and a magnesium atom into contact with an electron donor compound (b).

7. The olefin polymerization catalyst according to claim 1, wherein the solid catalyst component (A) for olefin polymerization is obtained by bringing a titanium compound (c), a magnesium compound (d) and an electron donor compound (b) into contact with one another.

8. The olefin polymerization catalyst according to claim 1, wherein the solid catalyst component (A) for olefin polymerization is obtained by bringing a titanium compound (c), a magnesium compound (d), an electron donor compound (b) and an organic acid chloride (e) into contact with one another.

9. The olefin polymerization catalyst according to claim 1, wherein the solid catalyst component (A) for olefin polymerization is obtained by bringing a solid component (a) comprising a titanium atom and a magnesium atom, an electron donor compound (b) and a metal halide compound represented by formula (vii) or (viii):
M¹R¹¹_{p-b}X³_{b} (vii)
M¹(OR¹¹)_{p-b}X³_{b} (viii)
wherein M¹ is an element of Group 4, 13 or 14 of the periodic table, R¹¹ is a hydrocarbyl group having 1 to 20 carbon atoms, X³ is a halogen atom, p represents a valency of the element M¹, and b is an integer number satisfying 0<b≦p, into contact with one another.

10. The olefin polymerization catalyst according to claim 1, wherein the solid catalyst component (A) for olefin polymerization is obtained by bringing a solid component (a) comprising a titanium atom and a magnesium atom, an electron donor compound (b), a metal halide compound represented by formula (vii) or (viii):
M¹R¹¹_{p-b}X³_{b} (vii)
M¹(OR¹¹)_{p-b}X³_{b} (viii)
wherein M¹ is an element of Group 4, 13 or 14 of the periodic table, R¹¹ is a hydrocarbyl group having 1 to 20 carbon atoms, X³ is a halogen atom, p represents a valency of the element M¹, and b is an integer number satisfying 0<b≦p, and an organic acid chloride (e) into contact with one another.

11. The olefin polymerization catalyst according to claim 6, wherein the solid component (a) is a solid catalyst component precursor (a-1) for olefin polymerization comprising a titanium atom, a magnesium atom and a hydrocarbyloxy group.

12. The olefin polymerization catalyst according to claim 11, wherein the catalyst component precursor (a-1) for olefin polymerization is obtained by reducing a titanium compound (a-1b) represented by formula (Iv): 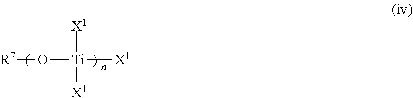
wherein n is an integer number of 1 to 20, R⁷ is a hydrocarbyl group having 1 to 20 carbon atoms, and each groups X¹ are a halogen atom or a hydrocarbyloxy group having 1 to 20 carbon atoms, and groups X¹ may be the same or different from each other, with an organomagnesium compound (a-1c) in the presence of a silicon compound (a-1a) having a Si—O bond.

13. The olefin polymerization catalyst according to claim 6, wherein the electron donor compound (b) is selected from the group consisting of an aliphatic carboxylate ester having an alkoxy group, a malonate diester, a succinate diester, a cyclohexane dicarboxylate diester, a phthalate diester, a dodecanedioic acid diester and a carbonate.

14. The olefin polymerization catalyst according to claim 7, wherein the magnesium compound (d) is a dialkoxy magnesium (d-2).

15. The olefin polymerization catalyst according to claim 7, wherein the magnesium compound (d) is a magnesium halide (d-1).

16. A process for producing an olefin polymer, comprising a step of polymerizing an olefin in the presence of the olefin polymerization catalyst according to claim 1.

17. The process according to claim 16, wherein the olefin is an α-olefin having 3 to 20 carbon atoms.

18. A propylene polymer satisfying all of the following requirements (1) to (4):
(1) an intrinsic viscosity measured at 135° C. in tetralin is 1.0 dl/g or less;
(2) a ratio of a weight average molecular weight to a number average molecular weight measured by gel permeation chromatography is not less than 3.0 and not more than 4.0;
(3) a total amount of bonds resulting from 2,1-insetion reaction and 3,1-insertion reaction in the total structural units derived from propylene, measured by a ¹³C nuclear magnetic resonance spectrum, is 0.01 mol % or less;
(4) an amount of a constituent extracted by subjecting 1 g of a sheet having a thickness of 100 μm obtained by pressing the propylene polymer in 10 ml of tetrahydrofuran for 1 hour to an ultrasonic treatment is 1700 ppm or less.

19. The propylene polymer according to claim 18.

20. A propylene polymer produced by using the olefin polymerization catalyst according to claim 1.

21. A polypropylene resin composition comprising the propylene polymer according to claim 18 and an ethylene-α-olefin copolymer.

22. A polypropylene resin composition comprising the propylene polymer [component (E)] according to claim 18, 0.01 to 0.5 parts by weight of the following compound [component (F)] per 100 parts by weight of the component (E) and 0.01 to 0.5 parts by weight of a compound [component (G)] having a hydroxyphenyl group per 100 parts by weight of the component (E):
Compound [component (F)]:
at least one compound selected from the group consisting of a compound represented by CₙHₙ₊₂(OH)ₙ wherein n is an integer of 4 or more; an alkoxylated compound defined as follows; a compound represented by the following formula (3); trehalose, sucrose, lactose, maltose, melezitose, stachyose, curdlan, glycogen, glucose and fructose;
Alkoxylated compound:
a compound in which at least one hydroxy group in a compound represented by formula (2):
CₘH₂ₘOₘ (2)
wherein m is an integer number of 3 or more,
is alkoxylated with an alkyl group having 1 to 12 carbon atoms, the compound represented by formula (2) containing one aldehyde or ketone group and m-1 hydroxy groups;
Compound represented by formula (3): 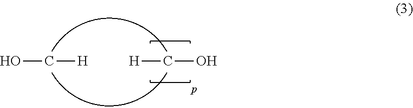
wherein p is an integer number of 2 or more.

23. The polypropylene resin composition according to claim 22, wherein the component (F) is trehalose.

24. The polypropylene resin composition according to claim 22, wherein the component (G) having a hydroxyphenyl group is selected from a group consisting of a compound represented by formula (4): 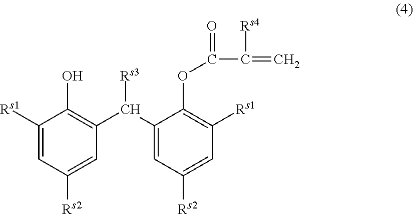
wherein R^{S1} and R^{s2} each independently are an alkyl group having 1 to 8 carbon atoms, an aryl group having 6 to 12 carbon atoms or an aralkyl group having 7 to 18 carbon atoms, the R^{S1} groups may be the same or different from each other, the R^{S2} groups may be the same or different from each other, R^{S3} is a hydrogen atom or an alkyl group having 1 to 3 carbon atoms, and R^{S4} is a hydrogen atom or a methyl group,
and a compound represented by formula (5): 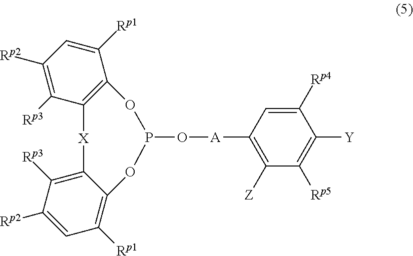
wherein R^{P1}, R^{P2}, R^{P4} and R^{P5} each independently are a hydrogen atom, an alkyl group having 1 to 8 carbon atoms, a cycloalkyl group having 5 to 8 carbon atoms, an alkyl cycloalkyl group having 6 to 12 carbon atoms, an aralkyl group having 7 to 12 carbon atoms or a phenyl group; R^{P3} groups each independently are a hydrogen atom or an alkyl group having 1 to 8 carbon atoms; X is a single bond, sulfur atom or a divalent group represented by formula (5-1): 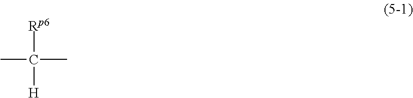
wherein R^{P6} is a hydrogen atom, an alkyl group having 1 to 8 carbon atoms or a cycloalkyl group having 5 to 8 carbon atoms;
A is an alkylene group having 2 to 8 carbon atoms or a divalent group represented by formula (5-2): 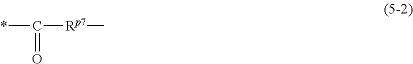
wherein R^{P7} is a single bond or an alkylene group having 1 to 8 carbon atoms, and □ represents a binding site to an oxygen atom;
one of Y or Z is a hydroxy group, an alkyl group having 1 to 8 carbon atoms, an alkoxy group having 1 to 8 carbon atoms or an aralkyloxy group having 7 to 12 carbon atoms and the other one is a hydrogen atom or an alkyl group having 1 to 8 carbon atoms.

25. The polypropylene resin composition according to claim 22, wherein the component (G) is 2,4-di-t-pentyl-6-[1-(3,5-di-t-pentyl-2-hydroxyphenyl)ethyl]phenylacrylate or 6-[3-(3-t-butyl-4-hydroxy-5-methylphenyl)propoxy]-2,4,8,10-tetra-t-butyldibenz[d,f][1,3,2] dioxaphosphepin.

26. An article comprising the propylene polymer according to claim 18.
